(19) United States
(12) Patent Application Publication
(10) Pub. No.: US 2023/0120926 A1
(43) Pub. Date: Apr. 20, 2023

(54) U-SPLINES: SPLINES OVER UNSTRUCTURED MESHES

(71) Applicant: Coreform LLC, Orem, UT (US)

(72) Inventors: Derek C. Thomas, Orem, UT (US); Michael A. Scott, American Fork, UT (US)

(21) Appl. No.: 17/711,874

(22) Filed: Apr. 1, 2022

Related U.S. Application Data
(63) Continuation-in-part of application No. 16/012,128, filed on Jun. 19, 2018, now abandoned.
(60) Provisional application No. 62/522,621, filed on Jun. 20, 2017.
(60) Provisional application No. 62/522,792, filed on Jun. 21, 2017.
(60) Provisional application No. 62/621,695, filed on Jan. 25, 2018.

(51) Int. Cl. G06F 30/12; G06F 30/23

(52) U.S. Cl. CPC G06F 30/12; G06F 30/23

(57) ABSTRACT

U-splines are a novel approach to the construction of a spline basis for representing smooth objects in Computer-Aided Design (CAD) and Computer-Aided Engineering (CAE). A spline is a piecewise-defined function that satisfies continuity constraints between adjacent cells in a mesh. U-splines differ from existing spline constructions, such as Non-Uniform Rational B-splines (NURBS), subdivision surfaces, T-splines, and hierarchical B-splines, in that they can accommodate local variation in cell size, polynomial degree, and smoothness simultaneously over more varied mesh configurations. Mixed cell types (e.g., triangle and tetrahedron and quadrilateral and hexahedral cells in the same mesh) and T-junctions are also supported. The U-spline construction is presented for curves, surfaces, and volumes with higher dimensional generalizations possible. A set of requirements are given to ensure that the U-spline basis is positive, forms a partition of unity, is complete, and is locally linearly independent.

### CROSS-REFERENCE TO RELATED APPLICATIONS

This application is a Continuation-in-Part of U.S. patent application Ser. No. 16/012,128 filed Jun. 19, 2018, entitled “U-Splines: Splines Over Unstructured Meshes,” which claims benefit of and priority to U.S. Provisional Patent Application Ser. No. 62/621,695 filed on Jan. 25, 2018 and entitled “U-Splines,” claims benefit of and priority to U.S. Provisional Patent Application Ser. No. 62/522,792 filed on Jun. 21, 2017 and entitled “U-Splines: Splines Over Unstructured Meshes of Arbitrary Dimension,” and claims benefit of and priority to U.S. Provisional Patent Application Ser. No. 62/522,621 filed on Jun. 20, 2017, entitled “U-SPLINES: SPLINES OVER UNSTRUCTURED MESHES OF ARBITRARY DIMENSION,” each of which applications is expressly incorporated herein by reference in its entirety.

### STATEMENT REGARDING FEDERALLY SPONSORED RESEARCH OR DEVELOPMENT

This invention was made with government support under Award Number DE-SC0017051 awarded by the U.S. Department. of Energy, Office of Science, Office of Advanced Scientific Computing Research. Also with support of contract number N6833518C0289 awarded by the United States Naval Air Systems Command. The government has certain rights in the invention.

### BACKGROUND OF THE INVENTION

Computer aided engineering (CAE) can provide feedback regarding the expected behavior of a given part before costly fabrication is undertaken. The predominant simulation technique in current use in CAE is finite element analysis (FEA). In FEA, the simulation of a computer aided design (CAD) is typically preceded by a process known as meshing, in which a faceted approximation of the original CAD model is constructed to satisfy the requirements of the simulation pipeline. Inconsistencies in common industrial CAD representations, such as small gaps between adjacent CAD faces, must be resolved during the meshing process resulting in a final mesh approximation that is referred to as “watertight.” or “analysis-suitable”.

A faceted mesh is a piecewise-defined function that satisfies continuity constraints between adjacent cells. The function, restricted to the domain of each cell, is a linear polynomial or facet. Across interfaces, or the boundary of adjacent cells, the function is [symbol] ⁰-continuous. Continuity or smoothness refers to the level at which a function shares the same values on either side of an interface. If the function is discontinuous at the interface then the function can have different values at adjacent points in the cells on either side of the interface. A function is said to be value continuous if the function produces the same value at points in each cell that are adjacent across the interface. Other levels of continuity are also possible; the slope and curvature of the function can also be continuous across the interface. Higher levels of continuity require mathematical definitions in terms of derivatives. We say a function has continuity of order [symbol] where [symbol] ≥−1; we also say a function is [symbol] -continuous. [symbol] ⁻¹ is discontinuous, [symbol] ⁰ is value continuous, etc.

While it is technically correct to call a faceted mesh a spline, the term spline has become synonymous with meshes of higher degree and continuity. We will often use the term smooth spline to disambiguate the term. The most recognized example of a smooth spline is the B-splines or basis splines. Originating with Cox, de Boor, and Mansfield, the basis spline functions are the minimally supported spline functions on a partitioning of an interval. The minimal, compact support of B-splines is significant for both design and simulation.

The simplicity and efficiency of prevailing smooth spline constructions, their superior approximation properties, and numerical robustness have led to the widespread industrial adoption of smooth splines as the foundation of modern CAD tools. Indeed, nonuniform rational B-splines (NURBS), a generalization of B-splines, are foundational to virtually all CAD modeling environments, where they are used primarily for non-analytic curve and surface representation.

Interestingly, the superior behavior of smooth splines, when applied to FEA has long been recognized by analysts. However, most splines, other than simple [symbol] ⁰ splines, were viewed as too expensive or the construction too complex for general-purpose FEA. Efforts were made to improve the geometric definition in FEA through the use of subdivision surfaces and NURBS in FEA, among others, but it was not until the introduction of the concept of isogeometric analysis (ICA) that a large-scale effort to exploit the properties of splines in FEA commenced. IGA can be understood simply to be FEA with smooth splines. The potential benefits of this approach have become clear, but the watertight meshing of complex CAD geometries with smooth splines remains a significant barrier to broader adoption.

Our opinion is that a smooth spline meshing technology for industrial-scale FEA problems should be capable of smoothly and accurately representing complex CAD models, be compatible with prevailing industrial spline representations such as NURBS and T-splines, support the local modification of cell size (h-refinement), degree (p-refinement), and intercell continuity (ϑ-refinement), naturally generalize to higher dimensions, and provide a locally-supported, complete, positive basis for the underlying spline space that forms a partition of unity and is (locally) linearly independent. The U-spline technology satisfies all these technical objectives.

The need for advanced smooth spline surface meshes in CAD and, in particular, animation and graphics applications led to the development of both subdivision surfaces and later T-splines. A significant benefit of the T-spline construction is its compatibility with NURBS representations. Additional developments to follow on the advances of subdivision surfaces and T-splines include PIT-splines and polynomial splines over T-meshes. In these works, the continuity of the splines is restricted to be less than half of the polynomial degrees on adjacent cells. The importance of handling singular or extraordinary vertices smoothly has long been recognized and many approaches have been proposed.

The potential benefits of smooth unstructured spline meshes was recognized soon after the advent of FEA. Despite these early efforts, the majority of finite element research was carried out on [symbol] ⁰ constructions and so FEA came to be associated primarily with [symbol] ⁰ basis functions. More recently, subdivision surfaces were applied to shells. Shortly after the original introduction of ICA, work commenced on ICA based on T-splines. This was motivated by both the unstructured nature of T-splines and the need for adaptive local refinement. The need for guarantees on analysis properties of the basis led to the introduction of analysis-suitable T-splines (ASTS). Other efforts to produce refineable splines suitable for use in FEA followed such as locally refined (LR) B-splines and hierarchical B-splines and truncated hierarchical B-splines. Constructions based on geometric rather than parametric continuity have also been explored.

There has also been significant work on spline constructions over unstructured meshes within the wider numerical analysis community, although many of these approaches have not been widely adopted in FEA. Classic approaches commonly employed to produce continuity greater than [symbol] ⁰ include Argyris elements, Clough-Tocher elements, and Powell-Sabin splines among others. Significant work has been carried out on the dimension of spline spaces for both triangle and T-meshes. Meshes consisting of both squares and triangles with potentially hanging vertices, also called T-junctions, have been considered although only splines of continuity [symbol] ⁰ were explored. The approximation power of splines over T-meshes for splines of reduced continuity greater than [symbol] ⁰ has been established. Several types of simplex splines have been introduced to facilitate the construction of splines in unstructured settings. Several adaptations of simplex splines to Powell-Sabin and other splits have been proposed to allow their use on unstructured meshes. Additional methods combine the solution of continuity constraints together with the solution of the governing PDEs. Splines based on both triangles and tetrahedra have been employed in IGA.

Practical constructions of mixed degree or multi-degree smooth splines are currently limited to univariate constructions and their tensor products and consequently have not seen extensive use in FEA although basic constructions are used in [symbol] ⁰ hp-adaptive methods. In CAGD, univariate mixed degree or multi-degree splines have been proposed. We should mention that multivariate multi-degree splines with higher continuity have been constructed on triangulations without a basis for the purpose of numerical analysis.

While B-splines, due to their tensor product structure, naturally generalize to arbitrary dimensions, it remains a challenge to generalize less structured splines to higher dimensions. Initial efforts have been made to parameterize an irregular volume with a collection of one or more tensor product or swept volumetric B-splines or NURBS (sometimes called a multi-patch construction). T-splines have been primarily used in two-dimensional surface applications, but modest efforts to expand T-splines to the volumetric regime have been made, building on top of the multi-patch approach used with B-splines and NURBS. The volumetric constructions have not yet seen widespread industrial adoption.

Each of these prior technologies have provided important advances and served to demonstrate the power and utility of splines in a wide array of applications, including FEA. However, each method also has known technical limitations in the level of smoothness permitted, maximum dimension, the placement of local refinement features, the polynomial degree supported, or the mathematical quality of the resulting basis functions. The U-spline algorithm presented here represents a fundamentally different method for understanding and constructing splines from any previous work and overcomes many of these limitations.

### BRIEF SUMMARY OF THE INVENTION

Presented herein are embodiments for the creation, calculation, determination, storage, and use of U-splines. Embodiment include, inter alia, systems, methods, and computer program products.

An example embodiment comprises a system for constructing a U-spline in computer aided design (CAD) or computer aided engineering (CAE). The system comprises one or more computer processors. The system also comprises computer readable memory which has stored therein computer-executable instructions. The computer-executable instructions are configured such that when executed by the one or more computer processors of the system, configures, enables, or causes the system to perform a plurality of functions for constructing a U-spline.

In this example embodiment, the functions include constructing a mesh which comprises a plurality of cells. The functions also include assigning a coordinate system to each cell in the mesh, wherein each coordinate system is barycentric or formed from tensor products of barycentric coordinate systems. The functions also include assigning a coordinate system to each cell in the mesh, wherein each coordinate system is barycentric or formed from tensor products of barycentric coordinate systems. The functions also include assigning parametric lengths to each edge of each cell in the mesh, wherein the parametric lengths satisfy conditions for seamless similarity maps. The functions also include assigning a basis to each cell in the mesh, wherein each basis of each cell is a Bernstein or Bernstein-like basis. The functions also include assigning a minimum desired continuity to each interface between adjacent cells in the mesh. The functions also include constructing a system of constraints, termed the global system of constraints, associated with each interface in the mesh, wherein the global system of constraints is derived from a coordinate system, parametric lengths, and basis for each cell and the continuity associated with each interface.

A spline space can be constructed directly from a mesh and assigned smoothness constraints, usually through the construction and analysis of an associated global smoothness constraint matrix. Various approaches to accomplish this have been proposed but we mention, in particular, the approach based on minimal determining sets as it most closely relates to the U-spline algorithm described in this work. Finding a minimal determining set corresponds to finding a basis of the appropriate size for the spline space. Unfortunately, this approach does not provide any insight into the quality or utility of a basis other than existence and quickly becomes intractable for meshes of even moderate size; accurate determination of even the rank of a large constraint matrix of floating point numbers is a difficult problem.

Of more practical use is an algorithm for the direct construction of a spline basis from a mesh that satisfies the desirable properties of the B-splines: (local) linear independence, minimal (compact) support, and positivity. An important corollary of the minimal support property of the B-splines that is not often appreciated is the fact that the minimal support property requires that when a single B-spline basis function is expressed in Bernstein form (i.e., written in terms of the Bernstein polynomials), the function is minimally supported in the number of positive Bernstein coefficients. In algebraic terms, this means that the vectors of Bernstein coefficients of the B-spline basis functions form the sparsest positive basis of the nullspace of the smoothness constraint matrix. However, the problem of finding the sparsest basis for the nullspace of a global smoothness constraint matrix, derived from an underlying mesh, is notoriously difficult. In fact, for general matrices this type of problem is known as the Nullspace Problem and has been shown to be NP-hard.

Using a brute force approach to solve the global nullspace problem to determine the members of a spline basis is an intractable problem. To avoid these issues, the U-spline approach leverages a prescribed admissible mesh topology and properties of a Bernstein-like basis in order to incrementally, through a series of local operations, construct member functions of the sparsest possible spline basis without directly solving the global nullspace problem. Note that although this approach is generally applicable to bases that satisfy the properties of a Bernstein-like basis, for simplicity, only examples using polynomial Bernstein bases are considered.

Additionally, the U-spline approach seeks to alleviate, if not eliminate, many of those longstanding limitations in prevailing spline representations discussed previously, providing a smooth spline meshing technology for industrial-scale FEA applications. In particular, this work can be seen as a generalization of the key innovations underlying both ASTS and Bézier extraction. Bézier extraction is a method for providing a local Bernstein representation of a non-local smooth spline function, and is used widely in IGA. In the U-spline approach, to guarantee the mathematical properties of U-spline spaces, we also impose restrictions on allowable mesh topologies, as is done in ASTS, but do away with (semi) global data structures, such as knot vectors and T-meshes, and fully adopt a Bernstein representation of spline functions, as is done in Bézier extraction. Leveraging this local Bernstein point-of-view, we achieve greater locality in the U-spline algorithm, making it possible to construct well-behaved bases for a much wider range of spline spaces than is encompassed by ASTS, including, for the first time, those that permit local variation in degree.

The key contributions of U-splines can be described as follows:
An algorithm for (1) solving a series of small and highly localized nullspace problems and (2) finding appropriate combinations of the basis vectors of these localized nullspaces to determine the U-spline basis functions. Importantly, the size of each localized nullspace problem is bounded by the local characteristics of the local basis chosen for each cell, the local mesh topology, and the associated smoothness constraints.
The algorithm is expressed entirely in terms of integers and requires no floating point operations until after the indices of the nonzero Bernstein coefficients of a U-spline basis function have been determined.
The need for artificial constructs like global or local knot vectors, control meshes, or T-meshes is eliminated. The only input is a properly specified Bézier mesh that characterizes an associated spline space and the only outputs are linear combinations of Bernstein coefficients that describe U-spline basis functions that span that spline space.
The algorithm naturally generalizes to higher dimensions.
Since continuity constraints, restricted to cell interfaces, are the primal building blocks of the U-spline algorithm, local variations in h, p, and [symbol] can be processed by the same algorithm as well as T-junctions, extraordinary vertices and triangles. The introduction of local variation in degree in a smooth spline setting is a particularly important and unique U-spline innovation.
The only requirement on the local basis assigned to each cell in the Bézier mesh is that it must be Bernstein-like. The key property is that it must have well-ordered derivatives at cell interfaces. This means that a mixture of standard polynomial Bernstein bases over quadrilateral and triangular cells can be used in addition to more exotic Bernstein-like bases based on exponential, trigonometric, and other special functions. In this work, we restrict our focus to polynomial Bernstein bases.
A simple definition of admissibility is given that characterizes a Bézier mesh topology, degree, and smoothness and ensures that the U-spline algorithm, applied to these meshes, produces U-spline basis functions that are locally linearly independent (thus forming a basis for the spline space), positive, form a partition of unity, and are complete up through a specified polynomial degree. To measure completeness in the presence of local variation in degree we require that U-splines satisfy both a local and global completeness measure, both of which are fully characterized by the Bézier mesh.
The satisfaction of local linear independence is the pace-setting property of U-splines, in that it controls to the greatest extent, the allowable Bézier mesh topologies. We should note that by relaxing this requirement to only global linear independence, the class of allowable Bézier mesh topologies that can be processed by the U-spline algorithm is greatly expanded. We have successfully constructed U-spline bases in this more general setting but postpone a thorough investigation of those more general U-spline spaces to a future work, as we have found local linear independence to be particularly beneficial to applications of the technology we are interested in.
As far as the authors are aware, the generality of U-splines spaces, in particular local variation in degree, is beyond the application of the mathematical analysis tools commonly used to rigorously characterize spline spaces. To compensate for this, we instead validate our mathematical claims numerically through a rigorous regime of randomly generated examples and postpone a theoretical exploration of these claims to a future work. We anticipate that this work will spur additional research in the theoretical characterization of the spline spaces generated by the U-spline algorithm.
When the input Bézier mesh coincides with single- or multi-patch NURBS or analysis-suitable T-splines the U-spline algorithm produces those spline spaces and associated bases with pointwise exactness.

In one dimension, we consider U-splines of any degree and any continuity up to the degree. In higher dimensions, we will only consider U-splines up to degree three with a maximal continuity of [symbol] ², and supersmooth¹ interfaces up to [symbol] ³. ¹The term supersmooth is defined in section 6.2.

We recognize that the name U-spline was originally used to refer to the definition of splines over unordered knot sequences. Because the need for unstructured splines is significant and the application of splines over unordered knot sequences has not yet achieved widespread use, we instead use the U-spline designation for our splines over unstructured meshes.

### BRIEF DESCRIPTION OF THE DRAWINGS

In order to describe the manner in which advantages and features described herein can be implemented and obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1: The Bernstein polynomials of degree 1, 2, and 3 and their normalized derivatives, evaluated on s∈Q.

FIG. 2: Examples of parametric coordinate systems specified on quadrilaterals and triangles in two dimensions (left) and on hexahedra in three dimensions (right) using small axes. VIEW A: Example of parametric coordinate systems specified on quadrilaterals and triangles in two dimensions. VIEW B: Example of a volumetric mesh where each hexahedra has parametric coordinates [s₀, s₁, s₂] shown as small axes.

FIG. 3: The continuity of interfaces on volumetric Bézier meshes are indicated by the color of a semi-transparent surface drawn on the interface.

FIG. 4: Examples of supersmooth interfaces.

FIG. 5: The Bernstein indices (on the left) and corresponding circles (on the right) for a two-dimensional mesh with a quadrilateral and triangular cell, with degrees p=(2, 3) and p=2, respectively.

FIG. 6: We depict Bernstein indices in volumetric cells as small spheres, the positioning and quantity of which indicate the polynomial degree of the Bernstein functions on each cell in each parametric direction. The cells from left to right have degrees p=(1, 1, 1), (2, 2, 2), (3, 3, 3), respectively.

FIG. 7: Each Bernstein function in a cell has an associated point known as a Greville point g in the parent domain of the cell, depicted on the right as small black circles.

FIG. 8: The submesh Greville points on an indexed submesh domain composed of two adjacent cells with differing degree. Each Greville point is labeled with its corresponding coordinate index. The origin chosen for this submesh domain is indicated by the small axis.

FIG. 9: To help differentiate between Greville points on adjacent elements, we often will draw the circles representing the Greville points with respect to a scaled element inset from the boundary, as seen here.

FIG. 10: The parallel and perpendicular equivalence relations [symbol] and [symbol] are used to partition the Greville points on a cell c with respect to the adjacent edge e, forming partitions G(c)/ [symbol] and G(c)/ [symbol] .

FIG. 11: An example of the sets GA, GB, and GI on two adjacent elements a and b with degrees (1,1) and (1, 2).

FIG. 12: The projected points for the two elements in FIG. 11 are shown as black circles along the shared interface I. The difference vector Δgₘₐₓ^{b} is shown with a curly bracket.

FIG. 13: Given a Greville point on the shared interface g^{I} ∈GI, a set of equivalence classes on element a (denoted GA_{I,g}_{^{I}}^{∥}) is aligned with a corresponding set of equivalence classes on element b (denoted GB_{I,g}_{^{I}}^{∥}), together forming a set of aligned sets of equivalence classes (denoted Align_{g}_{^{I}}).

FIG. 14: The concept of alignment follows naturally from the fact that multiple nonzero coefficients corresponding to higher-degree Bernstein basis functions are required to represent a single Bernstein function of lower degree (see section 6.1.2).

FIG. 15: Given an alignment index i on a shared interface I, i∈ID(I), a set of equivalence classes on element, a (denoted Align_{I,i}^{a}) is aligned with a corresponding set of equivalence classes on element b (denoted Align_{I,i}^{b}), together forming a set of aligned sets of equivalence classes (denoted Align_{I,i}).

FIG. 16: The nonzero coefficients of one-dimensional basis vectors on [symbol] ⁰, [symbol] ¹, and [symbol] ² interfaces, respectively. Each basis vector has [symbol] +2 contiguous nonzero entries.

FIG. 17: Coefficients corresponding to the nonzero entries in the rows of the constraint matrix. Each grey block surrounds the nonzero entries of a pair of rows in the matrix given in eq. (6.77).

FIG. 18: The indices associated with nonzero entries of two representative basis vectors for eq. (6.77) are shown. Each gray box indicates the nonzero entries in one basis vector.

FIG. 19: Indexing convention and coefficients corresponding to the nonzero entries in the constraint matrix given in eq. (6.78). The mesh has two elements with degrees (1,1) and (1,2), connected by a [symbol] ⁰ interface. Each contiguous gray region surrounds the nonzero entries of a row in the matrix given in eq. (6.78).

FIG. 20: The basis vectors with indices from both elements adjacent to the interface in FIG. 19. These basis vectors span the null space of the constraint matrix given in eq. (6.78).

FIG. 21: The basis vectors with indices from both faces adjacent to a [symbol] ¹ interface. The faces have degrees p=(2,2) and p=(3,3).

FIG. 22: Examples of spokes and inclusion distances. VIEW B: An example of a choice of inclusion distances, labeled adjacent to each spoke. VIEW A: Each spoke ρᵢ on a regular vertex v in a two-dimensional mesh is depicted as a dashed line.

FIG. 23: Choosing an initial element E and two initial spokes ρ₁ and ρ₂, and choosing the inclusion distances which uniquely identify a vertex basis vector. The fully constructed basis vector is seen in FIG. 26, VIEW B. VIEW A: A two-dimensional mesh with four cells. Three cells are biquadratic and one is bicubic. All edges are [symbol] ¹. VIEW B: We select an initial element E on the top-left, and label the two initial spokes ρ₁ and ρ₂. VIEW C: We choose inc(ρ₁)=0 and inc(ρ₂)=0, thus determining the inclusion distances on all the spokes.

FIG. 24: The basis vectors contained in EBG_{inc}_{₁}_{inc}_{₂}^{∥}(eᵢ) for each edge eᵢ, i∈{0, 1, 2, 3}, the sets of equivalence classes for which the minimum projection onto the edge is less than or equal to INCₑ_{ᵢ}^{inc}^{₁}^{,inc}^{₂}. Overlapping regions are depicted with darker gray. The fully constructed basis vector is seen in FIG. 26, VIEW B.

FIG. 25: The basis vectors contained in BG_{inc}_{₁}_{,inc}_{₂}^{⊥}(eᵢ) for each edge eᵢ, i∈{0, 1, 2, 3}. The dotted line represents the span of indices whose projections onto the edges perpendicular to eᵢ lie in G^{⊥}. Overlapping regions are depicted with darker gray. The fully constructed basis vector is seen in FIG. 26. VIEW B.

FIG. 26: The composite basis vectors on a vertex adjacent to four quadrilateral cells, three with degree p=(2, 2) and one with degree p=(3, 3). The continuity on the interfaces is [symbol] ¹. VIEW A: The vertex basis vector with index support IDᵥ^{0,1}. VIEW B: The vertex basis vector with index support IDᵥ^{0,0}. VIEW C: The vertex basis vector with index support IDᵥ^{1,1}. VIEW D: The vertex basis vector with index support. IDᵥ^{1,0}.

FIG. 27: The simple basis vectors on a vertex adjacent to four quadrilateral cells, three with degree p=(2,2) and one with degree p=(3, 3). The continuity on the interfaces is [symbol] ¹. Overlapping regions are depicted with darker gray. Each simple vertex basis vector is constructed from an adjacent edge basis vector that is not subsumed by a composite vertex basis vector.

FIG. 28: Examples of composite basis vectors on extraordinary vertices. On the left we see a valence-3 extraordinary vertex where all the cells have degree p=(2, 2). On the right we see a valence-5 extraordinary vertex where some cells have degree p=(2, 2) and others have degree p=(3, 3). In each case, the continuity of each edge is [symbol] ⁰.

FIG. 29: Basis vectors on a [symbol] ⁰ interface between two hexahedron on a volumetric mesh. The element on the left is linear and the element on the right is cubic. This results in four alignment sets, and one interface-overlapping basis vector per alignment index.

FIG. 30: Basis vectors on a [symbol] ¹ interface between two hexahedron on a volumetric mesh. The two elements are each quadratic in the direction normal to the interface, and then are given degrees (1,2) and (2, 1), respectively, in the directions parallel to the interface. This results in four alignment sets, and two interface-overlapping basis vectors per alignment index.

FIG. 31: Examples of composite basis vectors on an edge adjacent to four hexahedron on a volumetric mesh. Three elements are quadratic and one is cubic. The continuity is [symbol] ¹ everywhere. These (d−2)-cell basis vectors are the volumetric analog to the two-dimensional vertex basis vector shown in FIG. 26, VIEW B, one for each alignment index along the edge.

FIG. 32: Several examples of composite vertex basis vectors on volumetric meshes. The degree and continuity for each example is indicated. FIG. 32, VIEW B is an example of an extraordinary vertex on a volumetric mesh, constructed by filling a tetrahedron with hexahedral cells. FIG. 32, VIEW C is analogous to the two-dimensional example in FIG. 26, VIEW A. In FIG. 32, VIEW D notice the far corner Bernstein index is missing on the cubic cell, analogous to the two-dimensional example in FIG. 26, VIEW D. VIEW A: Seven linear and one quadratic hexahedron meet at a regular vertex. The continuity is [symbol] ⁰ everywhere. VIEW B: Three linear and one quadratic hexahedron meet at an extraordinary vertex. The continuity is [symbol] ⁰ everywhere. VIEW C: Seven quadratic and one cubic hexahedron meet at a regular vertex. The continuity is [symbol] ¹ everywhere. VIEW D: Seven quadratic and one cubic hexahedron meet at a regular vertex. The continuity is [symbol] ¹ everywhere.

FIG. 33: An example of subordinate basis vectors in one dimension. The set of subordinate basis vectors of n is SBV(n), and SBVₑ_{ᵢ}(n), i∈{0, 1} are the subsets of subordinate basis vectors associated with edges e₀ and e₁, respectively.

FIG. 34: An example of basis vector boundaries on a vertex null vector on a one-dimensional mesh.

FIG. 35: The boundary of a vertex basis vector nᵥ on edge e, on a quadratic mesh with [symbol] ¹ continuity. In this case, there is only one equivalence class, which contains two subordinate basis vectors. The rightmost subordinate basis vector from the equivalence class makes up the basis vector boundary.

FIG. 36: In the presence of local variation in degree, the boundary of a vertex basis vector nᵥ on edge e may be determined from more than one equivalence class. The rightmost subordinate basis vectors from each equivalence class make up the basis vector boundary. All the interfaces have [symbol] ¹ continuity.

FIG. 37: An example of a ribbon on a two-dimensional mesh (left) and on a three-dimensional mesh (right). In each case, a small solid circle or sphere near the head of the ribbon represents an initial Bernstein coefficient.

FIG. 38: Continuity transition ribbons on a two-dimensional mesh (left) and a three-dimensional mesh (right). In each case, the ribbon originates at a (d−2)-cell where a continuity transition occurs, and proceeds in the direction of lower continuity. All elements on both meshes are quadratic.

FIG. 39: Degree transition ribbons on a two-dimensional mesh (left) and a three-dimensional mesh (right). A degree transition ribbon is a ribbon of maximum coupling length with the additional property that pₘᵢₙ^{⊥}(I^{h})<pₘᵢₙ^{⊥}([t]₀).

FIG. 40: Examples of admissible layouts that satisfy ϑ- and p-separation conditions. On the top left, two continuity transition ribbons meet tail-to-tail. On the top right, a degree transition ribbon dr is sufficiently separated from a continuity transition ribbon cr to avoid intersection with the origin of cr. On the bottom, a degree transition is sufficiently separated from the head of a continuity transition ribbon cr so that

$${p}_{min}^{⊥} ( cr ) > {ϑ}^{\vert h}$$

FIG. 41: Example of two admissible layouts that satisfy the [symbol] -grading condition. Note that while extraordinary (d−2)-cells will always be creased, a creased (d−2)-cell may also be regular as shown in the example on the right.

FIG. 42: Examples of admissible volumetric meshes that satisfy [symbol] - and p-separation conditions. The example on the left contains both a tail-to-tail and head-to-tail ribbon intersection. Ribbons that cross at the center of a face are not considered intersecting and are admissible. The example on the right contains a continuity transition from [symbol] ¹ to [symbol] ⁰, sufficiently far from the degree transition to prevent the continuity transition ribbons from overlapping the cells with lower degree. VIEW A: Example of an admissible cubic volumetric mesh that satisfies the [symbol] -separation condition. The marked interfaces on the left are [symbol] ⁰, the middle are [symbol] ¹, and the right are [symbol] ³. All other interfaces are [symbol] ². VIEW A: Example of an admissible cubic volumetric mesh that satisfies the [symbol] -separation condition. The marked interfaces on the left are [symbol] ⁰, the middle are [symbol] ¹, and the right are [symbol] ³. All other interfaces are [symbol] ². VIEW B: An admissible mesh that satisfies the p-separation condition. The marked interfaces on the right are [symbol] ⁰, and the others are [symbol] ¹. This mesh is quadratic everywhere except for the cells on the far end, which are set to p=(2,1, 1), as depicted by the small solid spheres.

FIG. 43: An example of an admissible volumetric mesh that satisfies the ϑ-separation condition. All elements are quadratic and all faces have continuity [symbol] ¹ except for three mutually orthogonal planes of faces creased to [symbol] ⁰. For clarity, various parts of the mesh are shown separately before they are shown together. Notice the tail-to-tail and head-to-tail ribbon intersections, which are admissible. Ribbons that cross at the center of a face are not considered intersecting and are admissible. VIEW A: A subset of faces creased to [symbol] ⁰ are marked. VIEW B: A subset of faces creased to [symbol] ⁰ are marked. VIEW C: A subset of faces creased to [symbol] ⁰ are marked. VIEW D: All faces creased to [symbol] ⁰ are shown together. VIEW E: The continuity transition ribbons are shown alone. VIEW F: The complete admissible volumetric mesh, including the continuity transition ribbons.

FIG. 44: An admissible mesh that satisfies the p-separation condition. This mesh is cubic [symbol] ¹ everywhere except for five cells on the far side, which have been set to p=(3, 2,2), and a few faces on the near side which are set to [symbol] ³ (supersmooth). The degree transition ribbons may be seen extending away from the cells with lower degree. Observe that these transition ribbons do not intersect the edge where a supersmooth continuity transition occurs, thus maintaining the admissibility of the mesh. Both the front view and side view of the mesh are shown. VIEW A: Front view. VIEW B: Side view.

FIG. 45: Two quadratic volumetric meshes that satisfy the d-grading condition. The mesh on the left was constructed by filling a tetrahedron with hexahedral cells. All faces adjacent to an extraordinary edge must be creased to [symbol] ⁰, but there are cases where a face near but not directly adjacent to an extraordinary edge must also be creased, as seen in the example on the right (see also eq. (6.114)).

FIG. 46: An example of a simple core graph on a one-dimensional cubic U-spline mesh. The continuity on the interfaces is [symbol] ².

FIG. 47: A two-dimensional core graph example. In this example, the U-spline mesh U is a 3-by-4 bicubic mesh with a single supersmooth interface. All interior edges have continuity [symbol] ² (thin solid lines) except for one, which has continuity [symbol] ³ (thick dashed line), forming a supersmooth interface. VIEW A: The root core κ₀. VIEW B: The core graph is expanded along the edges to the right and top, forming cores Ki and κ₂. VIEW C: The core graph is expanded a second time, to the right on both legs of the graph, forming cores κ₃ and κ₄. A failed expansion is encountered when trying to expand upwards from κ₁. VIEW D: Expanding from the other direction, the failed edge is resolved, but this results in adding an extra basis vector to κ₁, which causes κ₃ to become inconsistent with its parent core. VIEW E: The inconsistent child core is removed from the graph. VIEW F: The core graph construction is completed.

FIG. 48: A U-spline mesh with three quadratic and one linear cell, and [symbol] ⁰ continuity on the interfaces. The indices of the nonzero coefficients of the U-spline basis functions are highlighted in gray. The quadratic cells on the top-left and bottom-right have a reduced degree of completeness due to their proximity to the linear cell.

FIG. 49: The faces that can be reached in a cardinal submesh direction that is orthogonal to the interfaces adjacent to f, denoted by the set CRD(f).

FIG. 50: The neighborhood of interaction NI(c) is highlighted for a cell c on a two-dimensional U-spline mesh with three quadratic and one linear cell and continuity [symbol] ⁰ on the interfaces.

FIG. 51: The three base tensor-product topologies used for constructing two-dimensional U-spline test meshes for verification. VIEW A: A regular grid, no periodicity. VIEW B: An annulus, periodic in one dimension. VIEW C: A torus, periodic in two dimensions.

FIG. 52: An example of a U-spline basis function that has a non-rectangular shape due to the close proximity of two continuity transitions near supersmooth interfaces. Notice the two perpendicular transition ribbons, starting at the vertices adjacent to the supersmooth interfaces, which touch at a common endpoint. This is an example of a basis function which is not possible with T-splines, which require basis functions to have a tensor product structure.

FIG. 53: A U-spline with local variation in degree. VIEW A: A degree transition from p=2. [symbol] ¹ (on the top-right) to p=3, [symbol] ² (on the bottom-left). The creasing pattern here is required to ensure the U-spline mesh is admissible. VIEW B: The control points that form a linear parameterization for the U-spline mesh on the left.

FIG. 54: An example of a cubic U-spline basis function near an extraordinary vertex that transitions from [symbol] ⁰ to [symbol] ¹, and then from [symbol] ¹ to [symbol] ². The coefficients for this example are listed in section 6.15.4.

FIG. 55: A U-spline composed of quadrilateral and triangular cells. VIEW A: A quadratic U-spline mesh where triangles allow two tensor product regions to meet diagonally. The edges near the triangles are creased to [symbol] ⁰, but edges further out retain [symbol] ¹ continuity. VIEW B: The control points and geometry of a U-spline where two regular grids meet diagonally with the help of triangles at the interface.

FIG. 56: A U-spline with local variation in smoothness, degree, and cell type. VIEW A: This U-spline mesh is cubic with [symbol] ² continuity on the outside edge, but is filled in the interior with linear triangles. A continuity transition was required between the [symbol] ⁰ triangles and the [symbol] ² quadrilaterals. VIEW B: The control points and geometry of the U-spline mesh in FIG. 56, VIEW A. Meshes of this type may prove useful to engineers who are only interested in smoothness on the surface, and opt for faster linear triangular cells on the interior.

FIG. 57: An example of a fully-unstructured volumetric U-spline mesh. The U-spline mesh is on the left and the U-spline geometry is on the right. VIEW A: A quadratic fully-unstructured volumetric U-spline mesh which forms a 3×3×3 lattice structure with unit cells shaped like spheres with holes. VIEW B: A rendered representation of a volumetric U-spline whose basis is defined by the U-spline mesh shown in FIG. 57. VIEW A.

FIG. 58: Several views of a fully-unstructured volumetric U-spline mesh of a segment of a piston.

FIG. 59: Several rendered views of the piston segment volumetric U-spline whose basis is defined by the mesh shown in FIG. 58.

FIG. 60: Two cells separated by interface I on a two-dimensional mesh. We consider building the continuity constraint on the derivative of order n on this interface.

FIG. 61: A quadrilateral cell and a triangle cell separated by interface 1 on a two-dimensional mesh. We consider building the continuity constraint on the derivative of order 0 on this interface.

FIG. 62: Two triangular cells separated by interface I on a two-dimensional mesh. We consider building the continuity constraint on the derivative of order 0 on this interface.

FIG. 63: The features of a ribbon of maximum coupling length on a two-dimensional U-spline mesh. The perpendicular interfaces on the jth vertex are assigned continuities [symbol] ⱼ⁰ and [symbol] ⱼ¹.

FIG. 64: A ribbon that has been collapsed into a one-dimensional U-spline mesh. The continuity assigned to each vertex is the maximum of the perpendicular interfaces in the two-dimensional mesh. The degree of each one-dimensional cell is the minimum of the parallel degrees of the adjoining cells from the two-dimensional mesh, in the direction parallel to the ribbon. The Bernstein coefficients are labeled as they are indexed in algorithm 2.

FIG. 65: Several examples of the construction of ribbons of maximum coupling length. The Bernstein index marked by a hollow circle in each cell is the index referenced by iₚᵣₑᵥ in each loop of algorithm 2. Note that the bottom two ribbons are truncated.

FIG. 66: A four-by-three cubic U-spline mesh with [symbol] ² continuity on all interior edges except for one which has [symbol] ³ continuity, forming a supersmooth interface. The Bernstein coefficients of the highlighted basis function are listed in table 6.2.

FIG. 67: An example of a U-spline, basis function that has a non-rectangular shape due to the close proximity of two continuity transitions near supersmooth interfaces. Notice the two perpendicular transition ribbons, starting at the vertices adjacent to the supersmooth interfaces, which touch at a common endpoint. This is an example of a basis function which is not possible with T-splines, which require basis functions to have a tensor product structure. The Bernstein coefficients of the highlighted basis function are listed in table 6.3.

FIG. 68: Control points and basis function contours for the U-spline in FIG. 67. VIEW A: The control points for a linear parameterization of the mesh in FIG. 67. The highlighted control point corresponds to the highlighted basis function. VIEW B: Contour plot of the basis function whose nonzero Bernstein coefficients are highlighted in FIG. 67.

FIG. 69: Basis function on a U-spline that is equivalent to an analysis-suitable T-spline. The T-mesh of the equivalent T-spline is shown in FIG. 71. Note that the ribbons of maximum coupling length in this example are analogous to the non-crossing T-junction extensions which guarantee an analysis-suitable T-spline. The Bernstein coefficients of the highlighted basis function are listed in table 6.4.

FIG. 70: Control points and basis function contours for the U-spline in FIG. 69. VIEW A: The control points for a linear parameterization of the mesh in FIG. 69. The highlighted control point corresponds to the highlighted basis function. VIEW B: Contour plot of the basis function whose nonzero Bernstein coefficients are highlighted in FIG. 69.

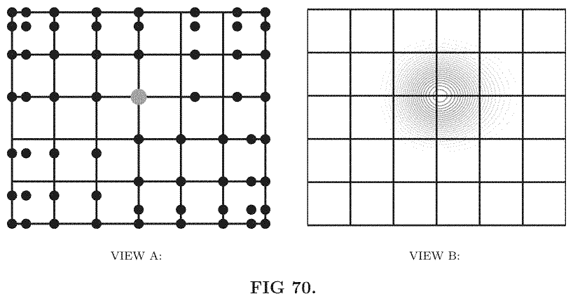

FIG. 71: The T-mesh for a cubic T-spline which is equivalent to the U-spline mesh in FIG. 69. The area highlighted in yellow corresponds to the Bézier elements of the U-spline mesh. The dotted lines next to the T-junctions are the lines of reduced continuity, where there is still [symbol] ² continuity. It is notable to observe that the vertices associated with the T-junctions on the T-mesh are not the same as the vertices adjacent to the supersmooth interfaces on the U-spline mesh, due to the lines of reduced continuity.

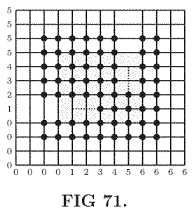

FIG. 72: The support, of one of the basis functions on a cubic mesh with a valence-3 extraordinary vertex. The edges about the extraordinary vertex are creased in a stair-step pattern, starting at [symbol] ⁰ and incrementally increasing continuity until [symbol] ². The Bernstein coefficients of the highlighted basis function are listed in table 6.5.

FIG. 73: Control points and basis function contours for the U-spline in FIG. 72. VIEW A: The control points for a linear parameterization of the mesh in FIG. 72. The highlighted control point corresponds to the highlighted basis function. VIEW B: Contour plot of the basis function whose nonzero Bernstein coefficients are highlighted in FIG. 72.

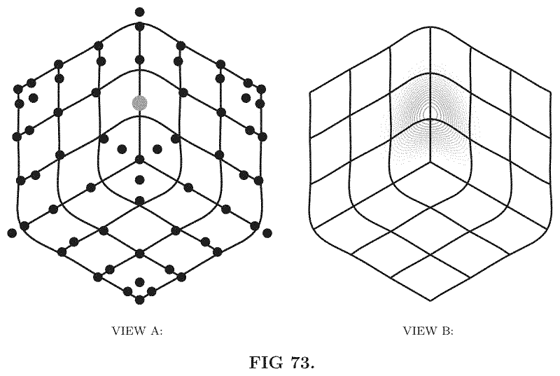

FIG. 74: The support of basis functions on a mesh that includes triangles. The values of the control points of the highlighted functions are listed in table 6.6 and table 6.7.

FIG. 75: Control points and basis function contours for the U-spline basis function highlighted on the left in FIG. 74. VIEW A: The control points for a linear parameterization of the mesh in FIG. 74. The highlighted control point corresponds to the left highlighted basis function. VIEW B: Contour plot of the basis function whose nonzero Bernstein coefficients are highlighted on the left in FIG. 74.

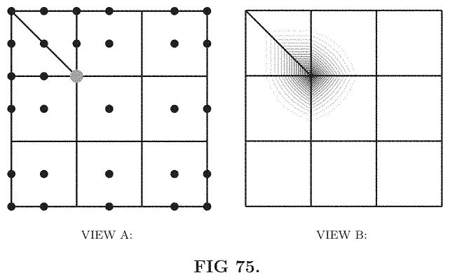

FIG. 76: Control points and basis function contours for the U-spline basis function highlighted on the right in FIG. 74. VIEW A: The control points for a linear parameterization of the mesh in FIG. 74. The highlighted control point, corresponds to the right highlighted basis function. VIEW B: Contour plot of the basis function whose nonzero Bernstein coefficients are highlighted on the right in FIG. 74.

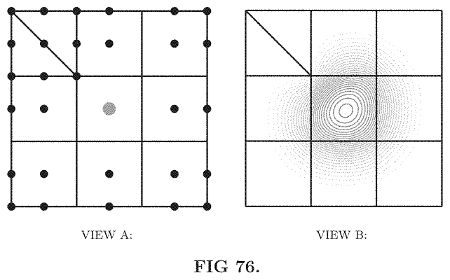

### DETAILED DESCRIPTION

Computer aided engineering (CAE) can provide feedback regarding the expected behavior of a given part before costly fabrication is undertaken. The predominant simulation technique in current use in CAE is finite element analysis (FEA). In FEA, the simulation of a computer aided design (CAD) is typically preceded by a process known as meshing, in which a faceted approximation of the original CAD model is constructed to satisfy the requirements of the simulation pipeline. Inconsistencies in common industrial CAD representations, such as small gaps between adjacent CAD faces, must be resolved during the meshing process resulting in a final mesh approximation that is referred to as “watertight” or “analysis-suitable”.

A faceted mesh is a piecewise-defined function that satisfies continuity constraints between adjacent cells. The function, restricted to the domain of each cell, is a linear polynomial or facet. Across interfaces, or the boundary of adjacent cells, the function is [symbol] ⁰-continuous. Continuity or smoothness refers to the level at which a function shares the same values on either side of an interface. If the function is discontinuous at the interface then the function can have different values at adjacent points in the cells on either side of the interface. A function is said to be value continuous if the function produces the same value at points in each cell that are adjacent across the interface. Other levels of continuity are also possible; the slope and curvature of the function can also be continuous across the interface. Higher levels of continuity require mathematical definitions in terms of derivatives. We say a function has continuity of order [symbol] where [symbol] ≥−1: we also say a function is [symbol] -continuous. [symbol] ⁻¹ is discontinuous, [symbol] ⁰ is value continuous, etc.

While it is technically correct to call a faceted mesh a spline, the term spline has become synonymous with meshes of higher degree and continuity. We will often use the term smooth spline to disambiguate the term. The most recognized example of a smooth spline is the B-splines or basis splines. Originating with Cox, de Boor, and Mansfield, the basis spline functions are the minimally supported spline functions on a partitioning of an interval. The minimal, compact support of B-splines is significant for both design and simulation.

The simplicity and efficiency of prevailing smooth spline constructions, their superior approximation properties, and numerical robustness have led to the widespread industrial adoption of smooth splines as the foundation of modern CAD tools. Indeed, nonuniform rational B-splines (NURBS), a generalization of B-splines, are foundational to virtually all CAD modeling environments, where they are used primarily for non-analytic curve and surface representation.

Interestingly, the superior behavior of smooth splines, when applied to FEA has long been recognized by analysts. However, most splines, other than simple [symbol] ⁰ splines, were viewed as too expensive or the construction too complex for general-purpose FEA. Efforts were made to improve the geometric definition in FEA through the use of subdivision surfaces and NURBS in FEA, among others, but it was not until the introduction of the concept of isogeometric analysis (IGA) that a large-scale effort to exploit the properties of splines in FEA commenced. IGA can be understood simply to be FEA with smooth splines. The potential benefits of this approach have become clear, but the watertight meshing of complex CAD geometries with smooth splines remains a significant barrier to broader adoption.

Our opinion is that a smooth spline meshing technology for industrial-scale FEA problems should be capable of smoothly and accurately representing complex CAD models, be compatible with prevailing industrial spline representations such as NURBS and T-splines, support the local modification of cell size (h-refinement), degree (p-refinement), and intercell continuity ( [symbol] -refinement), naturally generalize to higher dimensions, and provide a locally-supported, complete positive basis for the underlying spline space that forms a partition of unity and is (locally) linearly independent. The U-spline, technology satisfies all these technical objectives.

### the Bernstein Polynomials

A fundamental U-spline building block is the Bernstein polynomial basis. A univariate Bernstein polynomial Bᵢ^{p}: Ω̅♭ [symbol] , i=0, . . . , p, is defined over a parent domain Ω̅=[0, 1] as

$${B}_{i}^{p} ( ξ ) = ( \begin{matrix}p \\ i\end{matrix} ) {{ξ}^{i} ( 1 - ξ )}^{p - i} \qquad ( 6.1 )$$

where p is the polynomial degree and ξ∈Ω̅ is the parent coordinate. We denote the space spanned by the Bernstein polynomial basis by [symbol] and call it the Bernstein space. The Bernstein space is complete through polynomial degree |p|. In other words, all polynomials up through degree p are contained in [symbol] . The Bernstein polynomials possess many additional desirable properties such as pointwise nonnegativity and partition of unity.

Note that we have borrowed the idea of a “parent” domain from FEA, where it is used to standardize and simplify the evaluation of basis functions. The connection of the parent domain to the parametric domain of U-spline basis functions is described in section 6.2.2.

### Ordering of Derivatives

Of particular importance to the U-spline construction algorithms described later is the natural ordering exhibited by derivatives of the Bernstein polynomials. Specifically, we say that a function ƒ: [symbol] → [symbol] vanishes n times at a real value a if ƒ⁽ⁱ⁾(a)=0 for all i∈|0, n). Consider then that the nth derivative of the Bernstein polynomial Bᵢ^{p}(ξ) is given by

$$\frac{{d}^{n} {B}_{i}^{p} ( ξ )}{d {ξ}^{n}} {\vert}_{ξ = 0} = \frac{p !}{( p - n ) !} ( \begin{matrix}n \\ i\end{matrix} ) {( - 1 )}^{n - i} \qquad ( 6.2 )$$

$$\frac{{d}^{n} {B}_{i}^{p} ( ξ )}{d {ξ}^{n}} {\vert}_{ξ = 1} = \frac{p !}{( p - n ) !} ( \begin{matrix}n \\ p - i\end{matrix} ) {( - 1 )}^{i - p} . \qquad ( 6.3 )$$

From these equations, we see that

$$\frac{{d}^{n} {B}_{i}^{p} ( ξ )}{d {ξ}^{n}}$$

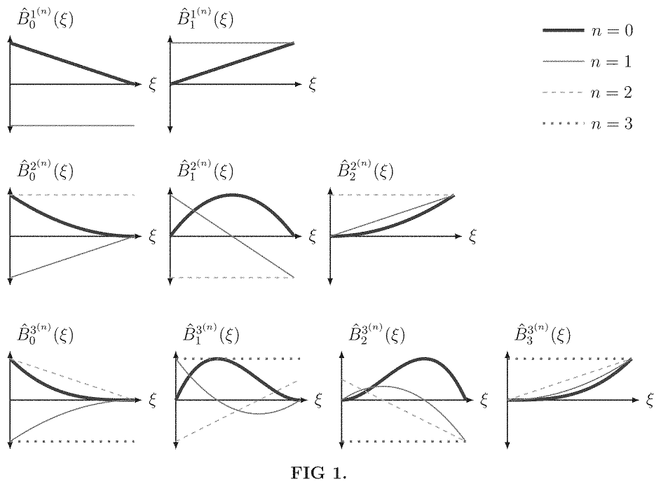

vanishes i times at ξ=0 and p−i times at ξ=1. For example, the value and derivatives of B₂³(ξ) vanish at ξ=0 for n=0, 1 since i=2. This property can be observed in FIG. 1 where we plot the Bernstein polynomials and their derivatives. Note that we have elected to plot normalized functions, found via

$${\hat{B}}_{i}^{{p}^{( n )}} ( ξ ) = {B}_{i}^{{p}^{( n )}} ( ξ ) / {max}_{ξ ∈ \overline{Ω}} \vert {B}_{i}^{{p}^{( n )}} ( ξ ) \vert and {f}^{( n )} = \frac{{d}^{n} f}{d {ξ}^{n}} ,$$

so that all functions may fit comfortably on the same axis. In each plot, the Bernstein polynomials are shown by the thick solid line. Thin solid lines correspond to first derivatives, dashed lines to second derivatives, and dotted lines to third derivatives.

### Degree Elevation

The order of the first nonzero derivative of a Bernstein basis function Bᵢ^{p} evaluated on the left boundary of the parent domain is given by i and by p−i on the right boundary. Consequently, if a single Bernstein basis function Bᵢ^{p} is to be represented in terms of a degree-elevated Bernstein basis Bⱼ^{q}, q>p, the nonzero derivatives of both bases must match on the boundaries of the domain.

This requirement places bounds on the indices of the degree elevated Bernstein basis functions that are required to represent Bᵢ^{p}. If the two sets of basis functions are ordered from left to right then i≤j and p−i≤q−j. These requirements can be combined to obtain a range of valid values for j:

i≤j≤q−p+i. (6.4)

### Multivariate Bernstein Polynomials

In a d-dimensional multivariate setting, Bernstein polynomials are commonly defined over boxes (e.g., quadrilaterals and hexahedra) and simplicial parent domains (e.g., triangles and tetrahedra). The multivariate Bernstein basis functions presented here possess similar derivative ordering properties to the univariate basis described previously. To accommodate this d-dimensional extension, we introduce a dimensional index k∈{0, . . . , d}.

### Box

A multivariate Bernstein polynomial Bᵢ^{p}:Ω̅→ [symbol] is defined over the d-dimensional hypercube or box Ω̅=⊗ₖ₌₀^{d-1}[0, 1] as the tensor product of univariate Bernstein polynomials

$${B}_{i}^{p} ( ξ ) = {{\prod }_{k = 0}}^{d - 1} {B}_{{i}_{k}}^{{p}_{k}} ( {ξ}_{k} ) \qquad ( 6.5 )$$

where i=(i₀, . . . , i_{d-1}) and p=(p₀, . . . , p_{d-1}) are tuples with iₖ and pₖ representing the univariate Bernstein basis function index and degree in dimensional direction k, respectively, and the parent coordinate ξ=[ξ₀, . . . , ξ_{d-1}]∈Ω̅.

### Simplicial

A multivariate Bernstein polynomial Bᵢ^{p}: Ω̅→ [symbol] is defined over the convex hull of the d-dimensional unit simplex Ω̅={ξ=[ξ₀, . . . , ξ_{d}]∈ [symbol] ^{d+1}:Σₖ₌₀^{d}ξₖ=1 and ξₖ≥0 for k=0, . . . , d} as

$${B}_{i}^{p} ( ξ ) = p ! {{\prod }_{k = 0}}^{d} \frac{{ξ}_{k}^{{i}_{k}}}{{i}_{k} !} \qquad ( 6.6 )$$

where i={iₖ:0≤k≤d, Σₖ₌₀^{d}iₖ=p} is an index tuple, p is the polynomial degree, and the parent coordinate ξ∈Ω̅ is commonly called a barycentric coordinate. For each boundary of the simplex, the nonzero entries in the basis are precisely the basis for the simplex of dimension d−1. Observe that the standard univariate Bernstein basis is merely a special case of the multivariate simplicial form.

### Tensor-Product Hybrid

A multivariate Bernstein polynomial Bᵢ^{p}:Ω̅→ [symbol] is defined over the domain Ω̅ constructed by taking the tensor product of an n-dimensional simplex with Bernstein basis Bⱼ^{p′}(ξ) and a (d−n)-dimensional simplex with Bernstein basis Bₖ^{p″}(ξ), 0<n<d,

$$\overline{Ω} = \{ ξ = [ {ξ}_{0} , … , {ξ}_{n} , {ξ}_{n + 1} , … , {ξ}_{d + 1} ] ∈ {d + 2}^{} : {{\sum }_{k = 0}}^{n} {ξ}_{k} = 1 , {{\sum }_{k = n + 1}}^{d + 1} {ξ}_{k} = 1 , and {ξ}_{k} \geq 0 for k = 0 , … , d + 1 \} \qquad ( 6.7 )$$

$$as$$

$${B}_{i}^{p} ( ξ ) = {B}_{j}^{{p}^{′}} ( ξ ) ⊗ {B}_{k}^{{p}^{″}} ( ξ )$$

where i={iₖ: 0≤k≤d+1, Σₖ₌₀ⁿ iₖ=p′, Σₖ₌ₙ₊₁^{d+1}iₖ=p″,} is an index tuple, p=(p′,p″) is the polynomial degree, and the parent coordinate ξ∈Ω̅ is the Cartesian product of the two lower-dimensional barycentric coordinates. Similar constructions exist for boxes, and tensor products of simplices and boxes.

### Bernstein-Like Bases

Although the focus is on the polynomial Bernstein basis in this work, this is not a necessary requirement. It has been shown that quasi-extended Chebyshev (QEC) spaces possess a Bernstein-like basis with the following property: Let ε be an (n+1)-dimensional QEC-space on the bounded closed interval [a, b]. Then, ε possesses a quasi-Bernstein-like basis relative to (a, b), that is, a basis Bᵢ: Ω̅→ [symbol] , i=0, 1, . . . , n such that:
B₀(a)≠0, and B₀ vanishes n times at b; Bₙ(b)≠0, and Bₙ vanishes n times at a;
for 1≤i≤n−1, Bᵢ vanishes exactly i times at a and exactly (n−i) times at b.
for 0≤i≤n, Bᵢ is positive on (a, b).
   This property is the key requirement for the U-spline definition and construction and so U-splines can be constructed from meshes with a QEC space assigned to each cell.

### The Bézier Mesh

As mentioned in the previous section, a key property of U-splines is the ability to construct, a spline basis on an unstructured Bézier mesh. A Bézier mesh B is defined by
1. A polyhedral mesh topology,
2. A local parameterization on each cell in the mesh,
3. A Bernstein space [symbol] assigned to each cell in the mesh,
4. A minimum level of continuity specified on each interface between cells.

In this section, the notation used throughout the remainder of this paper to describe a Bézier mesh is introduced.

### Topology

Formally, the Bézier mesh is a tiling of a d-dimensional manifold with box and simplex k-cells, 0≤k≤d, where k is the dimension of the cell. More precisely, the Bézier mesh B is a cell complex where:
Each k-dimensional cell c is a closed subspace of [symbol] ^{d},
Any lower-dimensional cell a⊂c is also in B.
The non-empty intersection of any two cells a and b in B is a lower-dimensional cell contained in both.

We have the following correspondence to common mesh entities:

| | d = 1 | d = 2 | d = 3 |
|---|---|---|---|
| d-cell | Edge | Face | Volume |
| (d − 1)-cell | Vertex | Edge | Face |
| (d − 2)-cell | — | Vertex | Edge |
| (d − 3)-cell | — | — | Vertex |

When a dimension-agnostic description is appropriate for a concept, we employ the generic terminology d-cell, (d−1)-cell, etc. For simplicity, we occasionally refer to d-cells, or elements, by E, (d−1)-cells, or interfaces, by I, (d−2)-cells by w, 2-cells, or faces, by f, 1-cells, or edges, by e, and 0-cells, or vertices, by v. We denote the set of cells of dimension k in the mesh B by C^{k}(B).

### Adjacencies

It is useful to define a set of k-cell adjacency operators. Given a cell c and a d-dimensional mesh B, the set of k-cells adjacent to e is denoted by

ADJ^{k}(c)={a∈C^{k}(B): a∩c≠ø} (6.8)

and |ADJ^{k}(c)| denotes the number of k-cells adjacent to c. Chained adjacency sets are written as

$${ADJ}^{{k}_{1}} ∘ {ADJ}^{{k}_{0}} ( c ) = {⋃}_{a ∈ {ADJ}^{{k}_{0}} ( c )} {ADJ}^{{k}_{1}} ( a ) . \qquad ( 6.9 )$$

The boundary of a k-cell c is denoted by

∂c=ADJ^{k-1}(c). (6.10)

Given a k-cell a^{k}, k<d, and an adjacent (k+1)-cell b^{k+1}∈ADJ^{k+1}(a^{k}), the set PC(a^{k}, b^{k+1}) contains all (k+1)-cells which are both adjacent to the given k-cell a^{k} and perpendicular to the given (k+1)-cell b^{k+1}∈ADJ^{k+1}(a^{k}) and is defined as

PC(a^{k},b^{k+1})=(ADJ^{k+}(a^{k})∩ADJ^{k+1}∘ADJ^{d}(b^{k+1}))\b^{k+1}. (6.11)

k-Cell Types

A k-cell c^{k} is an interior cell if every interface adjacent to c^{k} is adjacent to two elements. Otherwise, it is a boundary cell. We say that c^{k} is regular if it is possible to imbed the adjacent elements into a regular grid. More specifically, in a d-dimensional mesh a vertex v is regular if all elements in ADJ^{d}(v) are box-type and |ADJ^{d}(v)|=2^{(|ADJ}^{¹}^{(v)|-d)}, and a (d−2)-cell w is regular if all elements in ADJ^{d}(w) are box-type and |ADJ^{d}(w)|=2^{(|ADJ}^{^{d-1}}^{(w)|-2)}. Otherwise, it is an extraordinary cell. Note that all vertices and (d−2)-cells adjacent to simplex elements are considered to be extraordinary for this work. On d-dimensional meshes, an extraordinary (d−2)-cell w is said to be valence-m if |ADJ^{d-1}(w)|=m.

### Cell Domains and Parameterization

Building splines over a Bézier mesh requires that a domain and right-handed coordinate system be specified over each cell. These coordinate systems may change from cell to cell to accommodate extraordinary cells or cells of different type, such as between box-like and simplicial cells.

Each cell c is assigned a parent domain Ω̅ and a right-handed coordinate system ξ∈̅Ω or, when referencing a particular cell c, Ω̅^{C} and ξ^{c}, respectively. We define Ω̅^{B}=∪_{c∈B}Ω̅^{c}. For box cells, Ω̅ is assumed to be a unit hypercube with a cartesian coordinate system and, for simplicial cells, Ω̅ is taken to be the convex hull of a unit simplex with barycentric coordinates. The parent domain is defined in this way to simplify or standardize the implementation and evaluation of a Bernstein basis.

Likewise, each cell c is also assigned a parametric domain \hat{Ω} and a right-handed coordinate system s∈\hat{Ω} or, when referencing a particular cell c, \hat{Ω}^{c} and s^{c}, respectively. We define \hat{Ω}^{B}=∪_{c∈B} \hat{Ω}^{c}. The parametric domain of a box cell is assumed to be a hyperrectangle with Cartesian coordinates. The parametric domain of a simplicial cell will be the convex hull described by the simplex whose edges have been assigned arbitrary lengths but which are usually set to be equal to the parametric size of adjacent box cells. Barycentric coordinates are again assumed for the simplicial parametric domain. Although not discussed further in this work, the relative parametric sizes of adjacent cells must be chosen carefully so as to admit a well-defined smooth spline basis.

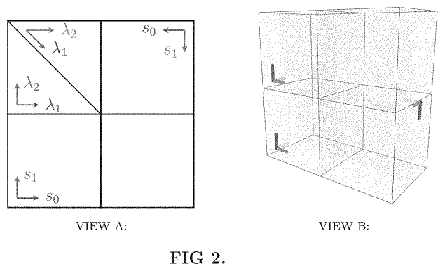

In two dimensions, we will often refer to the parametric coordinate s as [s₀, s₁] on a quadrilateral face and [λ₀, λ₁, λ₂] on a triangular face, as shown in FIG. 2, VIEW A. In three dimensions, we will refer to the parametric coordinate s as [s₀, s₁, s₂] on a hexahedral volume, as shown in FIG. 2, VIEW B. The operator s_{E}^{⊥}(|) returns the set of parametric coordinates on element. E that are normal to the interface |∈ADJ^{d-1}(E) and the operator s_{E}^{∥}(c^{k}) returns the set of parametric coordinates on element E that are parallel to an adjacent k-cell c^{k}∈ADJ^{k}(E). Similarly, s_{Ω}^{∥}(c^{k}) returns the set of coordinates in submesh domain Ω (section 6.6.2) that are parallel to c^{k}.

If required, the orientation of a cell's parametric coordinate system will be specified by a small axis located at the origin of the coordinate system. If the small axis is omitted, a cell on a two-dimensional mesh is assumed to be oriented with the page, with the origin of the parametric coordinate system at the bottom-left corner (see FIG. 2, VIEW A). Note that on triangles, typically only the barycentric axes associated with λ₁ and λ₂ are shown, since λ₀=1−λ₁−λ₂. On volumetric meshes, as shown in FIG. 2, VIEW B, a similar small axis may be used to specify the orientation of the parameterization. The parametric coordinate systems on a volumetric Bézier mesh can be rotated relative to each other as shown on the bottom two cells in FIG. 2, VIEW B.

For every cell c, we assume there exists a linear transformation between the parent and parametric domains wherein the parametric domain can be described in terms of the parent coordinates ξ^{c}∈Ω̅^{c}. We denote this linear mapping by ϕ^{c}: Ω̅^{c}→\hat{Ω}^{c} where s^{c}=ϕ^{c}(ξ^{c})=A^{c}ξ^{c}. Note that for box cells ϕ^{c} is a simple scaling, i.e., the matrix A^{c} is diagonal.

### Cell Space and Degree

A box or simplicial Bernstein space [symbol] is assigned to each cell c and is denoted by [symbol] ^{c}. We denote the total degree of polynomial completeness of the Bernstein space on c by |p^{c}|.

The following derived quantities will be used extensively in the description of the U-spline algorithm. Let p_{I}^{⊥}(E) denote the degree on a d-cell E in the direction perpendicular to the adjacent interface I and pₑ^{∥}(E) denote the degree on a d-cell E in the direction parallel to the adjacent edge e. Let p_{c}_{^{k}}^{∥}(E), 0≤k≤d denote the k-dimensional tuple p containing the degrees on E in the directions parallel to the cell c^{k}. We can then define the useful operators pₘₐₓ^{⊥}(I), pₘᵢₙ^{⊥}(I), pₘₐₓ^{∥}(e), and pₘᵢₙ^{∥}(e) as

$${p}_{max}^{⊥} ( l ) = {max}_{E ∈ {ADJ}^{d} ( l )} {p}_{l}^{⊥} ( E ) , \qquad ( 6.12 )$$

$${p}_{min}^{⊥} ( l ) = {min}_{E ∈ {ADJ}^{d} ( l )} {p}_{l}^{⊥} ( E ) , \qquad ( 6.13 )$$

$${p}_{max}^{‖} ( e ) = {max}_{E ∈ {ADJ}^{d} ( e )} {p}_{e}^{‖} ( E ) , \qquad ( 6.14 )$$

$${p}_{min}^{‖} ( e ) = {min}_{E ∈ {ADJ}^{d} ( e )} {p}_{e}^{‖} ( E ) . \qquad ( 6.15 )$$

To measure the minimum or maximum degree in a direction parallel to an interface I and perpendicular to a (d−2)-cell w adjacent to the interface we define pₘᵢₙ^{∥,⊥}(I, w) and pₘₐₓ^{∥,⊥}(I, w) as

$${p}_{min}^{‖ , ⊥} ( l , w ) = {min}_{E ∈ {ADJ}^{d} ( l )} {p}_{{l}^{′}}^{⊥} ( E ) , {l}^{′} ∈ ( {ADJ}^{d - 1} ( E ) ⋂ {ADJ}^{d - 1} ( w ) ∖ l ) , \qquad ( 6.16 )$$

$${p}_{max}^{‖ , ⊥} ( l , w ) = {max}_{E ∈ {ADJ}^{d} ( l )} {p}_{{l}^{′}}^{⊥} ( E ) , {l}^{′} ∈ ( {ADJ}^{d - 1} ( E ) ⋂ {ADJ}^{d - 1} ( w ) ∖ l ) . \qquad ( 6.17 )$$

### Interface Continuity

Given a d-dimensional mesh B, each interface I is assigned a required minimum continuity ϑ. We denote the continuity [symbol] assigned to an interface I by [symbol] ^{I}. Note that for certain mesh configurations, the U-spline basis may be smoother than the specified conditions on the interfaces. We say that an interface I has reduced continuity with respect to an adjacent d-cell E if [symbol] ^{I}<p_{I}^{⊥}(E)−1 where p_{I}^{⊥}(E) is the degree on a d-cell E in the direction perpendicular to the adjacent interface I. We say that an interface is creased if it has been assigned [symbol] ⁰ or [symbol] ⁻¹ continuity and a (d−2)-cell is creased if all adjacent interfaces are creased. The operator [symbol] ₘₐₓ^{⊥}(a^{k}, b^{k+1}) returns the maximum continuity of all the interfaces that are both adjacent to the given k-cell a^{k} and perpendicular to the given (k+1)-cell b^{k+1} ∈ADJ^{k+1}(a^{k}), and is defined as

$${ϑ}_{max}^{⊥} ( {a}^{k} , {b}^{k + 1} ) = {max}_{l ∈ Pl ( {a}^{k} , {b}^{k + 1} )} {ϑ}^{l} \qquad ( 6.18 )$$

where

PI(a^{k},b^{k+1})={I∈ADJ^{d-1}(a^{k})∩ADJ^{d-1}∘ADJ^{d}(b^{k+1}):∀E∈ADJ^{d}(b^{k+1}),s_{E}^{⊥}(I)⊆s_{E}^{∥}(b^{k+1}}. (6.19)

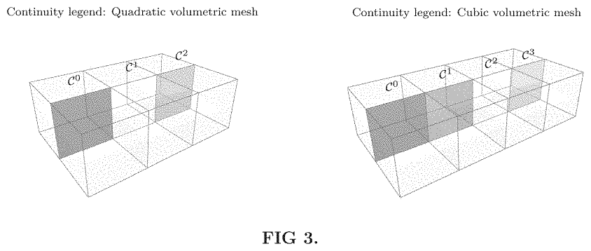

The continuity of interfaces on two-dimensional figures will be indicated by an accompanying legend or a description in the caption. The continuity of interfaces on volumetric meshes will be indicated by the description in the caption and will follow the pattern indicated in FIG. 3. The most common continuity in the mesh and boundary interfaces are often left colorless for greater clarity.

### Supersmooth Interfaces

When setting the smoothness of an interface we normally require that

[symbol]

^{I}<pₘᵢₙ^{⊥}(I) (6.20)

and say that [symbol] ^{I} is maximally smooth if

[symbol]

^{I}=pₘᵢₙ^{⊥}(I)−1. (6.21)

Additional options are possible with U-splines. We say an interface I is supersmooth if

[symbol]

^{I}=p_{I}^{⊥}(E) (6.22)

for some element E adjacent to I. If, additionally

[symbol]

^{I}=Pₘᵢₙ^{⊥}(I) (6.23)

then the supersmooth interface is in fact [symbol] ^{∞}. Note that a supersmooth interface is a generalization of the concept of T-junctions.

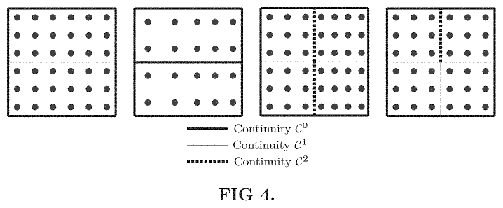

We do not explore this concept further but rather restrict supersmoothness to the simple case where, given two elements a and b that share interface I, we allow [symbol] ^{I}=pₘₐₓ^{⊥}(I) and require that p_{I}^{⊥}(a)=p_{I}^{⊥}(b) and p_{I}^{∥}(a)=p_{I}^{∥}(b). FIG. 4 shows several examples of supersmooth interfaces. On the left, an example of a two-dimensional Bézier mesh with maximally smooth interfaces (eq. (6.21)) is shown. The two meshes shown in the center have supersmooth interfaces with differing perpendicular degree (eq. (6.22)). On the right, a [symbol] ^{∞} supersmooth interface in a configuration which is equivalent to a T-junction (eq. (6.23)) is shown.

### Bernstein Representations

We now turn our attention to how spline functions are defined over a Bézier mesh. As discussed previously, classical spline technologies, such as NURBS and T-splines, rely on a certain level of global structure to define basis functions. In the case of NURBS, all cells in one direction must use the same polynomial degree and higher-dimensional splines are constructed by global tensor products of univariate NURBS. T-splines also require the specification of global polynomial degree and, while T-splines require less global structure than NURBS, each T-spline basis function is constructed on a local tensor product region. For T-splines, it can be difficult to infer the properties of the underlying spline space by examining the associated T-mesh.

A key practical and conceptual development in the field of IGA was the advent of Bézier extraction as an analysis technology. Bézier extraction allows global spline functions to be evaluated locally on a Bézier cell. More generally, Bézier extraction is a method of providing a Bernstein representation of spline functions while maintaining the connection to global spline representation. Bernstein representations are central to representing U-splines, and this section serves to present the necessary notation that will be used throughout the rest of this paper.

### Indexing

The ith Bernstein polynomial on a k-cell c in the mesh forms a unique index, denoted by i^{c}, that specifies both c and the local Bernstein function index i. For simplicity, and when the meaning is unambiguous, we will often just use i to denote both the function index and cell. The set of all indices for all Bernstein polynomials defined over all cells in B is denoted by ID(B) and ID(c) is used to represent the indices for c. We denote the number of indices in any index set by |ID|. The cell associated with a given index is denoted by cell(i) and the set of cells associated with an index set ID is written as

$$C ( ID ) := {⋃}_{i ∈ ID} cell ( i ) . \qquad ( 6.24 )$$

We will often denote a set of index sets by ID.

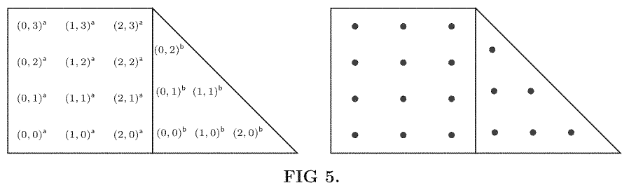

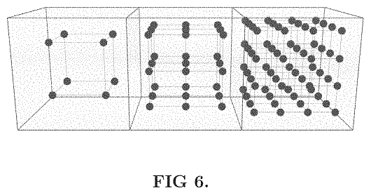

FIG. 5 shows an example of indices on two-dimensional cells. The positioning and quantity of indices indicates the polynomial degree of the Bernstein functions on each cell in each parametric direction. For example, the quadrilateral cell in FIG. 5 is quadratic in so and cubic in s₁. On triangular cells, we use the convention to list only indices i₁ and i₂ since on a two-dimensional simplicial Bernstein polynomial, one of the indices is fixed by the choice of polynomial degree and the other two indices: i₀=p−i₁−i₂, iₖ ∈i. In figures where the specific index is either apparent from context or not required, we represent indices as small circles or spheres as shown in FIGS. 5 and 6. Note that we draw these circles inset from the boundary of the cell to avoid confusion between functions on adjacent cells.

### Bernstein Form

We say that a piecewise function ƒ:\hat{Ω}^{B}→ [symbol] can be written in Bernstein form on the mesh B if it may be expressed as a linear combination of the Bernstein polynomials on each d-cell E in the mesh. In other words, given a set of Bernstein coefficients

c[B]={cᵢ}i∈ID(B) (6.25)

the Bernstein form of ƒ is

$$f ( s ) = {\sum }_{i ∈ ID ( B )} {c}_{i} {B}_{i} ( {ϕ}^{- 1} ( s ) ) ∀ s ∈ {\hat{Ω}}^{B} . \qquad ( 6.26 )$$

We will often use the Bernstein coefficients c[B] of ƒ and the function ƒ interchangeably.

The index set of ƒ, or equivalently, c[B], is ID(B) by definition since the domain of ƒ is \hat{Ω}^{B}. Functions that are nonzero on only a portion of the Bézier mesh S⊂B will typically have a large number of zero coefficients and so we adopt a sparse representation that contains only the indices that correspond to nonzero coefficients. The indices associated with the nonzero Bernstein coefficients in c[B] or ƒ is denoted by

ID(c[B])={i∈ID(B): c[B] [symbol] |cᵢ|>0}. (6.27)

The nonzero support of ƒ, denoted by supp₊(ƒ) or supp₊(c[B]), is the parametric domain over which the function is nonzero

$${supp}_{+} ( f ) = {⋃}_{i ∈ ID ( f )} {\hat{Ω}}^{c ( i )} . \qquad ( 6.28 )$$

Given a function ƒ in Bernstein form and an index set ID, we define the restriction of ƒ, denoted by ƒ|_{ID} or, equivalently, c[B]|_{ID}, to be the function having the same Bernstein coefficient, values as ƒ for all indices in ID and zero for all indices not in ID.

### The Trace Mapping Matrix

Assume that we are given an element E, with associated parametric domain \hat{Ω}^{E}, and an adjacent (lower-dimensional) interface I, with parametric domain \hat{Ω}^{I}⊂\hat{Ω}^{E} and a map ϕ_{1→E}:\hat{Ω}^{I}→\hat{Ω}^{E}, and Bernstein bases Bₖ^{E}:\hat{Ω}^{E}→ [symbol] and Bᵢ^{I}:\hat{Ω}^{I}+ [symbol] satisfying

$${B}_{i}^{E} {◦ϕ}_{I \to E} = {\sum }_{j ∈ ID ( \vert )} {c}_{j} {B}_{j}^{\vert}$$

(all functions from the element basis can be represented as linear combinations of interface basis functions). Then, the components of the trace mapping matrix M are

$${[ M ]}_{ij} = {〈 {\overline{B}}_{i}^{l} , {B}_{j}^{E} 〉}_{l} = {\int }_{{\hat{Ω}}^{l}} {\overline{B}}_{i}^{l} ( s ) {B}_{j}^{E} ( {ϕ}_{I \to E} ( s ) ) d \hat{Ω} \qquad ( 6.29 )$$

where B̅ᵢ^{I} is dual to Bᵢ^{I} in the sense that [symbol] B̅ᵢ^{I},Bⱼ^{I} [symbol] _{I}=δᵢⱼ.

We use D_{I⊥}ⁿƒ to indicate the nth directional derivative of the function ƒ:\hat{Ω}^{c}→ [symbol] with respect to the direction perpendicular to the interface I, the components of the trace derivative mapping matrix Mⁿ are

$${[ {M}^{n} ]}_{ij} = 〈 {\overline{B}}_{i}^{l} , {D}_{l ⊥}^{n} {B}_{j}^{E} 〉 = {\int }_{{\hat{Ω}}^{l}} {\overline{B}}_{i}^{l} ( s ) ( {D}_{l ⊥}^{n} {B}_{j}^{E} ) ( {ϕ}_{I \to E} ( s ) ) ) d \hat{Ω} . \qquad ( 6.3 )$$

For a given i∈ID(I) the set of indices on E that correspond to the nonzero coefficients on the ith row of M is denoted NZ and is defined as

NZ(M,i)={j∈ID(E):|[M]ᵢⱼ|>0}. (6.31)

Note that, in practice, there are efficient approaches for determining the indices of the nonzero coefficients of the trace mapping matrix without computing the matrix terms via integration.

### Continuity Constraints

As mentioned in section 6.2, a Bézier mesh B has a prescribed minimum continuity [symbol] assigned to each interface I. That, is, a piecewise function ƒ defined over \hat{Ω}^{B} should have at least [symbol] +1 continuous derivatives across 1. Given a function ƒ in Bernstein form, we may state a continuity constraint in terms of the function's Bernstein coefficients, c[B]. We denote a set of continuity constraint coefficients as r. Then, we may write a homogeneous continuity constraint on a piecewise function in Bernstein form as

$${\sum }_{i ∈ ID ( r )} {r}_{i} {c}_{i} = 0. \qquad ( 6.32 )$$

An abstract approach to assembling the constraint sets is presented here, which may be applied to determine the constraint equations for meshes of any dimension.

### Constraint Sets

The set of continuity constraints associated with an interface I is denoted by R(I) and the set of all continuity constraints defined over B is denoted by

$$R ( B ) = {⋃}_{I ∈ B} R ( I ) . \qquad ( 6.33 )$$

Given a k-dimensional cell c^{k}∈C^{k}(B), 0≤k≤d−1, the associated set of continuity constraints is the union of all constraint systems associated with interfaces satisfying I∩c^{k}≠ø:

$$R ( {c}^{k} ) = {⋃}_{I ∈ {ADJ}^{d - 1} ( {c}^{k} )} R ( I ) . \qquad ( 6.34 )$$

Given an index set ID and a continuity constraint, r, the restriction of the constraint to the index set is the constraint that results from keeping only the coefficients associated with indices in the index set. It is denoted by r|_{ID}. Given an index set ID and a set of continuity constraints R, we denote the restricted set of continuity constraints by

R|_{ID}={r|_{ID}:∥r|_{ID}∥>0,r∈R}. (6.35)

In other words, any constraints that are empty after the restriction to the index set has occurred are removed.

### Constraint Matrices

Given a set of continuity constraints R, an index set ID, and a function i_{ID} that assigns a unique integer i∈0, . . . , |ID|−1 to every index in ID, we can construct a matrix R|_{ID}∈ [symbol] ^{|R|×|ID|}, called a (restricted) constraint matrix. For simplicity, the constraint matrix associated with a k-cell c is denoted by R(c) and the constraint matrix for the entire Bézier mesh B is denoted by R(B).

### Constraint Construction

We consider constructing constraints on the interface I between two elements a and b on a d-dimensional Bézier mesh, where I=a∩b. Given two functions defined in Bernstein form, ƒ^{a} defined over a as

$${f}^{a} ( s ) = {\sum }_{j ∈ ID ( a )} {c}_{j} {B}_{j}^{a} ( s ) \qquad ( 6.36 )$$

and ƒ^{b} defined over b as

$${f}^{b} ( s ) = {\sum }_{j ∈ ID ( b )} {c}_{j} {B}_{j}^{b} ( s ) . \qquad ( 6.37 )$$

We also require the maps from the shared interface I to a and b: ϕ_{I→a}:\hat{Ω}^{I}→\hat{Ω}^{a} and ϕ_{I→b}:\hat{Ω}^{I}→\hat{Ω}^{b}.

If the functions ƒ^{a} and ƒ^{b} satisfy

ƒ^{a}oϕ_{I→a}(s)=ƒ^{b}oϕ_{I→b}(s) (6.38)

for any s∈\hat{Ω}I then we say that they are value continuous or [symbol] ⁰. This pointwise constraint over the interface can be converted to a constraint on the coefficients that define the two function through the use of the trace mapping matrix defined previously.

We choose a basis defined on the interface that is sufficient to generate the trace mapping matrices for both a and b: M^{0,a} and M^{0,b}. Equipped with these matrices, the value constraint given in eq. (6.38) is equivalent, to

$${\sum }_{j ∈ ID ( a )} {[ {M}^{0 , a} ]}_{ij} {c}_{j} = {\sum }_{k ∈ ID ( b )} {[ {M}^{0 , b} ]}_{ik} {c}_{k} \qquad ( 6.39 )$$

for all indices i associated with the basis selected for the interface. It is often convenient to express constraints in homogeneous form:

$${\sum }_{j ∈ ID ( a )} {[ {M}^{a} ]}_{ij} {c}_{j} - {\sum }_{k ∈ ID ( b )} {[ {M}^{b} ]}_{ik} {c}_{k} = 0. \qquad ( 6.4 )$$

Continuity constraints associated with the nth derivative can be constructed by using the matrices M^{n,a} and M^{n,b}.

Other work has been done that allows for higher-order continuity constraints for simplex cells to be stated similarly. Thus, the [symbol] ⁿ continuity constraint equations are

$${\sum }_{j ∈ ID ( a )} {[ {M}^{{𝒞}^{n} , a} ]}_{ij} {c}_{j} - {\sum }_{k ∈ ID ( b )} {[ {M}^{{𝒞}^{n} , b} ]}_{ik} {c}_{k} = 0 , i ∈ ID ( I ) . \qquad ( 6.41 )$$

For detailed derivations of the continuity constraints in two dimensions see section 6.12.

### Splines and the Nullspace Problem

Given R(B) we can form the corresponding vector nullspace problem: Determine the nullspace N⊆ [symbol] ^{|ID(B)|} where

N(B)=span{c[B]∈ [symbol] ^{|ID(B)|}:R(B)c[B]=0}. (6.42)

The rank-nullity theorem tells us that the dimension of the nullspace is dim N=|ID(B)|−rank(R(B)).

### Basis Vectors

As with any vector space, any vector in N can be represented as a linear combination of the members of a linearly independent set of vectors. The Ath such vector is called a basis vector, denoted by u_{A}, and the set of basis vectors, denoted by UV(B), form a basis for the nullspace. Of particular importance is determining a sparse positive basis for N(B). This means that, we seek to find a set of basis vectors where the set of Bernstein coefficients that define the basis vector has a small number of positive nonzero coefficients (and no negative coefficients). The set of indices associated with the nonzero coefficients of a basis vector ID(u) is sufficiently important that we introduce the symbol id to represent these sets. We also define the set of index sets associated with the basis vectors

UI={ID(u),u∈UV}. (6.43)

### Basis Functions

Since the Bernstein coefficients that compose each basis vector correspond to a set of Bernstein basis functions we can also formulate an equivalent operator nullspace problem. In this case the commonly used terminology changes slightly: Given the Bernstein space [symbol] (B), the constraint space [symbol] (B), and the linear constraint operator R(B) [symbol] (B)→ [symbol] (B), determine the linear subspace of [symbol] (B), called the kernel or nullspace of R(B) and denoted by [symbol] (B), where

[symbol]

(B)={ƒ∈ [symbol] (B):R(B)(ƒ)=0}. (6.44)

In this case, there is a set of functions, denoted by UF(B), that span the null space [symbol] (B). The Ath such function is called a basis function, denoted by N_{A}.

### Spline Form

Due to the equivalence between eqs. (6.42) and (6.44), the basis functions N_{A}:\hat{Ω}^{B}→ [symbol] in UF(B) not only define [symbol] (B) directly as

$$( B ) = \{ f : f = {\sum }_{{N}_{A} ∈ UF ( B )} {c}_{A} {N}_{A} , {c}_{A} ∈ \} \qquad ( 6.45 )$$

but are also written in terms of the basis vectors in UV(B) as

$${N}_{A} ( s ) = {\sum }_{i ∈ ID ( B )} {u}_{i}^{A} {B}_{i} ( s ) ∀ s ∈ {\hat{Ω}}^{c} ∀ c ∈ B \qquad ( 6.46 )$$

where uᵢ^{A} ∈u_{A}∈UV(B).

Importantly, since each N_{A} satisfies the continuity constraints on \hat{Ω}^{B} it is immediately obvious that N_{A} is not only a function in Bernstein form but also a spline, i.e., it is a piecewise function that satisfies the continuity constraints across all cell interfaces. In other words, finding a sparse positive basis for the nullspace N is equivalent to finding a set of spline basis functions that defines an equivalent spline space. This observation is fundamental to the U-spline construction algorithms presented in this paper.

### Extracted Form

For convenience, we often arrange the Bernstein and U-spline basis functions that are nonzero over a k-cell c into vectors, denoted by B^{c} and N^{c}, respectively. We can then arrange the Bernstein basis vector coefficients on c for each U-spline basis function into corresponding rows in a mat C^{c} ∈ [symbol] ^{|N}^{^{c}}^{|×|B}^{^{c}}^{|}, called a cell or element extraction matrix. We then have the extracted form of the U-spline basis:

N^{c}(ξ^{c})=C^{c}B^{c}(ξ^{c}),ξ^{c}∈Ω̅^{c}. (6.47)

In this case, we call the Bernstein basis vector coefficients extraction coefficients. Note that at times it is convenient to combine the cell extraction matrices into a global extraction matrix [symbol] . Representing U-spline basis functions in extracted form is a powerful and convenient abstraction when generalizing finite element frameworks to accommodate smooth spline bases like U-splines. In particular, it is the preferred and simplest representation for smooth splines when the underlying algorithms used to generate the spline basis are not the primary concern.

### Bernstein Basis Metrics and Index Measurements

It will be necessary to perform various measurements on submeshes to define relationships between Bernstein bases on adjacent cells. Foundational to these techniques are the Greville points associated with the Bernstein basis functions.

### Greville Points

The ith Bernstein polynomial on a k-cell c in the mesh can be associated with a parent point known as a Greville point g̅ or a domain point. For example, for a univariate Bernstein basis function of degree p defined on Ω̅=[0,1] this point or abscissa is given by i/p∈Ω̅ and, for a tensor product function, the point is given by the ordered tuple of parent Greville points for each of the Bernstein functions appearing in the product:

$$\overline{g} ( i ) = ( c , ( \frac{{i}_{k}}{{[ {p}^{c} ]}_{k}} , {i}_{k} ∈ i ) ) . \qquad ( 6.48 )$$

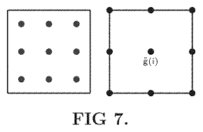

An example is shown in FIG. 7.

### Submesh Domains

We now need to identify a subdomain and coordinate system that encompasses multiple cells and that allows us to easily take advantage of the ordered derivative property of the Bernstein basis defined over each cell. To accomplish this, given a submesh K⊆B, a submesh domain Ω and right-handed orthogonal coordinate system α∈Ω is constructed. In other words, for a given coordinate α∈Ω we have that

$$α = {\sum }_{k} {α}_{k} {e}_{k} \qquad ( 6.49 )$$

where

eᵢ·eⱼ=δᵢⱼ. (6.50)

Note that the origin can be placed anywhere in Ω but is usually placed to simplify the problem at hand. When referencing a particular submesh K, we use Ω^{K} and α^{K}, respectively. Note that the submesh domain corresponding to a set of indices ID is created by setting K=C(ID).

To construct Ω^{K} we define a set of affine transformations, denoted by {γ^{c}}_{c∈K}, γ^{c}: [symbol] →Ω^{c}, where

γ^{c}(ξ^{c})=A^{c}ξ^{c}+α^{c}∀ξ^{c}∈ [symbol] (6.51)

and A^{c}=S^{c} R^{c} is a transformation composed of a scaling S^{c} and a rotation R^{c}. The submesh domain is now constructed as

$${Ω}^{K} = {⋃}_{c ∈ K} {φ}^{c} ( {\overline{Ω}}^{c} ) . \qquad ( 6.52 )$$

### Indexed Submesh Domains

The choice of the scaling operator S^{c} is particularly important and can be chosen to expose certain properties of the Bernstein basis. In particular, we can define a particularly simple scaling that can be leveraged to take advantage of the ordered derivative property of the Bernstein basis. In this case, we define the scaling S^{c} to be

$${S}^{c} = [ \begin{matrix}{p}_{0}^{c} & … & 0 \\ ⋮ & ⋱ & ⋮ \\ 0 & … & {p}_{d - 1}^{c}\end{matrix} ] . \qquad ( 6.53 )$$

In this case, we have that

i^{c}=S^{c}g̅(i^{c}) (6.54)

and the submesh Greville points g∈ [symbol] ^{d} are defined by the mapping γ^{c} as

g=γ^{c}(g̅). (6.55)

Due to the fact that, under the scaling chosen, all the submesh Greville points are composed of integers, we call this type of submesh domain an index domain and that the domain is indexed by the submesh Greville points g. A set of submesh Greville points is denoted by G and a set of sets of submesh Greville points is denoted by G.

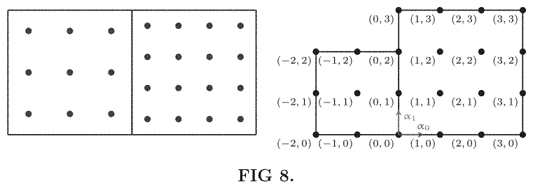

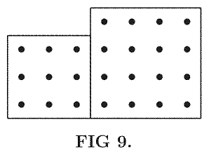

We will often choose the transformations γ^{c} so that both the indices and certain chosen features align. For example, when considering two cells of differing degree, the index map will not preserve all topological relationships that exist between the elements (the same vertex may be mapped to two different points under two adjacent maps, etc.) and so we choose to preserve relative orientation and require that a single vertex be preserved under adjacent maps. This is shown in FIG. 8. To help differentiate between Greville points on adjacent elements, we often will draw the circles representing the Greville points with respect to a scaled element inset from the boundary, as seen in FIG. 9.

### Equivalence Relations and Classes

Recall that an equivalence relation partitions a set into equivalence classes. An equivalence class is a set of objects which are defined as equivalent by a given equivalence relation. The set of equivalence classes induced by an equivalence relation is commonly called a partition.

The equivalence relations used here will be based on a classical result in finite-dimensional vector spaces. Given any subspace [symbol] ⊆Ω, any vector α∈Ω can be written uniquely in terms of the parallel and perpendicular projectors [symbol] :Ω→ [symbol] and [symbol] :Ω→ [symbol] ( [symbol] ) as

x= [symbol] (α)+ [symbol] (α). (6.56)

Now, given two Greville points g and h we define the equivalence relation [symbol] to be true if [symbol] (g)= [symbol] (h) and false otherwise and the equivalence relation [symbol] to be true if [symbol] (g)= [symbol] (h) and false otherwise. When distinguishing between parallel and perpendicular projectors is not important we will use the superscript * to convey that the corresponding statement holds for either case.

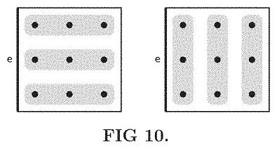

These equivalence relations can then be used to create corresponding partitions of a set of Greville points G denoted by G/ [symbol] . We see this in FIG. 10 where the Greville points on a cell c are partitioned with respect to an edge e using the equivalence relations [symbol] and [symbol] forming partitions G(c)/ [symbol] and G(c)/ [symbol] . We define the shorthand

[symbol]

=G/ [symbol] . (6.57)

and for any equivalence class G∈ [symbol] we define

[symbol]

(G)= [symbol] (g),g∈G∈ [symbol] (6.58)

since every point in an equivalence class has the same projected value.

We also extend the equivalence relation [symbol] to sets of points. We say that a set of points A is equivalent to another set of points B if they project to the same set of points under the projection

[symbol]

(A)= [symbol] (B) (6.59)

We can partition sets containing sets of points with this relation.

### Alignment

In order to compare indices on two or more adjacent elements, we define the concept of alignment. We first introduce the concept in two dimensions where an intuitive geometric description is available and then generalize those ideas to arbitrary dimensions.

### Alignment in Two Dimensions

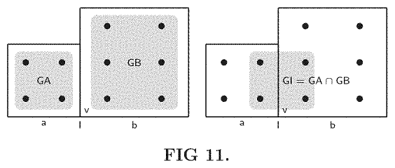

We consider two elements a and b on a two-dimensional mesh. In order to compare indices on a and b, we construct an index domain on the two elements so that a set of boundary edges {e∈∂a∩b:v∩e≠ø} that share a common vertex v are aligned and so that v lies at the origin. An example of an index domain satisfying these conditions is shown in FIG. 8. Next, we form the set of points shared between both elements under this index mapping GI=GA∩GB, where GA are the points on element, a and GB are the points on element b. FIG. 11 shows an example of these sets on two adjacent elements with degrees (1, 1) and (1, 2).

For each of the three sets GA, GB, and GI we determine the projected point that is farthest from v:

$${g}_{max}^{a} = g ∈ {π}_{I}^{‖} ( GA ) : {‖ g - v ‖}_{2} = {max}_{g ∈ {π}_{I}^{‖} ( GA )} {‖ g - v ‖}_{2} , \qquad ( 6.6 )$$

$${g}_{max}^{b} = g ∈ {π}_{I}^{‖} ( GB ) : {‖ g - v ‖}_{2} = {max}_{g ∈ {π}_{I}^{‖} ( GB )} {‖ g - v ‖}_{2} , \qquad ( 6.61 )$$

$${g}_{max}^{I} = g ∈ GI : {‖ g - v ‖}_{2} = {max}_{g ∈ GI} {‖ g - v ‖}_{2} . \qquad ( 6.62 )$$

These points can be used to define difference vectors:

Δgₘₐₓ^{a}=gₘₐₓ^{a}−gₘₐₓ^{I} (6.63)

Δgₘₐₓ^{b}=gₘₐₓ^{b}−gₘₐₓ^{I}. (6.64)

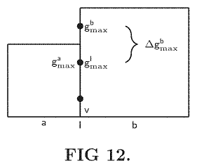

FIG. 12 shows the projected points for the elements in FIG. 11 as black circles along the shared interface I. The associated difference vector Δg_{mad}^{b} is shown with a curly bracket. The difference vector Δgₘₐₓ^{a} in this example has length zero and is not shown.

Given a difference vector Δgₘₐₓ^{a} we define a set of offset points given a point g as

Offset_{g}(Δgₘₐₓ^{a})={g}∪{g+Δgₘₐₓ^{a}}. (6.65)

Now, using AABB(P) to denote an axis-aligned bounding box associated with a set of points P, for every point g^{I}∈GI there are unique regions associated with GA and GB

Ω_{g}_{^{I}}^{a}=AABB(Offset_{g}_{^{I}}(Δgₘₐₓ^{a})), (6.66)

Ω_{g}_{^{I}}^{b}=AABB(Offset_{g}_{^{I}}(Δgₘₐₓ^{b})), (6.67)

Each region defines a subset of the equivalence classes on the associated faces:

GA_{I,g}_{^{I}}^{∥}={G∈GA_{I}^{∥}:π_{I}^{∥}(G)⊆Ω_{g}_{^{I}}^{a},G_{I}^{∥}=GA/ [symbol] }, (6.68)

GB_{I,g}_{^{I}}^{∥}={G∈GB_{I}^{∥}:π_{I}^{∥}(G)⊆Ω_{g}_{^{I}}^{b},G_{I}^{∥}=GB/ [symbol] }, (6.69)

For every g^{I}∈GI there is a unique set of equivalence classes from GA_{I}^{∥} and another unique set from GB_{I}^{∥}. We say that these two sets of equivalence classes are aligned and define a set containing the aligned sets of equivalence classes as

Align_{g}_{^{I}}=GA_{I,g}_{^{I}}^{∥}∪GB_{I,g}_{^{I}}^{∥}. (6.70)

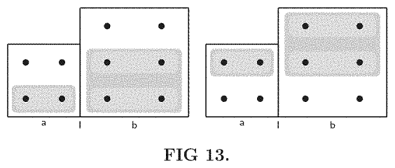

FIG. 13 shows each set of aligned sets of equivalence classes for the elements in FIG. 11 along the shared interface I. We use superscripts to refer to subsets of Align_{g}, formed from equivalence classes associated with a single cell. Align_{g}_{^{a}} is the set of equivalence classes in Align_{g}_{^{I}} associated with points on a. This approach may appear ambiguous for simplicial cells but because we restrict ourselves to [symbol] ⁰ interfaces around simplicial cells there is no ambiguity.

### Alignment in Arbitrary Dimensions

Consider in ≥2 neighboring elements Eₖ, k∈{1, . . . , m} on a d-dimensional Bézier mesh that meet at a common lower-dimensional adjacent cell c. Recall that each element Eₖ has a prescribed Bernstein space and set of Greville points GEₖ. The cell c is assigned a Bernstein space with polynomial degree p_{c} equal to the minimum of all degrees on Eₖ in each parametric direction parallel to c. In the case that c is a vertex, the Bernstein basis is assumed to be constant.

The set GEₖ can be partitioned into equivalence classes with respect to c as

GE_{k,c}^{∥}=GEₖ/ [symbol] (6.71)

We construct trace mapping matrices Mₖ for each Eₖ with respect to c and for each i∈ID(c) collect indices on Eₖ that correspond to the nonzero coefficients on the ith row of Mₖ, denoted NZ(Mₖ, i), as described in section 6.3.3.

For each i∈ID(c) there is a unique set of equivalence classes from each GE_{k,c}^{∥} defined as

GE_{k,c,i}^{∥}={G∈GE_{k,c}^{∥}:π_{c}^{∥}(G)⊆π_{c}^{∥}(g̅(NZ(Mₖ,i)))}. (6.72)

We say that these sets of equivalence classes, one set from each element Eₖ for a given i, are aligned and define a set containing the aligned sets of equivalence classes as

$${Align}_{c , i} = {⋃}_{k} {GE}_{k , c , i}^{‖} . \qquad ( 6.73 )$$

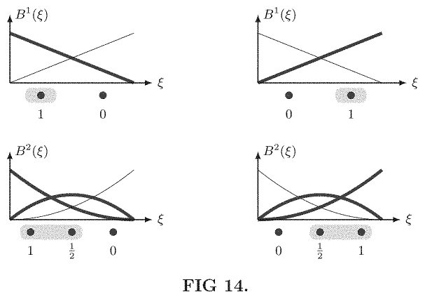

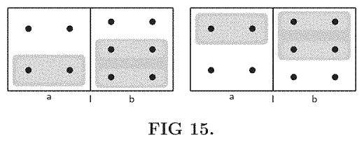

As we did in the two-dimensional case, we use superscripts to refer to subsets of Align_{c,i} formed from equivalence classes associated with a single element. For example, Align_{c,i}^{E}^{ₖ} is the set of equivalence classes in Align_{c,i} associated with points on element Eₖ. In this context, we refer to i∈ID(c) as an alignment index. See FIGS. 14 and 15 for simple illustrations of these ideas.
Basis Vectors for k-Cell Nullspaces

Given R(c) for any k-cell c∈B we want to determine the set or system of basis vectors, denoted by BV(c), that span the nullspace of the corresponding restricted constraint matrix R(c). Importantly, we require that a set of admissibility conditions defined in section 6.8.2 be satisfied by the mesh B. With this restriction we can use the ordered derivative property of the Bernstein basis to efficiently identify the index support of each basis vector through a series of operations on ID(B).

The set of index sets associated with a set of basis vectors is used with sufficient frequency that we use BI(c)={ID(v), v∈BV(c)} to represent it. We also define the set of mapped index sets associated with the basis vectors of the cell c to be BG(c)={{ϕ(i), i∈ID}, ID∈BI(c)} for a suitably chosen index mapping ϕ.

To aid the reader in understanding these concepts we begin in one dimension and then move to interface and vertex basis vectors in two dimensions followed last by the technical description of k-cell basis vectors in arbitrary dimensions. Most of the needed intuition for the general setting can be developed in the one- and two-dimensional settings.

### Basis Vectors in One Dimension

The constraint matrix to enforce [symbol] across an interface R(I) in a one-dimensional mesh has rank [symbol] +1. This is a consequence of the ordering of the Bernstein constraints. A suitable choice of permutation of the [symbol] +1 rows will produce a constraint matrix in lower triangular form and therefore the matrix has rank [symbol] +1.

Given an interface I in a one-dimensional mesh where I has been assigned a continuity [symbol] , the minimum number of nonzero contiguous Bernstein coefficients in any basis vector having nonzero indices in both edges adjacent to I is [symbol] +2. Let r_{ρ} represent the row of the constraint matrix R(I) associated with the constraint for continuity of level ρ, 0≤ρ≤ [symbol] ; there are a total of [symbol] +1 rows in the matrix. Begin with ρ=0 and pick a unit vector u₋₁ with a single positive nonzero entry that satisfies |r₀u₋₁|>0. Now second unit vector u₋₁ with a single nonzero entry that satisfies |r₀u₋₁|>0 and [symbol] u₋₁,u₀′ [symbol] =0. The two vectors can be combined to form a new vector u₀=u₋₁+au₀′ that satisfies r₀u₀=0. The system can be solved to find that

$$a = - \frac{{r}_{0} {u}_{- 1}}{{r}_{0} {u}_{0}^{′}} \qquad ( 6.74 )$$

$$and so$$

$${u}_{0} = {u}_{- 1} - {u}_{0}^{′} \frac{{r}_{0} {u}_{- 1}}{{r}_{0} {u}_{0}^{′}} \qquad ( 6.75 )$$

By construction, the vector u₀ has two nonzero entries. The same procedure can be applied to obtain solutions to the higher-order continuity constraints. This gives rise to the recursive definition:

$${u}_{ρ} = {u}_{ρ - 1} - {u}_{ρ}^{′} \frac{{r}_{ρ} {u}_{ρ - 1}}{{r}_{ρ} {u}_{ρ}^{′}} \qquad ( 6.76 )$$

where at each stage u′_{ρ} is chosen so that [symbol] u_{ρ-1}, u′₉₂ [symbol] =0 and so that the nonzero entry in u′_{ρ} is adjacent to the nonzero entries of u_{ρ-1}. This means that each additional constraint applied adds one additional nonzero entry and so the final vector of coefficients will always have [symbol] +2 nonzero entries. At every stage there are exactly two choices for the next vector u′_{ρ}. This is due to the ordered increase in the size of constraint vectors in Bernstein form. Each constraint vector has two more nonzero entries than the previous one. Note that this construction relies on the fact that r_{ρ}u_{ρ-1}≠0 which is not established rigorously here.

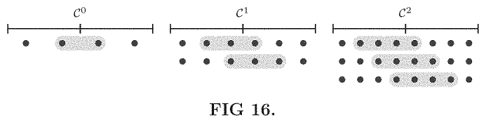

Because the number of nonzero contiguous coefficients in the basis vectors of a smoothness constraint, system is given by the maximum smoothness of the system, it is possible to determine the support of the basis vectors without solving the constraint system. It is sufficient to select all unique contiguous vectors with [symbol] +2 entries that have entries corresponding to functions on either side of the interface. Examples of these one-dimensional basis vectors for various continuities are shown in FIG. 16. Restricting the constraint system to these nonzero entries will result in a rank one nullspace problem (see section 6.9.2 for an approach to solving rank one nullspace problems).

### Interface Basis Vectors in Two Dimensions

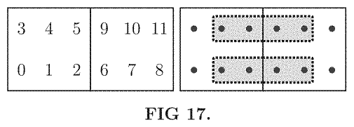

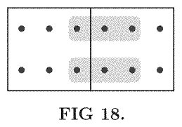

Equation (6.76) can easily be generalized to an edge interface between faces with matching tensor product bases along the interface. It can be seen that the constraints separate into separate systems with exactly the same nonzero constraint values as would occur in the univariate setting repeated for each equivalence class. A simple example of a constraint matrix is given in eq. (6.77). The indices corresponding to nonzero entries are highlighted with gray boxes in FIG. 17. In this setting, the results of eq. (6.76) can be applied directly to obtain the nonzero entries of each basis vector that has nonzero indices in both faces. The indices of the nonzero entries can similarly be obtained if one does not wish to solve for the values. The indices corresponding to two representative basis vectors are shown in FIG. 18. Each one was obtained by choosing three coefficients from a row with contiguous indices with at least one coefficient on each side of the interface.

$$[ \begin{matrix}0 & 0 & 1 & 0 & 0 & 0 & - 1 & 0 & 0 & 0 & 0 & 0 \\ 0 & 2 & - 2 & 0 & 0 & 0 & - 2 & 2 & 0 & 0 & 0 & 0 \\ 0 & 0 & 0 & 0 & 0 & 1 & 0 & 0 & 0 & - 1 & 0 & 0 \\ 0 & 0 & 0 & 0 & 2 & - 2 & 0 & 0 & 0 & - 2 & 2 & 0\end{matrix} ] \qquad ( 6.77 )$$

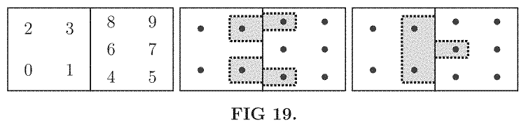

If the Bernstein basis in each element does not match along the interface edge then the situation is significantly more complex. Consider a system consisting of two elements, one with degree (1, 1) and the other with degree (1,2) connected by a [symbol] ⁰ interface such that the bases do not match on the shared interface. This is shown in FIG. 19. The constraint matrix is given in eq. (6.78). A pictorial representation of the nonzero entries associated with each row in the constraint matrix is given in FIG. 19. The constraints are now fully coupled and hence the one-dimensional result may not be directly applied to compute the indices of the nonzero entries of the basis vectors.

$$[ \begin{matrix}0 & - 1 & 0 & 0 & 1 & 0 & 0 & 0 & 0 & 0 \\ 0 & - \frac{1}{2} & 0 & - \frac{1}{2} & 0 & 0 & 1 & 0 & 0 & 0 \\ 0 & 0 & 0 & - 1 & 0 & 0 & 0 & 0 & 1 & 0\end{matrix} ] \qquad ( 6.78 )$$

For every interface in a Bézier mesh there is a natural association between the equivalence classes on one side of the interface and the equivalence classes on the other side as described by eq. (6.70). This association allows the results of eq. (6.76) to be generalized to the construction of interface basis vectors for higher-dimensional elements with local tensor product polynomial bases.

For two elements a and b sharing an interface I=a∩b with assigned smoothness [symbol] and having mapped index sets GA=π_{I}^{∥}(γ^{a}(ID(a))) and GB=π_{I}^{∥}(γ^{b}(ID(b))) with intersection set GI=GA∩GB, there are [symbol] +1 basis vectors with indices from both elements for every index in GI. The indices of the nonzero entries of these basis vectors are defined for all integers 0≤m≤ [symbol] . For every g^{I}∈GI form the sets

$${ID}_{{g}^{I} , m}^{a} = {⋃}_{G ∈ {Align}_{{g}^{I}}^{a}} \{ {i}^{a} : g = {φ}^{a} ( \overline{g} ( {i}^{a} ) ) ∈ G , \vert {π}_{I}^{⊥} ( g ) \vert \leq m \} , \qquad ( 6.79 )$$

$${ID}_{{g}^{I} , ϑ - m}^{b} = {⋃}_{G ∈ {Align}_{{g}^{I}}^{b}} \{ {i}^{b} : g = {φ}^{b} ( \overline{g} ( {i}^{b} ) ) ∈ G , \vert {π}_{I}^{⊥} ( g ) \vert \leq ϑ - m \} . \qquad ( 6.8 )$$

The indices for the nth function associated with g^{I} are given by the union of these two sets:

ID_{g}_{^{I}}_{,m}=ID_{g}_{^{I}}_{,m}^{a}∩ID_{g}_{^{I}}_{,ϑ-m}. (6.81)

Once the index set has been obtained, the nonzero coefficients associated with the basis vector may be obtained by solving the smoothness constraints restricted to the index set. This also holds for [symbol] ⁰ interfaces between triangle-triangle or quad-triangle pairs. The set of all interface basis vectors with indices from both elements adjacent to I is obtained by considering all possible values of g^{I} and m.

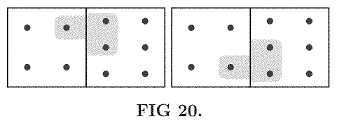

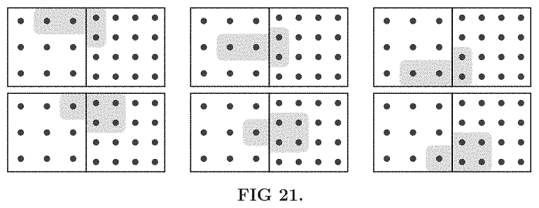

The interface basis vectors with indices from both elements in FIG. 19 are highlighted in FIG. 20. These basis vectors are in the nullspace of the constraint matrix in eq. (6.78). A slightly more complex example is seen in FIG. 21, where two faces with degrees p=(2, 2) and p=(3,3) are separated by an interface with [symbol] ¹ continuity. The six basis vectors with indices from both faces are highlighted.

k-Cell Basis Vector Preliminaries

The construction of basis vectors on k-cells of dimension lower than an interface is more complex. Before proceeding with the construction of basis vectors for an arbitrary k-cell a^{k} we define several preliminary concepts.

### Spokes and Inter Face-Element Pairs

A spoke, denoted by ρ, is a pair containing an element E and an adjacent (k+1)-cell b^{k+1}, both of which are adjacent to a^{k}. More specifically, a spoke is defined as

ρ=(a^{k},E,b^{k+1}) s.t. E∈ADJ^{d}(a^{k}),b^{k+1}∈ADJ^{k+1}(a^{k}),b^{k+1}∈ADJ^{k+1}(E). (6.82)

Each spoke ρ has a corresponding perpendicular interface-element pair, denoted by t, and defined as

t=(a^{k},E,I) s.t. E∈ADJ^{d}(a^{k}),I∈ADJ^{d-1}(a^{k}),I∈ADJ^{d-1}(E). (6.83)

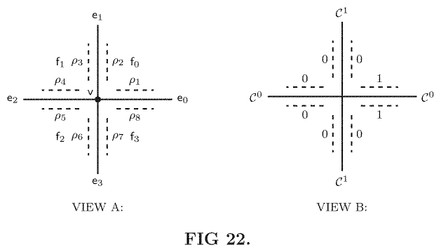

In FIG. 22, VIEW A, the spokes adjacent to a vertex v are depicted as dashed lines.

We define several operations on spokes and interface-element pairs. The operator t^{⊥}(ρ) gives the interface-element pair perpendicular to a spoke on the same element and is defined as

t^{⊥}(a^{k},E,b^{k+1})=(a^{k},E,I) s.t. I∈ADJ^{d-1}(E),s_{E}^{⊥}(I)⊆s_{E}^{∥}(b^{k+1}). (6.84)

The operator ρ^{⊥}(t) gives the spoke perpendicular to an interface-element pair on the same element and is defined as

ρ^{⊥}(a^{k},E,I)=(a^{k},E,b^{k+1}) s.t. b^{k+1}∈ADJ^{k+1}(a^{k}),b^{k+1}∈ADJ^{k+1}(E),s_{E}^{⊥}(I)⊆s_{E}^{∥}(b^{k+1}). (6.85)

The operator t^{∥}(t) gives the element-interface pair on the adjacent element sharing the same interface and is defined as

t^{∥}(a^{k},Eₐ,I)=(a^{k},E_{b},I) s.t. E_{d}∩E_{b}=I,E_{b}∈ADJ^{d}(I). (6.86)

The operator ρ^{∥}(a^{k}, b^{k+1}) gives the set of spokes that share the same (k+1)-cell b^{k+1} and is defined as

ρ^{∥}(a^{k},b^{k+1})={(a^{k},E,b^{k+1}) s.t. E∈ADJ^{d}(b^{k+1})}. (6.87)

We let [symbol] ₘₐₓ^{⊥}(ρ)= [symbol] ₘₐₓ^{⊥}(a^{k},b^{k+1}):a^{k},b^{k+1}∈ρ.

### Inclusion Distances

We assign a number called an inclusion distance to each spoke, denoted inc(ρ), which will be used to determine the set of (k+1)-cell basis vectors from each (k+1)-cell adjacent to a^{k} that are included in the k-cell basis vector.

Each inclusion distance has the following properties:
0≤inc(ρ)≤ [symbol] ₘₐₓ^{⊥}(ρ)
inc(ρ)= [symbol] ₘₐₓ^{⊥}(ρ)−inc(ρ^{⊥}(t^{∥}(t^{⊥}(ρ))))
∀{ρₐ, ρ_{b}}⊆ρ^{∥}(b^{k+1}), inc(ρₐ)=inc(ρ_{b}).

For the construction of a k-cell basis vector on a d-dimensional mesh, there are (d−k) spokes that share each element adjacent to the k-cell. We begin the process of constructing a set of inclusion distances for a k-cell a^{k} by choosing one of these elements E and then choosing (d−k) inclusion distances inc₁ . . . inc_{d-k}, one for each of the spokes on E, ρⱼ, j∈{1, . . . , d−k}, E∈ρⱼ, that satisfy the requirement 0≤incⱼ≤ [symbol] ₘₐₓ^{⊥}(ρⱼ),j∈{1, . . . , d−k}. The set of inclusion distances for each (k+1)-cell adjacent to a^{k} are fixed by the choice of inc₁ . . . inc_{d-k} on E. We denote the set of inclusion distances for all (k+1)-cells adjacent to a^{k} by INC^{inc}^{₁}^{, . . . , inc}^{_{d−k}} and denote the value associated with the (k+1)-cell b^{k+1} by

$${INC}_{{b}^{k + 1}}^{{inc}_{1} , … , {inc}_{d - k}} .$$

In FIG. 22, VIEW B, a set of inclusion distances have been chosen for the spokes adjacent to a vertex v, on a system where each face has a biquadratic basis, and the continuity on each edge is as indicated.

### Alignment Sets

We define the alignment sets on the k-cell a^{k}. A k-dimensional Bernstein basis is placed in \hat{Ω}^{a}^{^{k}} with polynomial degree pₐ_{^{k}} equal to the minimum on the adjacent elements in each parametric direction parallel to a^{k}, and for each i∈ID(a^{k}) we construct the sets of aligned equivalence classes, contained in Alignₐ_{^{k}}_{,i} (see section 6.6.4). For each i∈ID(a^{k}) there exists a set of (k+1)-cell basis vectors HBVᵢ(a^{k}) such that

HBVᵢ(a^{k})={n∈HBV(a^{k}):G(ID(n))⊆Alignₐ_{^{k}}_{,i}} (6.88)

where

$$H B V ( {a}^{k} ) = {⋃}_{{b}^{k + 1} ∈ {ADJ}^{k + 1} ( {a}^{k} )} B V ( {b}^{k + 1} ) . \qquad ( 6.89 )$$

Overview of k-Cell Basis Vector Construction

In general, the algorithm for constructing k-cell basis vectors is recursive. It assumes the basis vectors on the adjacent (k+1)-cells have already been constructed, the base case being the d-cell basis vectors (the Bernstein functions). Each k-cell basis vector is a linear combination of (k+1)-cell basis vectors on adjacent (k+1)-cells. Composite k-cell basis vectors are formed by taking a linear combination of multiple (k+1)-cell basis vectors, while simple k-cell basis vectors are formed from just one (k+1)-cell basis vector.

The algorithm for constructing the basis vectors on a k-cell a^{k} is summarized as follows:
1. Construct the basis vectors on adjacent (k+1)-cells b^{k+1}∈ADJ^{k+1}(a^{k}) by calling this algorithm recursively. The base case is a d-cell, where the basis vectors are the Bernstein functions which span the Bernstein space assigned to the element.
2. Composite basis vectors are constructed by considering all possible sets of inclusion distances INC^{inc}^{₁}^{, . . . ,inc}^{_{d-k}} (section 6.7.3.2) and all possible alignment indices i∈ID(a^{k}) (section 6.7.3.3) on a^{k}. For each,
   Collect the set of (k+1)-cell basis vectors associated with the given set of inclusion distances and alignment index. (section 6.7.5.1 and section 6.13.1)
   The index set of the new k-cell basis vector is the union of the index sets of this collection of (k+1)-cell basis vectors.
3. Each simple k-cell basis vector is constructed from a single (k+1)-cell basis vector on an adjacent (k+1)-cell, one for each (k+1)-cell basis vector whose index set is not a subset of a composite k-cell basis vector (section 6.7.5.2 and section 6.13.2).
4. If desired, once the index set for each k-cell basis vector has been obtained, the constraint system can be solved to obtain the coefficient values and construct the basis vector.

### Vertex Basis Vectors in Two Dimensions

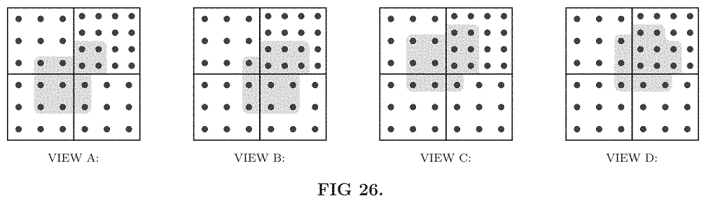

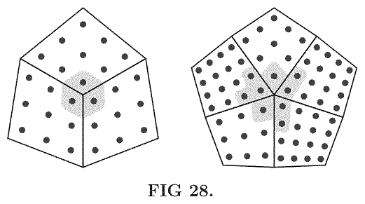

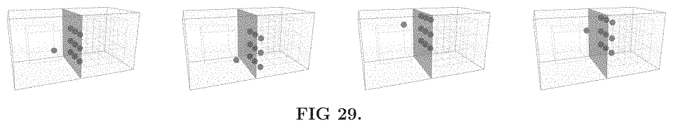

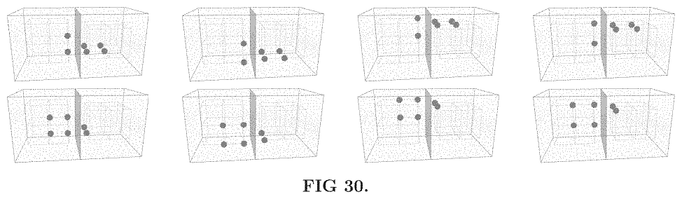

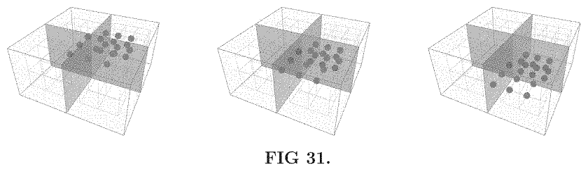

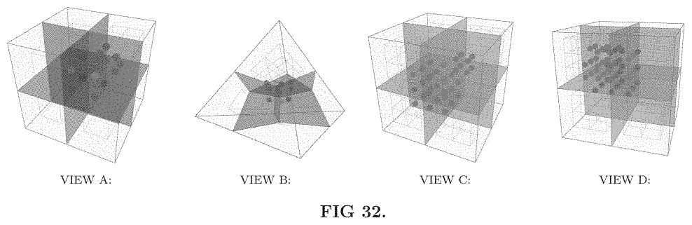

We illustrate the algorithm by constructing two-dimensional basis vectors on vertices. The algorithm for arbitrary dimensions is found in section 6.13. Examples of k-cell basis vectors of various dimension, on both two- and three-dimensional meshes are seen in FIGS. 26 to 32.

### Composite Vertex Basis Vectors

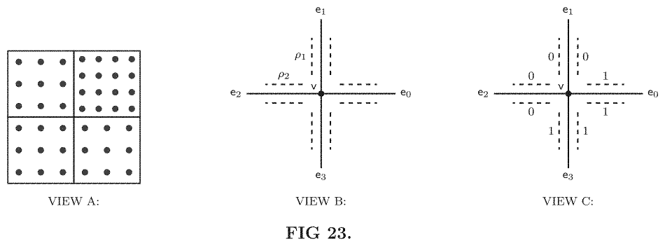

The composite basis vectors on a vertex v are formed from multiple adjacent edge basis vectors. Each composite vertex basis vector is associated with a set of inclusion distances INC^{inc}^{₁}^{,inc}^{₂} (section 6.7.3.2) and alignment index i∈ID(v) (section 6.7.3.3). In the case of a vertex, there is only one alignment index. The spokes (section 6.7.3.1) in this case consist of every edge-face pair adjacent to the vertex v. In FIG. 23, VIEW A we see a two-dimensional mesh with four elements. A set of spokes on the edges adjacent to the center vertex are depicted in FIG. 23, VIEW B. We assign an inclusion distance to every spoke adjacent to the vertex v, as described in section 6.7.3.2, beginning with two initial inclusion distance choices denoted inc₁ and inc₂ (corresponding to the spokes ρ₁ and ρ₂, respectively), that satisfy the requirement 0≤incⱼ≤ [symbol] ₘₐₓ^{⊥}(ρⱼ), j∈{1, 2}. The inclusion distances associated with every spoke adjacent to v, denoted INC^{inc}^{₁}^{,inc}^{₂}, are fixed by the choice of inc₁ and inc₂, as determined by the properties of inclusion distances outlined in section 6.7.3.2. One possible set, of inclusion distances for the mesh in FIG. 23. VIEW A is shown in FIG. 23, VIEW C. The inclusion distance associated with a particular edge e∈ADJ¹(v) is denoted by INCₑ^{inc}^{₁}^{,inc}^{₂}.

We place indexed submesh domains over each pair of elements adjacent to each edge adjacent to v (with their origins at v), and partition the mapped index sets of the basis vectors associated with each edge e into equivalence classes with respect to the parallel equivalence relation on the edge BG(e)/ [symbol] . We then identify the equivalence classes for which the minimum projection onto the edge is less than or equal to INCₑ^{inc}^{₁}^{,inc}^{₂}:

$${EGB}_{{inc}_{1} , {inc}_{2}}^{‖} ( e ) = \{ EBG ( e ) ∈ BG ( e ) / {\overline{ω}}_{e}^{‖} : {min}_{g ∈ G} ( {π}_{e}^{‖} ( g ) ) \leq {INC}_{e}^{{inc}_{1} , {inc}_{2}} , G ∈ EBG ( e ) \} . \qquad ( 6.9 )$$

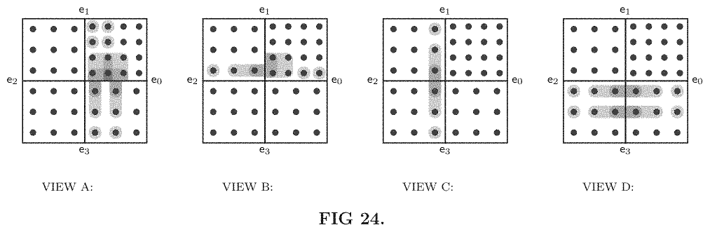

An example of these equivalence classes is shown in FIG. 24.

Let e₀^{⊥}∈PC(v, e), and e₁^{⊥}∈PC(v, e). (PC is defined in section 6.2.1.1.) We form the sets containing all indices whose associated cell is adjacent to e and whose associated submesh Greville point is a part of elements of EBG_{inc}_{₁}_{,inc}_{₂}^{∥}(e₀^{⊥}) and EBG_{inc}_{₁}_{,inc}_{₂}^{∥}(e₁^{⊥})

$${ID}_{{e}_{0}^{⊥}}^{⊥} = \{ i ∈ ID ( f ) : f ∈ {ADJ}^{2} ( e ) , g ( i ) ∈ G ∈ EBG ∈ {EBG}_{{inc}_{1} , {inc}_{2}}^{‖} ( {e}_{0}^{⊥} ) \} , \qquad ( 6.91 )$$

$${ID}_{{e}_{1}^{⊥}}^{⊥} = \{ i ∈ ID ( f ) : f ∈ {ADJ}^{2} ( e ) , g ( i ) ∈ G ∈ EBG ∈ {EBG}_{{inc}_{1} , {inc}_{2}}^{‖} ( {e}_{1}^{⊥} ) \} . \qquad ( 6.92 )$$

We form the set of Greville points that are fixed points of the parallel projectors onto e₀^{⊥} or e₁^{⊥}:

$${G}^{⊥} = \{ g ( i ) : g ( i ) = {π}_{e}^{⊥} ( g ( i ) ) , i ∈ {ID}_{{e}_{0}^{⊥}}^{⊥} \} ⋃ \{ g ( i ) : g ( i ) = {π}_{e}^{⊥} ( g ( i ) ) , i ∈ {ID}_{{e}_{1}^{⊥}}^{⊥} \} . \qquad ( 6.93 )$$

We take all basis vectors whose projections onto the edges perpendicular to e lie in G^{⊥}:

BGC_{inc}_{₁}_{,inc}_{₂}^{⊥}(e)={G∈EBG∈EBG_{inc}_{₁}_{,inc}_{₂}^{∥}(e): ∀_{g∈G}πₑ^{⊥}(g)⊆G^{⊥}}. (6.94)

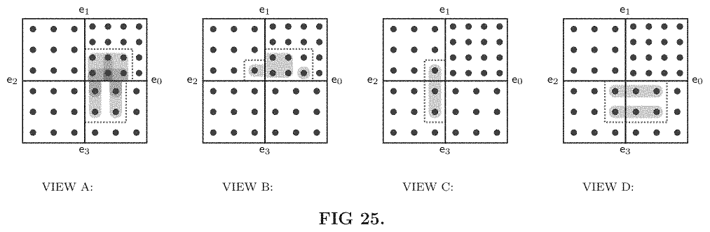

In FIG. 25, we see an example of these basis vector subsets marked with dotted lines.

The set of indices associated with BG_{inc}_{₁}_{,inc}_{₂}^{⊥}(e) is

$${ID}_{e}^{{inc}_{1} , {inc}_{2}} = {⋃}_{G ∈ {BG}_{{inc}_{1} , {inc}_{2}}^{⊥} ( e )} \{ i ∈ ID ( f ) : f ∈ {ADJ}^{2} ( e ) , g ( i ) ∈ G \} . \qquad ( 6.95 )$$

The full set of indices associated with inc₀ and inc₁ is

$${ID}_{v}^{{inc}_{1} , {inc}_{2}} = {⋃}_{e ∈ {ADJ}^{1} ( v )} {ID}_{e}^{{inc}_{1} , {inc}_{2}} . \qquad ( 6.96 )$$

In the case of a vertex, there is only one alignment index, so the set IDᵥ^{inc}^{₁}^{,inc}^{₂} represents the index set of the composite basis vector. Note that for higher-dimensional cells, one additional step is required to find the set associated with a given alignment index and inclusion distances (see eq. (6.159) in section 6.13.1).

We consider all possible values of inc₀ and inc₁ on v to construct the set of all composite vertex basis vectors. We use BV″(v) to represent this set. The full set of indices contained in this set is

$${UID}_{v} = {⋃}_{n ∈ {BV}^{′′} ( v )} ID ( n ) . \qquad ( 6.97 )$$

An example of a set of composite vertex basis vectors is shown in FIG. 26.

### Simple Vertex Basis Vectors

Each simple vertex basis vector is formed from a single edge basis vector on an adjacent edge, one for each edge basis vector whose index set is not subsumed by UIDᵥ. We use BV′(v) to represent this set:

$$B {V}^{′} ( v ) = {⋃}_{e ∈ {ADJ}^{k + 1} ( v )} \{ n ∈ B V ( e ) : ID ( n ) ⊈ {UID}_{v} \} . \qquad ( 6.98 )$$

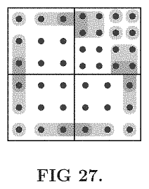

An example of a set of simple vertex basis vectors is shown in FIG. 27.

### The Full Set of Vertex Basis Vectors

The full set of vertex basis vectors is found by combining the set of composite vertex basis vectors with the set of simple vertex basis vectors:

BV(v)=BV″(v)∩BV′(v). (6.99)

Once the index set for each vertex basis vector has been obtained, the constraint system can be solved to obtain the coefficient values and construct the basis vector.

### Subordinate Basis Vectors

By definition (see eq. (6.34)), the constraint set for a k-cell c, R(c), is a superset of the constraint set of any higher dimensional cell having c in its boundary. Consequently, the basis vectors in BV(c) can be expressed locally in terms of the basis vectors associated with the (k+1)-cells having c in their shared boundary. Given n∈BV(c), we define the set of (k+1)-cell basis vectors associated with n as

$$S B V ( n ) = \{ m ∈ \{ {⋃}_{a ∈ {ADJ}^{k + 1} ( c )} B V ( a ) \} : ID ( m ) ⊆ ID ( n ) \} \qquad ( 6.1 )$$

and say that the members of SBV(n) are subordinate basis vectors or basis vectors subordinate to n. The subordinate basis vectors of a set of basis vectors is also defined as SBV(BV(c))=U_{n∈BV(c)}SBV(n).

We also define the subset of basis vectors subordinate to n that are also basis vectors on an adjacent cell c as

SBV_{c}(n)=SBV(n)∩BV(c). (6.101)

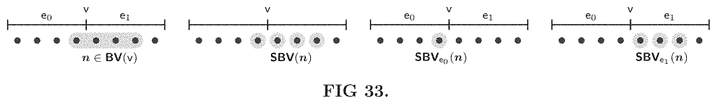

An example of subordinate basis vectors in one dimension are shown in FIG. 33.

### Basis Vector Boundaries

The U-spline algorithm relies on relationships between basis vectors associated with adjacent topological features in order to construct, basis vectors from the global set. These relationships are most conveniently expressed by introducing a notion of boundary to the mapped indices associated with nonzero entries in the basis vector.

It has been shown that basis vectors can be represented in terms of the basis vectors associated with higher-dimensional adjacent cells. Having constructed a basis vector, n∈BV(a^{k}), for a k-cell, a^{k}, we loosely define the boundary with respect to an adjacent (k+1)-cell, b^{k}+l, as the most distant elements chosen from the set of subordinate basis vectors SBV_{b}_{^{k+1}}(n). We will denote this set by BD_{b}_{^{k+1}}(n) and make the definition more precise. We first give definitions for the three cases relevant to one and two dimensions and then define basis vector boundaries in arbitrary dimension.

### Basis Vector Boundaries in One Dimension

For the case of a basis vector nᵥ∈BV(v) associated with a vertex v in the one-dimensional setting, we begin by defining an indexed submesh domain over the two edges adjacent to the vertex, such that the origin lies at the vertex, and the associated index mappings are ϕ^{e} for each edge e. Then, the boundary with respect to the edge e is given by

$${BD}_{e} ( {n}_{v} ) = \{ q ∈ S B {V}_{e} ( {n}_{v} ) : {max}_{i ∈ ID ( q )} {‖ {ϕ}^{e} ( i ) ‖}_{2} = {q}_{max} \} \qquad ( 6.102 )$$

$${q}_{max} = {max}_{q ∈ {SBV}_{e} ( {n}_{v} )} {max}_{i ∈ ID ( q )} {‖ {ϕ}^{e} ( i ) ‖}_{2} . \qquad ( 6.103 )$$

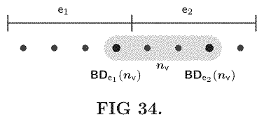

In FIG. 34 we see a basis vector nᵥ on a vertex on a one-dimensional mesh. Associated with each adjacent edge e₁ and e₂ is a boundary set, BDₑ_{₁}(nᵥ) and BDₑ_{₂}(nᵥ), which contains the subordinate basis vector that makes up the boundary in the direction of the respective edge. These are represented as black circles. The full set of boundaries is obtained by taking the union of all boundary sets generated by the edges adjacent to v:

$$BD ( {n}_{v} ) = {⋃}_{e ∈ {ADJ}^{1} ( v )} {BD}_{e} ( {n}_{v} ) . \qquad ( 6.104 )$$

### Basis Vector Boundaries in Two Dimensions

In a two-dimensional setting we must consider the boundaries of edge basis vectors and vertex basis vectors. The boundaries of edge basis vectors are constructed from the basis vectors of the adjacent face systems, which are just the standard Bernstein basis functions. Given an edge e∈ADJ¹(f) with basis vector nₑ∈BV(e) adjacent to a face f, the subordinate subset is SBV_{f}(nₑ) and the associated index set is ID(SBV_{f}(nₑ)). We form the mapped points associated with ID(SBV_{f}(nₑ)) and partition it with respect to the projection onto the edge e:

G^{∥}={ϕ^{f}(i),i∈ID(SBV_{f}(nₑ))}/ [symbol] . (6.105)

The boundary set is formed by taking the index associated with the most distant point in each equivalence class:

$${BD}_{f} ( {n}_{e} ) = {⋃}_{G ∈ {G}^{‖}} \{ i ∈ ID ( {SBV}_{f} ( {n}_{e} ) ) : {π}_{e}^{⊥} ( {ϕ}^{f} ( i ) ) = {max}_{g ∈ G} {π}_{e}^{⊥} ( g ) \} . \qquad ( 6.106 )$$

Again, the full boundary is given by

$$BD ( {𝓃}_{e} ) = {⋃}_{f ∈ {ADJ}^{2} ( e )} {BD}_{f} ( {𝓃}_{e} ) . \qquad ( 6.107 )$$

The boundary set for a vertex basis vector n in the two-dimensional setting is formed from the basis vectors associated with an edge e adjacent to the vertex v. The construction is similar to the construction presented for the boundary of edge basis vectors. We form the set containing the set of mapped index points for each vector in SBVₑ(nᵥ):

G(SBVₑ(nᵥ))={{ϕ^{e}(i),i∈ID(nₑ)},nₑ∈SBVₑ(nᵥ)}. (6.108)

The chart ϕ^{e} is chosen so that both elements adjacent to the edge e are mapped consistently and that v lies at the origin. We partition the set of Greville point, sets into equivalence classes with respect to the projection perpendicular to the edge e and form the boundary set by taking the most distant element, from each equivalence class. Given an equivalence class H∈G(SBVₑ(nᵥ))/ [symbol] , we define the maximum of this equivalence class as the set of points whose projection onto the line in the direction of e is greatest:

$$max H = G ∈ H : {max}_{g ∈ G} π {‖}_{e} ( g ) = {max}_{{G}^{{′}_{∈ H}}} {max}_{{g}^{′} ∈ {G}^{′}} π {‖}_{e} ( {g}^{′} ) , \qquad ( 6.109 )$$

$${BD}_{e} ( {𝓃}_{v} ) = \{ {𝓃}_{e} ∈ {SBV}_{e} ( {𝓃}_{v} ) : {ϕ}^{e} ( ID ( {𝓃}_{e} ) ) = max H , {ϕ}^{e} ( ID ( {𝓃}_{e} ) ) ∈ H , H ∈ G ( {SBV}_{e} ( {𝓃}_{v} ) ) / {\overline{ω}}_{e}^{⊥} \} . \qquad ( 6.11 )$$

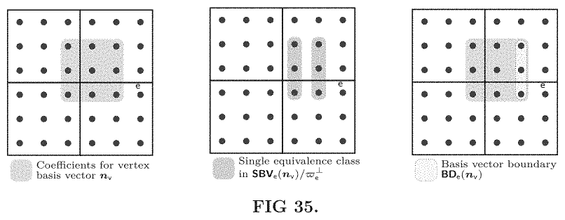

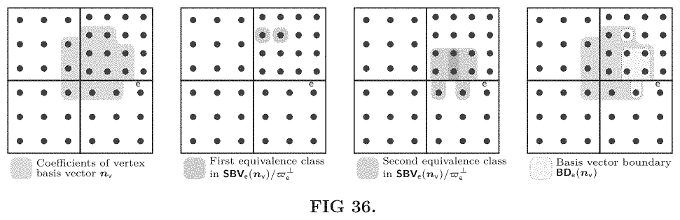

In FIG. 35 a vertex basis vector on a two-dimensional mesh with uniform degree is seen on the left. An equivalence class with respect, to the projection perpendicular to the edge e contains two subordinate basis vectors, as seen in the middle. The rightmost subordinate basis vector from the equivalence class makes up the basis vector boundary, as seen on the right. Similarly, in FIG. 36 on the left we see a vertex basis vector on a two-dimensional mesh with mixed degree. In this case there are two equivalence classes with respect to the projection perpendicular to the edge e, each of which contain two subordinate basis vectors. The boundary set is made up of the rightmost subordinate basis vectors from each equivalence class, as seen on the right. The full boundary is once again obtained by uniting the boundary sets associated with every edge adjacent to v

$$BD ( {𝓃}_{v} ) = {⋃}_{e ∈ {ADJ}^{1} ( v )} {BD}_{e} ( {𝓃}_{v} ) . \qquad ( 6.111 )$$

### Basis Vector Boundaries in Arbitrary Dimensions

The boundary set for a k-cell basis vector nₐ_{^{k}}∈BV(a^{k}) in the d-dimensional setting is formed from the basis vectors associated with a (k+1)-cell b^{k+1} adjacent to a^{k}, b^{k+1}∈ADJ^{k+1}(a^{k}). The description for constructing the boundary set for a basis vector in arbitrary dimensions is a direct generalization of the description in section 6.7.7.2 for vertex basis vectors in two dimensions, by taking eqs. (6.108) to (6.111) and replacing the vertex v with a^{k} and the edge e with b^{k+1}. In the general description, the chart

$${ϕ}^{{b}^{k + 1}}$$

is chosen so that all elements adjacent to b^{k+1} are mapped consistently and that one of the vertices adjacent to a^{k} lies at the origin.

### The U-Spline Mesh

As described previously in section 6.5, a spline space can be constructed directly from the nullspace of the global constraint matrix R(B). However, for large meshes, analyzing and constructing a basis for the global nullspace is usually not computationally feasible.

To overcome this issue, we will instead seek to build the index sets corresponding to k-cell basis vectors as described in section 6.7 and arrange them into basis vectors for U-spline basis functions as described in section 6.9. The nullspace problem associated with each U-spline basis function will be rank one in all cases.

To simplify the construction of a U-spline basis, we define a class of admissible Bézier meshes, which we call U-spline meshes and denote by U. A U-spline mesh is a Bézier mesh with admissibility constraints placed on the layout of cells, the degree, and the smoothness of interfaces. Admissibility constraints are imposed through appropriate separation and grading conditions on degree and continuity transitions throughout the Bézier mesh. The mathematical properties of the corresponding admissible U-spline space [symbol] can be controlled a priori by specifying the properties of the underlying Bézier mesh topology.

Specifically, admissibility ensures that the following properties are satisfied:
The index sets of k-cell basis vectors can be constructed directly through topological equivalence relations based on the derivative ordering property of a Bernstein-like basis on each cell and mesh topology local to the k-cell as described in section 6.7,
The basis vector that defines each U-spline basis function can be determined from the relationships between a set of k-cell basis vectors to determine the indices of nonzero values. Coefficient values can then be determined by solving a relatively small rank one nullspace problem. The details of this approach are described in section 6.7 and section 6.9.1.
The detailed mathematical properties satisfied by the U-spline space are described in section 6.10.

The admissibility conditions are written in terms of ribbons. A ribbon r is an ordered set of interfaces from a Bézier mesh segment length is controlled by both the degree and continuity of adjacent elements and interfaces, respectively. Ribbons are used as a measuring instrument on a Bézier mesh to quantify the separation distance between local variations in degree and continuity.

We note, however, that we have studied U-spline basis functions constructed over Bézier meshes that are more complex than those presented here and plan to present more generalized admissibility conditions in a forthcoming work. We anticipate that certain admissibility requirements will always be necessary to construct spline spaces with desirable mathematical properties.

### Ribbons

A ribbon r={I^{h}, o, t} where the tail t=[I₀, I₁, . . . , I_{|t|-1}], is composed of |t| consecutive interfaces Iⱼ, originating at an origin (d−2)-cell o, and I^{h} is the head interface that is opposite the tail t. The origin (d−2)-cell o must be regular and interior to the mesh. We say a ribbon with |t| interfaces in the tail is a ribbon of length |t|. The skeleton of a ribbon, denoted by skel(r), is the array of |t|+1 (d−2)-cells which are attached to the |t| interfaces in the tail and parallel to the origin (d−2)-cell o, including the origin (d−2)-cell. The fact that the definition of a ribbon is defined using (d−2)-cells prevents a meaningful definition of ribbons for univariate U-splines. Fortunately, all univariate U-splines of maximal continuity are admissible and so this is not a problem.

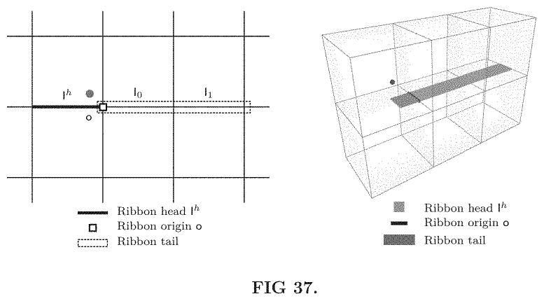

FIG. 37 illustrates a ribbon composed of several consecutive interfaces in both the two- and three-dimensional mesh cases. A small solid circle or sphere near the head of the ribbon represents an initial Bernstein coefficient, adjacent to which is the origin (d−2)-cell o. The interfaces in the tail extend to the right. The head of the ribbon I^{h} is the interface immediately opposite the tail.

### Maximum Coupling Length

A ribbon r can originate from any interior regular (d−2)-cell in a U-spline mesh, and can be of any length |t|, t∈r. However, we will primarily use ribbons to measure the maximum distance, measured by the length of the ribbon, between a specified Bernstein coefficient and any other coefficient coupled to it. We call a ribbon constructed in this way a ribbon of maximum coupling length. In this case, the length of the tail is determined by how far that coefficient can couple with neighboring coefficients in the direction of an interface which is adjacent to the origin (d−2)-cell (this becomes the first interface in the tail). Algorithm 2 in section 6.14 describes the procedure used to determine the interfaces in the tail of a ribbon of maximum coupling length. A ribbon of maximum coupling length is said to be truncated if the length of the ribbon is shortened due to reduced continuity on the final interface encountered by the tail.

### Continuity Transitions

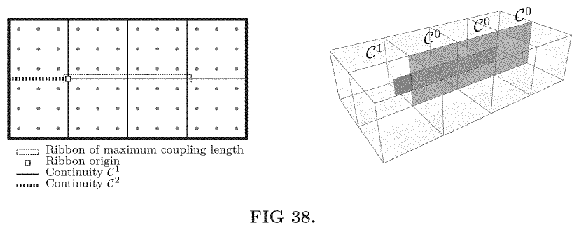

A continuity transition ribbon (designated by cr) is a ribbon of maximum coupling length with the additional property that [symbol] ^{h}> [symbol] ^{|t|}^{₀}. An example of this type of ribbon for both two and three dimensions is seen in FIG. 38. Two perpendicular continuity transition ribbons crᵢ and crⱼ where i≠j and crᵢ is length |tᵢ| and crⱼ is length |tⱼ|, are said to be intersecting if they share a (d−2)-cell (i.e., skel(crᵢ)∩skel(crⱼ)≠ø). A tail-to-tail intersection occurs when the shared (d−2)-cell is w_{|t}_{₁}_{|+1} in crᵢ and w_{|t}_{ⱼ}_{|+1} in crⱼ. A head-to-tail intersection occurs when the shared (d−2)-cell is w₀ in crᵢ and w_{|t}_{ⱼ}_{|+1} in crⱼ, or vice-versa. The minimum perpendicular degree of a continuity transition ribbon is defined as pₘᵢₙ^{⊥}(cr)=minₖ(pₘᵢₙ^{⊥}([t]ₖ)).

### Degree Transitions

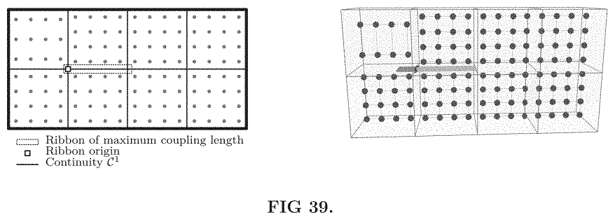

A degree transition ribbon (designated by dr) is a ribbon of maximum coupling length with the additional property that pₘᵢₙ^{⊥}(I^{h})<pₘᵢₙ^{⊥}([t]₀). An example of this type of ribbon for both two and three dimensions is seen in FIG. 39.

### Admissible Layouts

As described previously, a U-spline mesh U is a Bézier mesh with an admissible layout. The admissibility conditions presented here were selected for simplicity, while still ensuring that the resulting U-spline spaces possess the requisite mathematical properties. It should be noted, however, that various generalizations of these conditions exist but are significantly more complex to implement and understand so are omitted from this work. We will explore these generalized conditions in a forthcoming work. For our purposes, an admissible layout satisfies the following three simple constraints:
[symbol] -separation: If two perpendicular continuity transition ribbons crᵢ and crⱼ intersect (that is, share a common (d−2)-cell), then it must be a tail-to-tail intersection or a head-to-tail intersection. If a truncated continuity transition ribbon meets with a non-truncated continuity transition ribbon tail-to-tail, then [symbol] ^{I}^{ᵢ}^{h}< [symbol] ^{∞} or [symbol] ^{I}^{ⱼ}^{h}< [symbol] ^{∞}. If two truncated continuity transition ribbons meet tail-to-tail, then [symbol] ^{I}^{ᵢ}^{h}< [symbol] ^{∞} and [symbol] ^{I}^{ⱼ}^{h}< [symbol] ^{∞}.
p-separation: For all continuity transition ribbons crᵢ, if pₘᵢₙ^{⊥}(I^{h})> [symbol] ^{I}^{^{h}}, then pₘᵢₙ^{⊥}(crᵢ)> [symbol] ^{I}^{^{h}} and if pₘᵢₙ^{⊥}(I^{h})= [symbol] ^{I}^{^{h}}, then pₘᵢₙ^{⊥}(crᵢ)≥ [symbol] ^{I}^{^{h}}. Also, no degree transition ribbon dr perpendicular to crᵢ may intersect oᵢ, the origin of crᵢ.
[symbol] -grading: A creased (d−2)-cell is any (d−2)-cell in a Bézier mesh where all adjacent interfaces are creased to [symbol] ⁰ or [symbol] ⁻¹. For a creased (d−2)-cell w and a set of continuity transition ribbons {crⱼ} that all terminate at w, and given any cr∈{crⱼ} of length |t| where wⱼ=ADJ^{d-2}(Iⱼ)∩ADJ^{d-2}(Iⱼ₋₁), Iⱼ∈t∈cr, then [symbol] ^{I}^{ⱼ}≤ [symbol] ⱼ, where [symbol] ⱼ is defined recursively as [symbol] _{|t|-1}=0 and [symbol] ⱼ₋₁= [symbol] ⱼ+βⱼ, j=|t|−1, . . . , 1 where

$${β}_{j} = \{ \begin{matrix}0 & if {ϑ}_{max}^{⊥} ( {w}_{j} ) = {𝒞}^{∞} \\ 1 & otherwise\end{matrix} \qquad ( 6.112 )$$

$$and$$

$${ϑ}_{max}^{⊥} ( {w}_{j} ) = {max}_{{I}^{⊥} ∈ {ADJ}^{d - 1} ( {w}_{j} ) \backslash \{ {I}_{j} , {I}_{j - 1} \}} {ϑ}^{{\vert}^{⊥}} . \qquad ( 6.113 )$$

Additionally, on three-dimensional meshes, given three edges on a hexahedral element E adjacent to vertex v∈ADJ⁰(E), (without loss of generality we label these edges {e₀, e₁, e₂}=ADJ¹(E)∩ADJ¹(v)), if e₀ is extraordinary, then all faces adjacent to v and perpendicular to e₁ and e₂, i.e.,

$$f ∈ {⋃}_{{e}^{′} ∈ \{ {e}_{1} , {e}_{2} \}} {ADJ}^{2} ( v ) ⋂ {ADJ}^{2} ◦ {ADJ}^{d} ( {e}^{′} ) ∖ {ADJ}^{2} ( {e}^{′} ) , \qquad ( 6.114 )$$

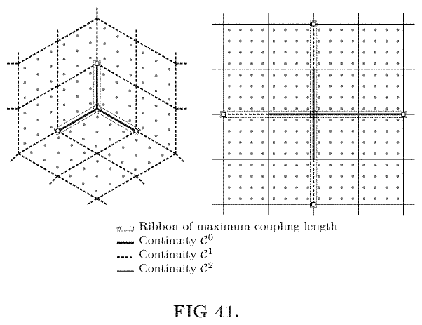

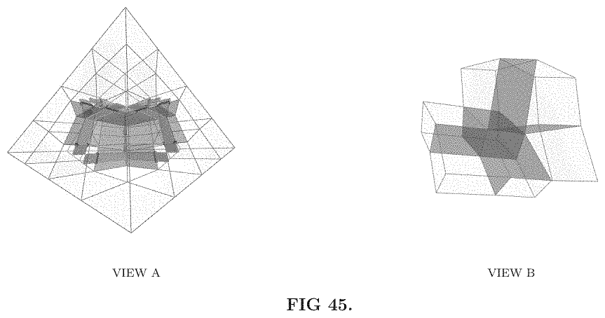

must be creased. This three-dimensional requirement is illustrated in FIG. 45, VIEW B. Note that all extraordinary (d−2)-cells are required to be creased, but regular (d−2)-cells may also be creased as seen in FIG. 41.

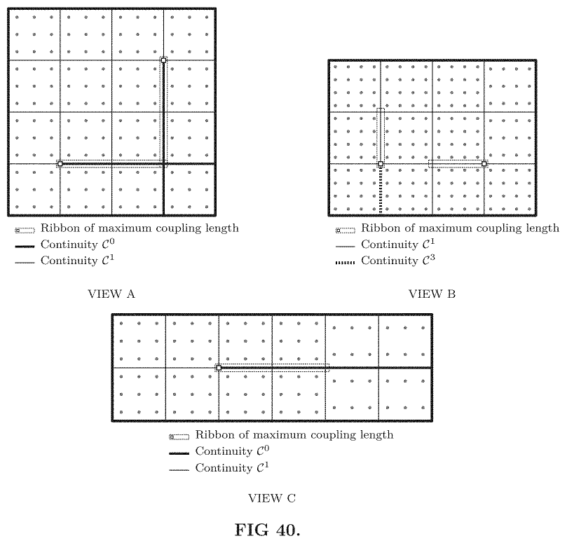

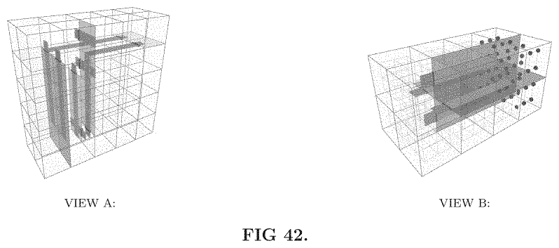

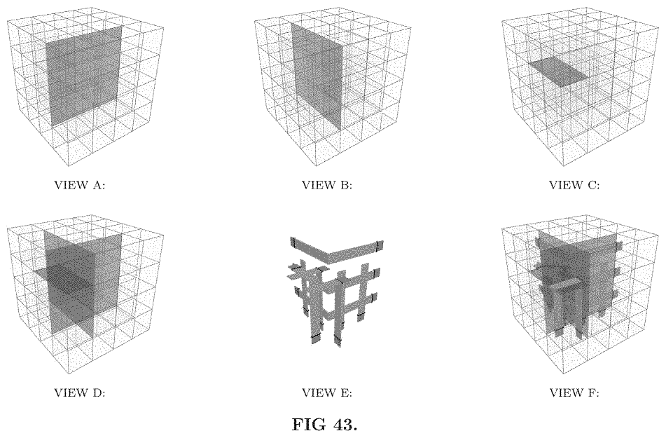

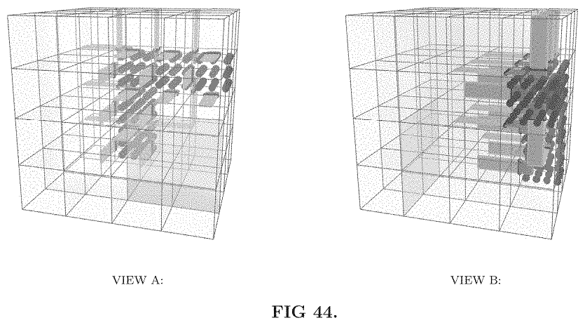

Examples of two-dimensional mesh layouts that satisfy the separation and grading admissibility conditions are shown in FIGS. 40 and 41 and three-dimensional examples are shown in FIGS. 42 to 45.

The [symbol] -separation condition is demonstrated in FIG. 40, VIEW A and similarly in FIGS. 42, VIEW A and 43 where we see admissible configurations with ribbons that do not intersect except tail-to-tail or head-to-tail. We note that ribbons on volumetric meshes that cross in the middle of a face are not considered intersecting, and are admissible.

A common application of the p-separation condition is seen in FIGS. 40, VIEW C and 42, VIEW B where a transition to lower continuity must be sufficiently separated from a transition to lower perpendicular degree. Also notable is the p-separation condition demonstrated in FIGS. 40, VIEW B and 44 where a degree transition ribbon cannot be permitted to intersect the origin of a continuity transition.

The [symbol] -grading condition is demonstrated in FIGS. 41 and 45 where we see several mesh configurations that include a creased (d−2)-cell. Extraordinary (d−2)-cells are always required to be creased, but the same [symbol] -grading conditions also apply to the interfaces near a regular (d−2)-cell if all adjacent interfaces are creased. Unstructured volumetric configurations often contain many extraordinary edges, as the hex-meshed tetrahedral topology demonstrates in FIG. 45, VIEW A. When an extraordinary edge is near a boundary on a volumetric mesh, sometimes additional faces must be creased as is demonstrated in FIG. 45, VIEW B. In this case, an additional face to the left of the extraordinary edge was required to be creased (despite itself being adjacent to only regular edges). This is because this face is perpendicular to an edge which, in turn, is perpendicular to the extraordinary edge (see eq. (6.114)).

### Classification

We denote a class of U-spline meshes by [symbol] , with a superscript that is used to identify key Bézier mesh properties which are common to the meshes contained in the class (see table 6.1). Using this superscript notation, U-spline meshes sharing certain characteristics can be grouped and denoted by, for example z,213 ^{RHKP}, which would denote all structured U-spline meshes where variations in mesh size, smoothness, and degree propagate globally. Examples include the tensor product splines such as B-splines and NURBS. The U-spline class z,213 ^{rHKP} may not admit a global parameterization due to the possible presence of, for example, extraordinary vertices, but all variations in mesh size, smoothness, and degree propagate globally. Spline meshes in this class include unstructured finite element meshes composed of linear elements and multi-patch NURBS meshes. Analysis-suitable T-spline (ASTS) meshes are in z,213 ^{rhkP}. We note that in one dimension, the most unstructured class possible is z,213 ^{RhKP}.

In table 6.1, this superscript notation is related to underlying Bézier mesh characteristics.

TABLE 6.1
The definition of each superscript used to identify a U-spline mesh class.

```
R: A global parameterization is possible.
    It is possible to construct a submesh domain Ω^{∪} and an
    associated coordinate system α^{K} on the U-spline mesh ∪.
r: A global parameterization may not be possible.
H: Supersmooth interfaces are not permitted in the mesh.
    All interfaces in the mesh have continuity less than pₘᵢₙ^{⊥} (I).
    ∀l ∈ ∪, [symbol] ^{l} < pₘᵢₙ^{⊥} (I).
h: Supersmooth interfaces are permitted in tire mesh.
K: Smoothness propagates globally.
    For any ribbon of maximum coupling length r in the mesh, the
    continuity of the ribbon head l^{h} is equal to the continuity on
    any interface in the tail.
    ∀r ∈ ∪, [symbol] ^{I}^{^{h}} = [symbol] ^{I}^{ᵢ} , l^{h} ∈ r, lᵢ ∈ t ∈ r.
k: Local variation in smoothness is permitted.
P: Polynomial degree propagates globally.
    For all interfaces in the mesh, the polynomial degree parallel to
    the interface is the same on both cells adjacent: to the interface.
    ∀l ∈ C^{d-1}(∪), pₑ^{||} (c) = pₑ^{||} (c′), e ∈ ADJ¹ (I), {c, c′} ⊆ ADJ^{d} (I).
p: Local variation in polynomial degree is permitted.
```

### the U-Spline Basis

A U-spline basis is constructed over a U-spline mesh U as follows:
1. Determine the index support idₙ=ID(n), n∈BV(c) for each k-cell basis vector n associated with each k-cell c∈U (see section 6.7).
2. Determine the index support id_{A} of each U-spline basis vector by constructing a corresponding core graph G_{A}(see section 6.9.1).
3. Determine the basis vector u_{A} of each U-spline basis function by solving the rank one null space problem R_{|id}_{_{A}} (see section 6.9.2).
4. Normalize the set of U-spline basis vectors UV(U) to determine the set of U-spline basis functions UF(U) (see section 6.9.3).

### The Core Graph

In order to construct U-spline basis vectors or, equivalently, U-spline basis functions, we need to create collections of vertex basis vectors and represent relationships between them. We do this by defining a core graph for each U-spline basis function. A core graph G_{A} is a directed acyclic graph that combines adjacent vertex basis vectors into the index support id_{A} for a single U-spline basis vector u_{A}. An algorithm to compute G_{A} is given in algorithm 1.

### Cores

Each node in the graph, called a core and denoted by κ, corresponds to a set of vertex basis vectors, i.e., κ⊆BV(v). To retrieve the core associated with a vertex v we use κ(v). The boundary of a core in the direction of an edge e, denoted by BDₑ(κ), is computed in the same manner as basis vector boundaries (section 6.7.7). The set of children cores of κ is denoted by children(κ). We say that cores κᵢ and κⱼ are conforming if BDₑ(κᵢ)=BDₑ(κⱼ) on a shared edge e. Edges between conforming cores represent parent/child relationships in G_{A}.

### Expansion Edges

The core graph algorithm functions by iterating over candidate expansion edges on which to expand. An expansion edge is a directed edge from vertex vᵢ to vertex vⱼ, denoted e_{i,j}. For the subsequent definitions it is convenient to define several auxiliary sets. The set of expanding basis vectors on a vertex adjacent to a core is given by

XBV(κᵢ,vⱼ)={n∈BV(vⱼ):C(ID(n))⊆/C(ID(κᵢ))}. (6.115)

The set of interacting edges is given by

IE={e_{i,j}:SBV(κᵢ)∩SBV(XBV(κᵢ,vⱼ))≠ø}. (6.116)

The set of covered edges is given by

CE={e_{i,j}:BDₑ(κᵢ)⊆SBV(κⱼ)}. (6.117)

Finally, let FE be the set of directed edges for which the algorithm has tried and failed to find a conforming child core. Then, the set of candidate expansion edges are given by:

XE=IE\(CE∪FE). (6.118)

The core graph algorithm proceeds in a breadth-first manner. That is, in a graph with multiple candidate expansion edges, we prioritize those edges originating from cores closest to the root of the graph.

### Algorithm

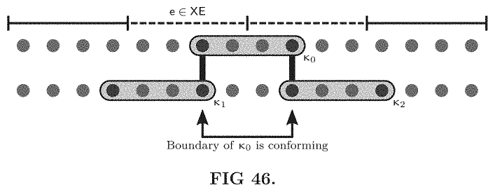

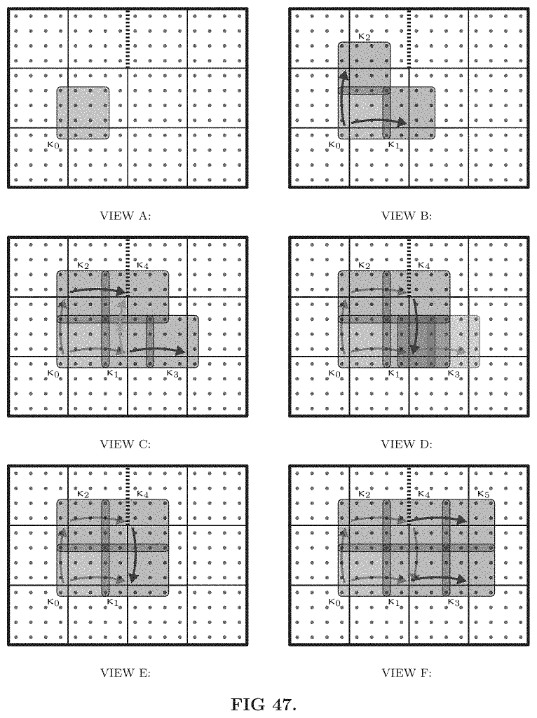

Algorithm 1 describes the procedure for constructing a core graph. To illustrate the behavior of the core graph algorithm, first consider the one-dimensional cubic U-spline mesh shown in FIG. 46, where each feature of a core graph is depicted, including the root core KO, two child cores κ₁ and κ₂, and the expansion candidate edges XE which resulted in the two children being added to the graph. Next, consider the two-dimensional cubic U-spline mesh shown in FIG. 47. This mesh has twelve cells and continuity [symbol] ² everywhere except for one edge which is [symbol] ³, forming a supersmooth interface. The Bernstein coefficients of the completed basis function are listed in section 6.15.1.

### The Rank One Null Space Problem

The U-spline index support id_{A} is extracted from the combined index supports of the cores in G_{A}. We then consider a restricted rank one constraint matrix R|_{id}_{_{A}} and associated null space problem. In the multi-dimensional setting, the smoothness constraints often form

Algorithm 1 Compute core graph G_{A} from given vertex basis vector n

| 1: | procedure COMPUTECOREGRAPH(n) | |
|---|---|---|
| 2: | κᵣ ← {n} | [symbol] The root core consists of the input null vector. |

| | | |
|---|---|---|
| 3: | κ(vᵣ) ← κᵣ | [symbol] Initialize the graph by inserting the root core. |

| 4: | while XE ≠ ∅ do | |
|---|---|---|
| 5: | e_{i,j} ← next(XE) | [symbol] Get next expansion edge from XE. |

| | | |
|---|---|---|
| 6: | if κ(vᵢ) is an ancestor of κ(vⱼ) then | [symbol] A connection from κᵢ to κⱼ would create a cycle. |

| | | |
|---|---|---|
| 7: | FE ← FE ∪ e_{i,j} | [symbol] Mark e_{i,j} as failed and go to next iteration. |

| 8: | continue | |
|---|---|---|
| 9: | end if | |
| 10: | κ_{new} ← {n ϵ BV(vⱼ) : BDₑ(n) ⊂ BDₑ(κ(vᵢ))} | [symbol] Construct a new core on vⱼ that |

| | conforms to κᵢ. | |
|---|---|---|
| 11: | if κ_{new} = ∅ then | [symbol] If κ_{new} is empty, expansion failed along this edge. |

| 12: | FE ← FE ∪ e_{i,j} | |
|---|---|---|
| 13: | continue | |
| 14: | end if | |
| 15: | κ(vⱼ) ← (vⱼ) ∪ κ_{new} | [symbol] Merge κ_{new} with any existing null vectors in κ(vⱼ). |

| | | |
|---|---|---|
| 16: | children(κ(vᵢ)) ← children(κ(vᵢ)) ∪ κ(vⱼ)) | [symbol] Add a graph edge from κᵢ to κⱼ. |

| | | |
|---|---|---|
| 17: | for each κ_{c} ϵ children(κ(vⱼ)) do | [symbol] Prune any children of x(vⱼ) that no longer conform. |

| 18: | if BDₑ(κ_{c}) ≠ BDₑ(κⱼ) then | |
|---|---|---|
| 19: | remove κ_{c} and all descendants from G_{A} | |
| 20: | end if | |
| 21: | end for | |
| 22: | FE ← FE \ (e_{i,j} ∪ e_{j,i}) | [symbol] Remove e_{i,j} and its opposite from failed edges. |

| 23: | end while | |
|---|---|---|
| 24: | success ← FE = ∅ | [symbol] The algorithm succeeds only if it terminates with no failed edges.. |

| | |
|---|---|
| 25: | return G_{A}, success |
| 26: | end procedure |

a system of linearly dependent equations. That is, the constraint matrix R|_{id}_{_{A}} is often not square, with the number of rows to being greater than the number of columns n. To solve for the Bernstein coefficients of the U-spline basis vector u_{A}, one approach is to solve for the reduced row echelon form of R|_{id}_{_{A}} via Gaussian elimination, resulting in a matrix with m−n rows equal to 0^{T}. However, it has been shown that Gaussian elimination on floating point numbers leads to unacceptably high accumulated error when analyzing the null space of spline constraint equations.

An alternative approach is to cast the problem as the linear program

minimize 1^{T}u_{A} (6.119)

subject to R_{|id}_{_{A}}u_{A}=0 (6.120)

u_{A}≥1. (6.121)

Note that we have enforced the lower bound u_{A}≥1 to preclude the trivial solution of u_{A}=0. This linear program can then be solved using any number of established methods such as simplex methods or interior-point methods. We have used the revised simplex method implemented in the lp_solve package. Thus far we have found this approach to be sufficient for solving our problems of interest, and as such have not compared the various algorithms that may be used to solve the above linear program. Instead, a detailed comparison of the solution methods that may be employed to solve the linear system of constraint equations for a given function will be the topic of a future work.

### Normalization

To recover a partition of unity in the U-spline basis we perform a normalization step. In other words, we want to find a set of positive coefficients c_{A}∈ [symbol] ₊, A=1, . . . , |UF|, such that

$$1 = {\sum }_{A} {c}_{A} {N}_{A} \qquad ( 6.122 )$$

$$= {\sum }_{A} {\overline{N}}_{A} \qquad ( 6.123 )$$

where N̅_{A} is a normalized U-spline basis function. This normalization is always possible due to the underlying structure of the null space N.

This problem can be solved in a variety of ways such as by constructing a full rank linear system by sampling the U-spline basis at |UF| unique locations or by recasting the problem as a linear programming problem and solving it using a simplex method or similar technique as described in section 6.9.2.

Note that there exists a set of non-negative coefficients, c_{A}∈ [symbol] ₊, A=1, . . . , |UF|, such

that

$$1 = {\sum }_{A} {c}_{A} {N}_{A} . \qquad ( 6.124 )$$

This can be shown using the following reasoning. Since the function ƒ=1 is an analytic function and ƒ∈ [symbol] ^{c} for every c∈U we know that ƒ∈N. This means there exists a set of coefficients, c_{A}∈ [symbol] , A=1, . . . , |UF|, such that

$${\sum }_{A} {c}_{A} {𝓊}_{A} = 1. \qquad ( 6.125 )$$

Since by construction N∩ [symbol] ₊^{|UF|}, where [symbol] ₌^{|UF|} is the non-negative orthant, and [symbol] ^{|UF|} is a polyhedral cone then N is a polyhedral cone as well. This means that, in fact, the coefficients are also non-negative, i.e., c_{A}∈ [symbol] ₊. Consequently, we have that

$${\sum }_{A} {c}_{A} {𝓊}_{A} = 1 \qquad ( 6.126 )$$

$${\sum }_{A} {c}_{A} {\sum }_{i ∈ {id}_{A}} {𝓊}_{i}^{A} {B}_{i} = {\sum }_{i ∈ ID ( U )} {B}_{i} \qquad ( 6.127 )$$

$${\sum }_{A} {c}_{A} {N}_{A} = 1 \qquad ( 6.128 )$$

$${\sum }_{A} {\overline{N}}_{A} = 1. \qquad ( 6.129 )$$

### The U-Spline Space

Given a U-spline mesh U, a U-spline space, denoted by [symbol] (U) or [symbol] for short, can now be defined. As described in section 6.5, we will construct the U-spline space by leveraging the nullspace perspective for splines. However, rather than constructing and attempting to find a solution to the global nullspace problem, which can be computationally expensive and numerically unstable, we will instead solve a single small, highly localized rank one nullspace problem for each U-spline basis function.

### Completeness and the Neighborhood of Interaction

Because adjacent cells with differing polynomial degree can occur in admissible meshes, the notion of completeness of the U-spline basis must take into account the way a cell of lower degree affects the completeness on adjacent cells which may have a local Bernstein basis of higher degree, but only have completeness at a lower total degree, bounded by the lower degree of nearby cells.

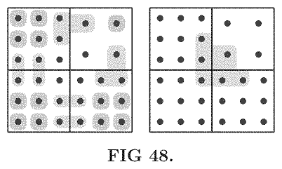

For example, in FIG. 48, we show a U-spline mesh with three quadratic and one linear cell, and [symbol] ⁰ continuity on the interfaces. The indices of the nonzero coefficients of the U-spline basis functions on this mesh are highlighted in gray. Observe that the cells directly to the left and directly below the linear cell each have a local Bernstein basis of degree p=(2,2), which has a total of nine functions, yet there are only eight U-spline basis functions which are nonzero on those cells. Due to their close proximity to the linear cell, these cells are complete up to degree p=(2, 1) and p=(1, 2), respectively, or complete up to total degree p=1. The cell diagonal from the linear cell, on the other hand, is not impacted by the linear basis and remains complete up to degree p=(2,2).

To describe this behavior, we define a submesh NI(c), called the neighborhood of interaction, of a given d-cell c. Let the set of basis functions that are nonzero over a k-cell c be denoted by UF(c) and the extended support of a k-cell be denoted by

$$supp ( UF ( c ) ) = {⋃}_{{N}_{A} ∈ UF ( c )} supp ( {N}_{A} ) . \qquad ( 6.13 )$$

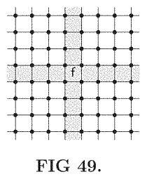

Additionally, we denote the set of all d-cells that can be reached in a cardinal submesh direction that is orthogonal to the interfaces that are adjacent to a d-cell c by CRD(c). FIG. 49 shows CRD(f) for a face f. Then, the neighborhood of interaction NI(c) of a given d-cell c is defined as

NI(c)=supp(UF(c))∩CRD(c). (6.131)

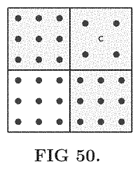

The neighborhood of interaction of the linear cell in the mesh in FIG. 48 is highlighted in FIG. 50. The completeness of a U-spline space is then defined as described in section 6.10.2.

### Mathematical Properties

The mathematical properties satisfied by a U-spline space are:
Local linear independence: The set of U-spline basis functions are locally linearly independent. This means that, for any submesh K⊆U, Σ_{A} c_{A}N_{A}(s)=0 for all s∈\hat{Ω}^{K}, where c|U|={c_{A}} is a set of real coefficients, if and only if c|U|=0.
Completeness: A set of U-spline basis functions is complete through total polynomial degree

$$\vert {q}^{c} \vert = {min}_{a ∈ NI ( c )} \vert {p}^{a} \vert \qquad ( 6.132 )$$

over \hat{Ω}^{c}. Additionally, a U-spline space is complete through total polynomial degree

$$\vert {q}^{U} \vert = {min}_{c ∈ U} \vert {q}^{c} \vert \qquad ( 6.133 )$$

over \hat{Ω}^{U}. In other words, there exists a set of real coefficients {C_{A}} such that Σ_{A}c_{A}N_{A}(s)=s^{r} for any r≤|q^{c}|, s∈\hat{Ω}^{c} or r≤|q^{U}|, s∈\hat{Ω}^{U}.
Pointwise non-negativity: A set of U-spline basis functions are pointwise non-negative. More precisely, N_{A}(s)≥0 for all s∈\hat{Ω}^{U}, A=1, . . . , |UF(U)| where UF(U) is the set of U-spline basis functions that are nonzero over \hat{Ω}^{U}.
Partition of unity: A set of U-spline basis functions forms a partition of unity. In other words, Σ_{A}N_{A}(s)=1 for all s∈\hat{Ω}^{U}.
Compact support: Compact support simply means that for any U-spline basis function N_{A} there exists a submesh K_{A}⊆U such that for any s∈\hat{Ω}^{U}

$$\{ \begin{matrix}{N}_{A} ( s ) > 0 & s ∈ {\hat{Ω}}^{{K}_{A}} , \\ {N}_{A} ( s ) = 0 & otherwise .\end{matrix} \qquad ( 6.134 )$$

It is desirable for the submesh K_{A} to be as small as possible to preserve the sparsity of linear systems written in terms of the basis functions.

### Numerical Verification

The approach to building a basis on a U-spline mesh presented in section 6.9 is algorithmic in nature. In order to verify that this algorithm will always successfully build a valid U-spline basis with the desired properties on every U-spline mesh, we performed extensive testing by running the U-spline algorithm on a large number and variety of one- and two-dimensional input U-spline meshes. For three-dimensional meshes, due to computational speed limitations we focused our testing on a specific set of tailor-made volumetric meshes that specifically conform to or violate each admissibility condition. A formal proof of the correctness of the algorithm is beyond the scope of this work.

The set of all admissible U-spline meshes is very large, and it is impractical to test every possible mesh configuration. In order to ensure that our test suite contained sufficient variety to provide reasonable evidence of the validity of the U-spline algorithm, for one- and two-dimensional meshes we leveraged the U-spline mesh classification system presented in section 6.8.3 to generate test meshes within several of these classes, representing increasing levels of complexity.

### Overview of Verification Procedure

We first generated meshes within the most structured class [symbol] ^{RHKP}, and then proceeded to remove structure until finally a large number of meshes in the class [symbol] ^{rhkp} were tested (see table 6.1 for a definition of each superscript). In one dimension, we focused on class [symbol] ^{RhKP}. For each mesh, we used the U-spline algorithm to construct a set of basis functions. These basis functions were then analyzed to ensure they satisfied all the mathematical properties of a U-spline space as described in section 6.10.2.

### One Dimension

For one-dimensional meshes, the class [symbol] ^{RhKP} was selected, which allows any degree on each cell and continuity on each interface up to [symbol] ^{∞}. This is the most unstructured class possible in one dimension.

### Two Dimensions

On two-dimensional meshes, five gradations of structure were selected.
[symbol] ^{RHKP}: Tensor-product topology; degree and continuity propagate globally.
[symbol] ^{RhkP}: Tensor-product topology; degree propagates globally but continuity may vary locally (including supersmooth interfaces).
[symbol] ^{RHKp}: Tensor-product topology; continuity propagates globally but degree may vary locally.
[symbol] ^{rHkP}: Meshes nay include extraordinary vertices and triangles; degree propagates globally but continuity may vary locally.
[symbol] ^{rhkp}: Fully unstructured.

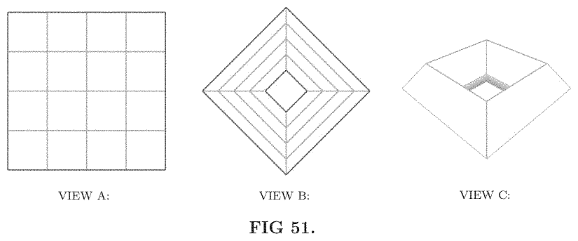

Within each class, meshes were randomly constructed to include as much variation as possible while still conforming to the admissibility conditions described in section 6.8.2. This included degree up to p=3 and continuity up to [symbol] = [symbol] ² or when permitted, supersmooth continuity. The process of constructing these meshes involved starting with a specific base topology, listed below, and then applying further modifications as the class allowed, such as adding extraordinary vertices, triangles, and variations in degree and continuity. The base topologies used are as follows. Simple representations of these base topologies are shown in FIG. 51.
Line. A line topology is a non-periodic one-dimensional sequence of edges, and is denoted by L.
Loop (has periodicity). A loop topology is a periodic one-dimensional sequence of edges, and is denoted by P.
Regular grid. A regular grid topology is a tensor product, of two non-periodic one-dimensional mesh topologies, and is denoted

G=L⊗L (6.135)
Annulus (periodicity in one tensor product direction). An annulus topology is the tensor product of a periodic one-dimensional topology with a non-periodic one-dimensional topology, and is denoted

A=P⊗L. (6.136)
Torus (periodicity in both tensor product directions). A torus topology is the tensor product of two periodic one-dimensional topologies, and is denoted

T=P⊗P. (6.137)
Triangle. A triangle mesh topology is an unstructured mesh containing only triangles, and is denoted Δ.
Mixed grid. A mixed grid mesh is a mesh containing both quadrilateral and triangular cells that is constructed by taking a tensor product mesh (grid, annulus, or torus), and then splitting a subset of the quadrilateral cells into two or more triangles. A mixed grid mesh is denoted M.
Multi-patch. A multi-patch topology is constructed of multiple regular grid, mixed grid, or triangle meshes, sewn together along conforming boundaries. A multi-patch topology is denoted X.

Following these guidelines, twenty-five thousand two-dimensional admissible U-spline meshes were constructed, with variation in degree, continuity, mesh size, and topology. In addition, several thousand one-dimensional admissible U-spline meshes of all combinations of degree and continuity were also constructed. The U-spline algorithm successfully constructed a basis on each of these meshes that was verified to satisfy all the mathematical properties of a U-spline space described in section 6.10.2.

### Three Dimensions

Due to computational speed limitations, it was impractical to generate and test volumetric meshes in the same way as was done in one and two dimensions. Instead, a specific set of tailor-made volumetric meshes were created that specifically conform to or violate each admissibility condition. Our tests demonstrated that the U-spline algorithm successfully built a valid U-spline basis with the desired properties on each of the admissible meshes.

### Notable U-Spline Examples

### Supersmooth Interfaces

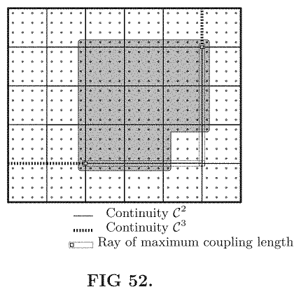

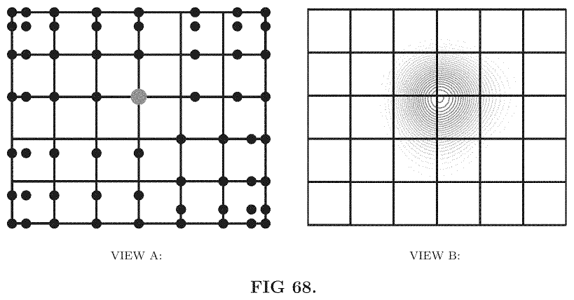

FIG. 52 shows a U-spline mesh where two perpendicular continuity transition ribbons, emanating from supersmooth interfaces, touch at a common endpoint. The support of a nearby U-spline basis function is also shown. The control points for a linear parameterization of this mesh along with a countour plot of the highlighted basis function are seen in FIG. 68. Notice the non-rectangular support of the basis function, required in this configuration to ensure local linear independence of the U-spline basis near the transition.

This example contrasts with T-splines, that leverage a type of supersmooth interface, called a T-junction, which only produce blending functions that have a tensor product structure. U-splines, on the other hand, are not limited to a tensor product structure, and can therefore produce an analysis-suitable basis on certain meshes which cannot produce analysis-suitable T-splines. This is particularly evident in cases where infinitely smooth interfaces are close enough in proximity to interact, as we see in this example. The values of the Bernstein coefficients of the highlighted basis function are listed in the section 6.15.2. See also section 6.15.3 to compare with a U-spline that is equivalent to an analysis-suitable T-spline.

### Degree Transitions

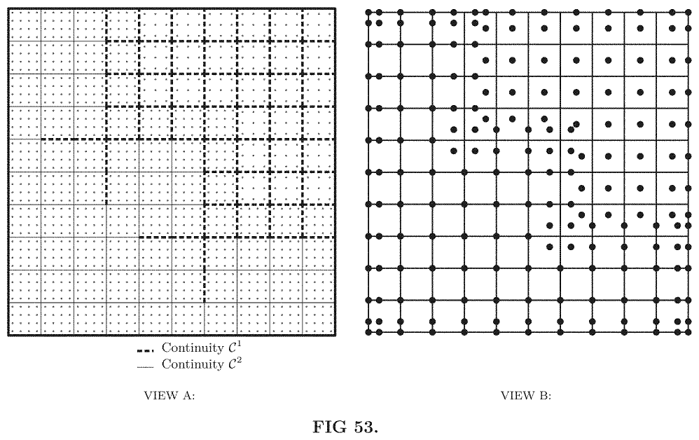

FIG. 53 illustrates a transition from a degree 2, continuity [symbol] ¹ section of the mesh to a degree 3, continuity [symbol] ² section. The continuity in the vicinity of the degree transition must be carefully set to maintain the admissibility of the U-spline mesh.

### Extraordinary Vertices

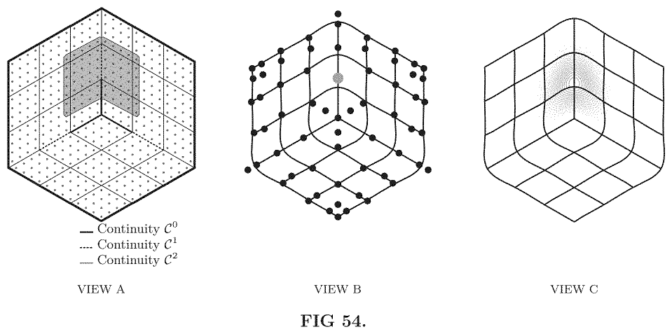

A cubic U-spline mesh that contains an extraordinary vertex is shown in FIG. 54, VIEW A. Graded creasing on the edges emanating from the extraordinary vertex transition the continuity gradually from [symbol] ⁰ to [symbol] ². The highlighted basis function overlaps these edges, transitioning from [symbol] ⁰ to [symbol] ² smoothness within its support. The control points for a linear parameterization of the mesh are seen in FIG. 54, VIEW B, and a contour plot of the highlighted basis function is seen in FIG. 54. VIEW C. The coefficients for this basis function are listed in section 6.15.4.

### Triangles

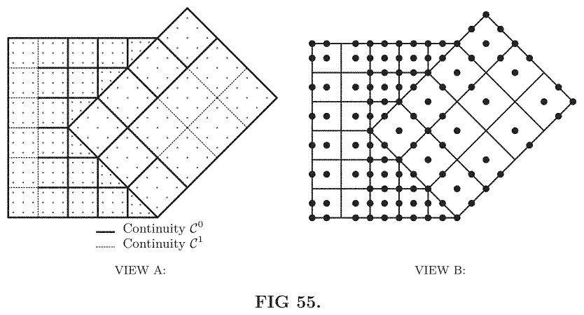

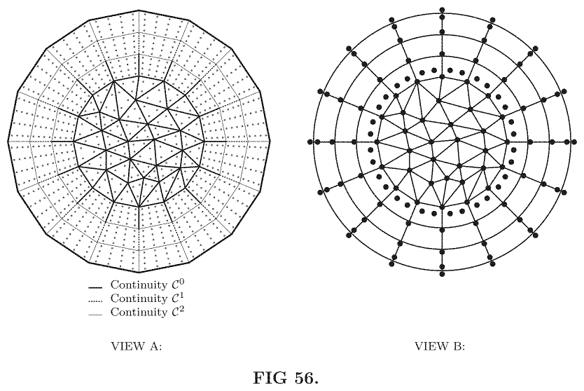

In FIG. 55 two tensor product regions meet diagonally. Triangles are used in the transition region. In FIG. 56 triangles are utilized in one portion of the domain, which then interface with quadrilateral cells to transition to a [symbol] ² outer boundary.

### Unstructured Volumetric U-Splines

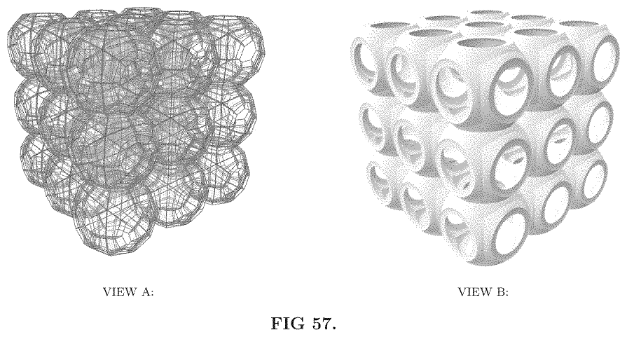

FIG. 57, VIEW A shows an example of a quadratic fully-unstructured volumetric U-spline mesh that forms a 3×3×3 lattice structure with unit cells shaped like spheres with holes. This mesh has 3888 quadratic hexahedral elements. Most of the faces have [symbol] ⁰ continuity (colorless faces) because they are adjacent to an extraordinary edge, while a few of the faces have [symbol] ¹ continuity (colored). The control points for this U-spline were chosen by projecting a linear mesh onto the U-spline basis. A rendered representation of the geometry defined by these control points is shown in FIG. 57, VIEW B.

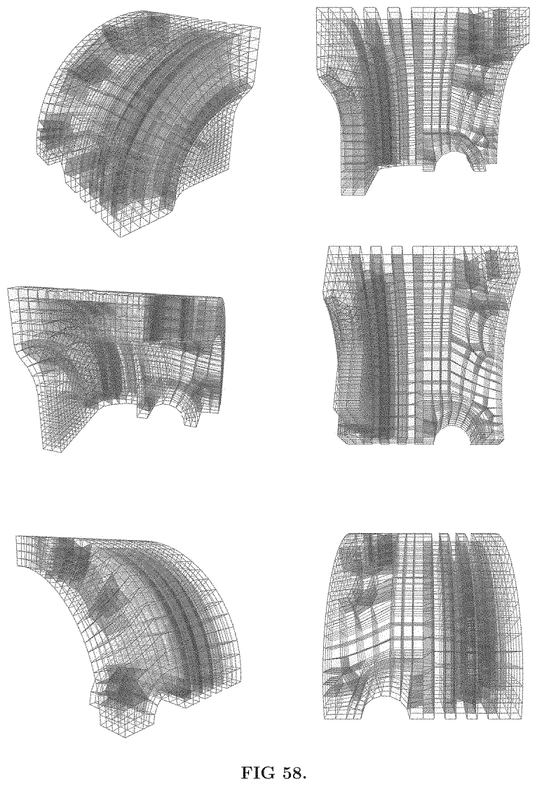

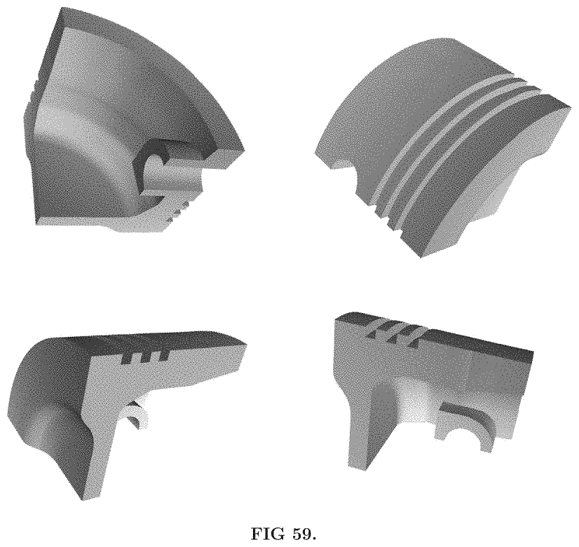

FIG. 58 shows an example of a quadratic fully-unstructured volumetric U-spline mesh of a segment of a piston. This mesh has 1539 quadratic hexahedral elements. All colorless faces have [symbol] ¹ continuity while the colored faces are [symbol] ⁰. This example contains several extraordinary edges both interior and on boundaries. The continuity scheme set on the interfaces of this mesh uses the minimal creasing necessary to be admissible. Earlier spline methods (such as multi-patch NURBS) would have required many more faces to be creased. The control points for this U-spline were chosen by performing a projection of the linear mesh onto the U-spline basis. A rendered representation of the U-spline, geometry is shown in FIG. 59.

### Interface Continuity Constraints in Two Dimensions

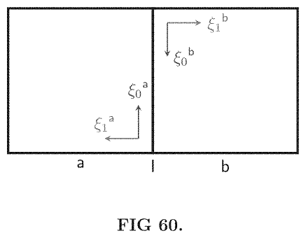

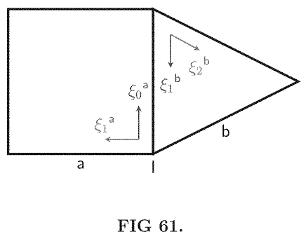

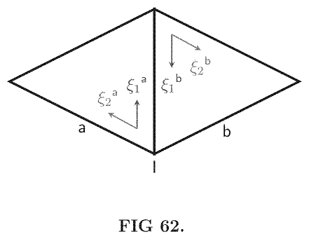

We consider constructing constraints on the interface between two cells on a two-dimensional U-spline mesh. We consider three cases: the interface between two quadrilateral cells, between a quadrilateral and triangle cell, and between two triangle cells. Without loss of generality, in each case we express these constraints with respect to the interface-aligned parameterizations indicated by the axes in FIG. 60, FIG. 61, and FIG. 62. We recognize that in practice, arbitrary relative rotations of the parameterizations on the adjacent cells must be accounted for, but for simplicity of exposition we assume the adjacent cells have the aligned coordinate systems as indicated.

We also assume the existence of a degree-elevation operator D that maps the coefficients c of a Bernstein polynomial of degree p to a new vector of coefficients c̅ of a Bernstein polynomial of degree q>p, thus representing the original function with a new basis of degree q. Thus,

c̅=D^{p,q}c (6.138)

where the nonzero entries of the matrix operator are given by

$${D}_{i , j}^{p , q} = \frac{( \begin{matrix}q - p \\ i - j\end{matrix} ) ( \begin{matrix}p \\ j\end{matrix} )}{( \begin{matrix}q \\ i\end{matrix} )} \begin{matrix}i ∈ [ 0 , q ] \\ j ∈ [ max ( 0 , i - q + p ) , min ( p , i ) ] .\end{matrix} \qquad ( 6.139 )$$

### Quadrilateral-Quadrilateral Interface

Consider two quadrilateral cells a and b on a two-dimensional mesh, separated by interface I as shown in FIG. 60. Each cell has been assigned a box-like parameterization with parent coordinates ξᵢ∈[0, 1], i∈{0, 1}, ξ∈Ω̅. These cells have their parameterizations oriented such that the parameters ξ₀^{a} on cell a and the parameter ξ₀^{b} on cell b each point parallel the interface (although in opposite directions). Let η∈[0,1] parameterize the shared interface I, and be defined as η=ξ₀^{a}=(1−ξ₀^{b}). The lengths of the parametric domain on cell a are [symbol] ^{a}=[ [symbol] ₀^{a}, [symbol] ₁^{a}], and the lengths of the parametric domain on cell b are [symbol] ^{b}=[ [symbol] ₀^{b}, [symbol] ₁^{b}]. The mapping from the parent to the parametric domain in each parametric direction on each cell is

s₀^{a}= [symbol] ₀^{a}ξ₀^{a}

s₁^{a}= [symbol] ₁^{a}ξ₁^{a}

s₀^{b}= [symbol] ₀^{b}ξ₀^{b}

s₁^{b}= [symbol] ₁^{b}ξ₁^{b} (6.140)

sᵢ∈[0, [symbol] ᵢ], i∈{0,1}, s [symbol] \hat{Ω}. The degree assigned to cell a is p^{a}=(p₀^{a}, p₁^{a}), and the degree assigned to cell b is p^{b}=(p₀^{b}, p₁^{b})

A piecewise polynomial with support over a and b can be written in Bernstein form as

$$f ( ξ ) = \{ \begin{matrix}{\sum }_{i = 0}^{{{p}_{0}}^{a}} {\sum }_{j = 0}^{{{p}_{1}}^{a}} {B}_{i}^{{{p}_{0}}^{a}} ( {{ξ}_{0}}^{a} ) {B}_{j}^{{{p}_{1}}^{a}} ( {{ξ}_{1}}^{a} ) {c}_{{( i , j )}^{a}} for {ξ}^{a} ∈ {\overline{Ω}}^{a} \\ {\sum }_{i = 0}^{{{p}_{0}}^{b}} {\sum }_{j = 0}^{{{p}_{1}}^{b}} {B}_{i}^{{{p}_{0}}^{b}} ( {{ξ}_{0}}^{b} ) {B}_{j}^{{{p}_{1}}^{b}} ( {{ξ}_{1}}^{b} ) {c}_{{( i , j )}^{b}} for {ξ}^{b} ∈ {\overline{Ω}}^{b}\end{matrix} . \qquad ( 6.141 )$$

We can write the continuity constraint on the derivative of order n across the interface as

$${( \frac{1}{{ℓ}_{1}^{a}} )}^{n} {\sum }_{i = 0}^{{p}_{0}^{a}} {\sum }_{j = {p}_{1}^{a} - n}^{{p}_{1}^{a}} {B}_{i}^{{p}_{0}^{a}} ( η ) \frac{{d}^{n} {B}_{j}^{{p}_{1}^{a}} ( 0 )}{d {ξ}_{1}^{an}} {c}_{{( i , j )}^{a}} = {( \frac{- 1}{{ℓ}_{1}^{b}} )}^{n} {\sum }_{i = 0}^{{p}_{0}^{b}} {\sum }_{j = 0}^{n} {B}_{i}^{{p}_{0}^{b}} ( η ) \frac{{d}^{n} {B}_{j}^{{p}_{1}^{b}} ( 0 )}{d {ξ}_{1}^{{b}^{n}}} {c}_{{( i , j )}^{b}} ∀ η ∈ {\overline{Ω}}^{ι} \qquad ( 6.142 )$$

and if p₀^{a}=p₀^{b}=p^{∥} we can enforce the above equality constraint by instead enforcing

$${( \frac{1}{{ℓ}_{1}^{a}} )}^{n} {\sum }_{j = {p}_{1}^{a} - n}^{{p}_{1}^{a}} \frac{{d}^{n} {B}_{j}^{{p}_{0}^{a}} ( 0 )}{d {ξ}_{1}^{an}} {c}_{{( i , j )}^{a}} = {( \frac{- 1}{{ℓ}_{1}^{b}} )}^{n} {\sum }_{j = 0}^{n} \frac{{d}^{n} {B}_{j}^{{p}_{0}^{b}} ( 0 )}{d {ξ}_{1}^{{b}^{n}}} {c}_{{( {p}^{∥} - i , j )}^{b}} ∀ i ∈ [ 0 , {p}^{∥} ] . \qquad ( 6.143 )$$

In the case that p₀^{a}≠p₀^{b}, we define pₘₐₓ^{∥}(I)=max(p₀^{a},p₀^{b}). The degree-elevation operator D is used here to map the respective Bernstein coefficients to a degree pₘₐₓ^{∥}(I) Bernstein space on the shared interface. Substituting in and rearranging yields the constraints in homogeneous form

$${( \frac{1}{{ℓ}_{1}^{a}} )}^{n} {\sum }_{\begin{matrix}i ∈ [ 0 , {p}_{0}^{a} ] \\ j ∈ [ {p}_{1}^{a} - n , {p}_{1}^{a} ]\end{matrix}} \frac{{d}^{n} {B}_{j}^{{p}_{1}^{a}} ( 0 )}{d {ξ}_{1}^{an}} {D}_{k , i}^{{p}_{0}^{a} , {p}_{m a x}^{∥} ( ι )} {c}_{{( i , j )}^{a}} - {( \frac{- 1}{{ℓ}_{1}^{b}} )}^{n} {\sum }_{\begin{matrix}i ∈ [ 0 , {p}_{0}^{b} ] \\ j ∈ [ 0 , n ]\end{matrix}} \frac{{d}^{n} {B}_{j}^{{p}_{1}^{b}} ( 0 )}{d {ξ}_{1}^{{b}^{n}}} {D}_{{p}_{m a x}^{∥} ( ι ) - k , i}^{{p}_{0}^{b} , {p}_{m a x}^{∥} ( ι )} {c}_{{( i , j )}^{b}} = 0 {∀}_{n ∈ [ 0 , {ϑ}^{ι} ]}^{k ∈ [ 0 , {p}_{m a x}^{∥} ( ι ) ]} . \qquad ( 6.144 )$$

### Quadrilateral-Triangle Interface

Consider a quadrilateral cell a and a triangle cell b on a two-dimensional mesh, separated by interface I as shown in FIG. 61. The quadrilateral cell has been assigned a box-like parameterization with parent coordinates ξᵢ^{a}∈[0,1], i∈{0, 1}, and the triangle cell has been assigned a barycentric parameterization with parent coordinates ξ₀^{b} ∈[0,1], i∈{0, 1, 2}. These cells have their parameterizations oriented such that the parameter ξ₀^{a} on the quadrilateral and the parameter ξ₁^{b} on the triangle each point parallel the interface (although in opposite directions). Let η∈[0,1] parameterize the shared interface I, and be defined as η=ξ₀^{a}=(1−ξ₁^{b}). The degree assigned to cell a is p^{a}=(p₀^{a}, p₁^{a}), and the degree assigned to cell b is p^{b}. All barycentric index tuples in the triangle cell b are expressed with two indices i and j corresponding to barycentric coordinates ξ₁^{b} and ξ₂^{b}. The remaining index corresponding to ξ₀^{b} is omitted, but is implicitly defined to be equal to p^{b}−i−j.

A piecewise polynomial with support over a and b can be written in Bernstein form as

$$f ( ξ ) = \{ \begin{matrix}{\sum }_{j = 0}^{{p}_{1}^{a}} {\sum }_{i = 0}^{{p}_{0}^{a}} {B}_{i}^{{p}_{0}^{a}} ( {ξ}_{0}^{a} ) {B}_{j}^{{p}_{1}^{a}} ( {ξ}_{1}^{a} ) {c}_{{( i , j )}^{a}} & for {ξ}^{a} ∈ {\overline{Ω}}^{a} \\ {\sum }_{j = 0}^{{p}^{b}} {\sum }_{i = 0}^{{p}^{b} - j} {B}_{i , j}^{{p}^{b}} ( {ξ}_{0}^{b} , {ξ}_{1}^{b} , {ξ}_{2}^{b} ) {c}_{{( i , j )}^{b}} & for {ξ}^{b} ∈ {\overline{Ω}}^{b}\end{matrix} . \qquad ( 6.145 )$$

For an interface that is adjacent to a triangle, we are only required to consider the constraint on the derivative of order 0. We can write the continuity constraint on the derivative of order 0 across the interface as

$${\sum }_{i = 0}^{{p}_{0}^{a}} {B}_{i}^{{p}_{0}^{a}} ( η ) {B}_{0}^{{p}_{1}^{a}} ( 0 ) {c}_{{( i , 0 )}^{a}} = {\sum }_{i = 0}^{{p}^{b}} {B}_{i , 0}^{{p}^{b}} ( η , 1 - η , 0 ) {c}_{{( i , 0 )}^{b}} ∀ η ∈ {\overline{Ω}}^{ι} \qquad ( 6.146 )$$

and if p₀^{a}=p^{b}=p^{∥} we can enforce the above equality constraint by instead enforcing

$${c}_{{( i , 0 )}^{a}} = {c}_{{( {p}^{‖} - i , 0 )}^{b}} ∀ i ∈ [ 0 , {p}^{‖} ] . \qquad ( 6.147 )$$

In the case that p₀^{a}≠p^{b}, we define pₘₐₓ^{∥}(I)=max(p₀^{a},p^{b}). The degree-elevation operator D is used here to map the respective Bernstein coefficients to a degree pₘₐₓ^{∥}(I) Bernstein space on the shared interface. Substituting in and rearranging yields the constraints in homogeneous form

$${\sum }_{i ∈ [ 0 , {p}_{0}^{a} ]} {D}_{k , i}^{{p}_{0}^{a} , {p}_{m a x}^{∥} ( ι )} {c}_{{( i , 0 )}^{a}} - {\sum }_{i ∈ [ 0 , {p}^{b} ]} {D}_{{p}_{m a x}^{∥} ( ι ) - k , i}^{{p}^{b} , {p}_{m a x}^{∥} ( ι )} = 0 ∀ k ∈ [ 0 , {p}_{m a x}^{∥} ( ι ) ] . \qquad ( 6.148 )$$

### Triangle-Triangle Interface

Consider two triangle cells a and b on a two-dimensional mesh, separated by interface I as shown in FIG. 62. Each triangle cell has been assigned a barycentric parameterization with parent coordinates ξᵢ^{a}∈[0,1], i∈{0, 1, 2} and ξᵢ^{b}∈[0, 1], i∈{0, 1, 2}. These cells have their parameterizations oriented such that the parameters ξ₁^{a} on cell a and the parameter ξ₁^{b} on cell b each point parallel the interface (although in opposite directions). Let η∈[0,1] parameterize the shared interface I, and be defined as η=ξ₀^{a}=(1−ξ₁^{b}). The degree assigned to cell a is p^{a} and the degree assigned to cell b is p^{b}. All barycentric index tuples on the two triangle cells are expressed with two indices i and j corresponding to barycentric coordinates ξ₁ and ξ₂. The remaining index corresponding to ξ₀ is omitted, but is implicitly defined to be equal to p−i−j (where p is the degree assigned to the respective triangle cell).

A piecewise polynomial with support over a and b can be written in Bernstein form as

$$f ( ξ ) = \{ \begin{matrix}{\sum }_{j = 0}^{{p}^{a}} {\sum }_{i = 0}^{{p}^{a} - j} {B}_{i , j}^{{p}^{a}} ( {ξ}_{0}^{a} , {ξ}_{1}^{a} , {ξ}_{2}^{a} ) {c}_{{( i , j )}^{a}} & for {ξ}^{a} ∈ {\overline{Ω}}^{a} \\ {\sum }_{j = 0}^{{p}^{b}} {\sum }_{i = 0}^{{p}^{b} - j} {B}_{i , j}^{{p}^{b}} ( {ξ}_{0}^{b} , {ξ}_{1}^{b} , {ξ}_{2}^{b} ) {c}_{{( i , j )}^{b}} & for {ξ}^{b} ∈ {\overline{Ω}}^{b}\end{matrix} . \qquad ( 6.149 )$$

For an interface that is adjacent to a triangle, we are only required to consider the constraint on the derivative of order 0. We can write the continuity constraint on the derivative of order 0 across the interface as

$${\sum }_{i = 0}^{{p}^{a}} {B}_{{p}^{a} - i , 0}^{{p}^{a}} ( 1 - η , η , 0 ) {c}_{{( {p}^{a} - i , 0 )}^{a}} = {\sum }_{i = 0}^{{p}^{b}} {B}_{i , 0}^{{p}^{b}} ( η , 1 - η , 0 ) {c}_{{( i , 0 )}^{b}} ∀ η ∈ {\overline{Ω}}^{ι} \qquad ( 6.15 )$$

and if p^{a}=p^{b}=p^{∥} we call enforce the above equality constraint by instead enforcing

$${c}_{{( i , 0 )}^{a}} = {c}_{{( {p}^{‖} - i , 0 )}^{b}} ∀ i ∈ [ 0 , {p}^{‖} ] . \qquad ( 6.151 )$$

In the case that p^{a}≠p^{b}, we define pₘₐₓ^{∥}(I)=max(p^{a},p^{b}). The degree-elevation operator D is used here to map the respective Bernstein coefficients to a degree pₘₐₓ^{∥}(I) Bernstein space on the shared interface. Substituting in and rearranging yields the constraints in homogeneous form

$${\sum }_{i ∈ [ 0 , {p}^{a} ]} {D}_{k , i}^{{p}^{a} , {p}_{m a x}^{∥} ( ι )} {c}_{{( {p}^{a} - i , 0 )}^{a}} - {\sum }_{i ∈ [ 0 , {p}^{b} ]} {D}_{{p}_{m a x}^{∥} ( ι ) - k , i}^{{p}^{b} , {p}_{m a x}^{∥} ( ι )} {c}_{{( i , 0 )}^{b}} = 0 ∀ k ∈ [ 0 , {p}_{m a x}^{∥} ( ι ) ] . \qquad ( 6.152 )$$

### Basis Vectors in Arbitrary Dimensions

We now describe how to build basis vectors on a k-cell from a d-dimensional Bézier mesh, 0≤k≤d. The description is recursive, and we begin with the base case: the basis vectors on a d-cell are the Bernstein functions which span the Bernstein space assigned to the element. Then, the basis vectors on a k-cell a^{k}, 0≤k<d are constructed as follows.

Composite k-Cell Basis Vectors

Composite k-cell basis vectors are formed from multiple adjacent (k+1)-cell basis vectors. Each composite k-cell basis vector is associated with a choice of inclusion distances INC^{inc}^{₁}^{, . . . , inc}^{_{d−k}} (section 6.7.3.2) and alignment index i∈ID(a^{k}) (section 6.7.3.3). An example of selecting a choice of inclusion distances is shown in FIG. 23.

We begin by placing indexed submesh domains denoted Ω^{ab} over each set of elements adjacent to each (k+1)-cell adjacent to a^{k} (with their origins set to v∈ADJ⁰(a^{k})), and then partitioning the mapped index sets of the basis vectors associated with each (k+1)-cell b^{k+1} into equivalence classes with respect to the parallel equivalence relation on the (k+1)-cell BG(b^{k+1})/ [symbol] . We then identify the equivalence classes for which the minimum projection onto the (k+1)-cell is less than or equal to INC_{b}_{^{k+1}}^{inc}^{₁}^{, . . . , inc}^{_{d−k}}.

$${EBG}_{{inc}_{1} , … , {inc}_{d - k}}^{∥} ( {b}^{k + 1} ) = \{ EBG ( {b}^{k + 1} ) ∈ BG ( {b}^{k + 1} ) / {\overline{ω}}_{{b}^{k + 1}}^{∥} : {min}_{g ∈ G} ( {[ {π}_{{b}^{k + 1}}^{∥} ( g ) ]}_{{s}_{r}} ) \leq {INC}_{{b}^{k + 1}}^{{inc}_{1} , … , {inc}_{d - k}} , G ∈ EBG ( {b}^{k + 1} ) \} \qquad ( 6.153 )$$

where sᵣ=s_{Ω}_{^{ab}}^{∥}(b^{k+1})\s_{Ω}_{^{ab}}^{∥}(a^{k}) is the parameter coordinate parallel to b^{k+1} and perpendicular to a^{k}. An example of these equivalence classes is shown in FIG. 24.

Let c_{⊥,j}^{k+1}∈PC(a^{k}, b^{k+1}), j∈{1, . . . , |PC(a^{k}, b^{k+1})|}. (PC is defined in section 6.2.1.1.) We form the sets containing all indices whose associated cell is adjacent to b^{k+1} and whose associated submesh Greville point is a part of elements of EBG_{inc}_{₁}_{, . . . , inc}_{_{d−k}}^{∥}(c_{⊥,j}^{k+1})

$${ID}_{{c}_{⊥ , j}^{k + 1}}^{⊥} = \{ i ∈ ID ( E ) : E ∈ {ADJ}^{d} ( {b}^{k + 1} ) , \\ g ( i ) ∈ G ∈ EBG ∈ {EBG}_{{inc}_{1} , … , {inc}_{d - k}}^{‖} ( {c}_{⊥ , j}^{k + 1} ) \} . \qquad ( 6.154 )$$

We form the set of Greville points that are fixed points of the parallel projectors onto c_{⊥,j}^{k+1}:

$${G}^{⊥} = {⋃}_{j ∈ \{ 1 , … , \vert PC ( {a}^{k} , {b}^{k + 1} ) \vert \}} \{ g ( i ) : g ( i ) = {π}_{{b}^{k + 1}}^{⊥} ( g ( i ) ) , i ∈ {ID}_{{c}_{⊥ , j}^{k + 1}}^{⊥} \} . \qquad ( 6.155 )$$

We take all basis vectors whose projections onto the (k+1)-cells perpendicular to b^{k+1} lie in G^{⊥}:

BG_{inc}_{₁}_{, . . . ,inc}_{_{d−k}}^{⊥}(b^{k+1})=(G∈EBG∈EBG_{inc}_{₁}_{, . . . ,inc}_{_{d−k}}^{∥}(b^{k+1}):∀_{g∈G}π_{b}_{^{k+1}}^{⊥}(g)⊆G^{⊥}). (6.156)

In the case that PC(a^{k}, b^{k+1})=ø then BG_{inc}_{₁}_{, . . . , inc}_{_{d−k}}^{⊥}(b^{k+1})=EBG_{inc}_{₁}_{, . . . , inc}_{_{d−k}}^{∥}(b^{k+1}). In FIG. 25, we see an example of these basis vector subsets marked with dotted lines.

The set of indices associated with BG_{inc}_{₁}_{, . . . , inc}_{_{d−k}}^{⊥}(b^{k+1}) is

$${ID}_{{b}^{k + 1}}^{{inc}_{1} , … , {inc}_{d - k}} = {⋃}_{G ∈ {BG}_{{inc}_{1} , … , {inc}_{d - k}}^{⊥} ( {b}^{k + 1} )} \{ i ∈ ID ( E ) : E ∈ {ADJ}^{d} ( {b}^{k + 1} ) , g ( i ) ∈ G \} . \qquad ( 6.157 )$$

The full set of indices associated with incⱼ, j∈{1, . . . , d−k} is

$${ID}_{{a}^{k}}^{{inc}_{1} , … , {inc}_{d - k}} = {⋃}_{{b}^{k + 1} ∈ {ADJ}^{k + 1} ( {a}^{k} )} {ID}_{{b}^{k + 1}}^{{inc}_{1} , … , {inc}_{d - k}} . \qquad ( 6.158 )$$

Given an alignment index i∈ID(a^{k}) and a choice of inc₁, . . . , inc_{d-k}, we can now define the index set for the composite k-cell basis vector as

IDₐ_{^{k}}^{inc}^{₁}^{, . . . ,inc}^{_{d−k}}=ID(HBVᵢ(a^{k}))∩IDₐ_{^{k}}^{inc}^{₁}^{, . . . ,inc}^{_{d−k}}. (6.159)

We consider all possible alignment indices i∈ID(a^{k}) and all possible values of inc₁, . . . , inc_{d-k} on a^{k} to construct the set of all composite k-cell basis vectors. We use BV″(a^{k}) to represent this set. The full set of indices contained in this set is

$${UID}_{{a}^{k}} = {⋃}_{n ∈ {BV}^{″} ( {a}^{k} )} ID ( n ) . \qquad ( 6.16 )$$

An example of a set of composite vertex basis vectors is shown in FIG. 26.

Simple k-Cell Basis Vectors

Each simple k-cell basis vector is formed from a single (k+1)-cell basis vector on an adjacent (k+1)-cell, one for each (k+1)-cell basis vector whose index set is not subsumed by UIDₐ_{^{k}}. We use BV′(a^{k}) to represent this set:

$${BV}^{′} ( {a}^{k} ) = {⋃}_{{b}^{k + 1} ∈ {ADJ}^{k + 1} ( {a}^{k} )} \{ n ∈ BV ( {b}^{k + 1} ) : ID ( n ) ⊈ {UID}_{{a}^{k}} \} . \qquad ( 6.161 )$$

An example of a set of simple vertex basis vectors is shown in FIG. 27.
The Full Set of k-Cell Basis Vectors

The full set of k-cell basis vectors is found by combining the set of composite k-cell basis vectors with the set of simple k-cell basis vectors:

BV(a^{k})=BV″(a^{k})∪BV′(a^{k}). (6.162)

Once the index set for each k-cell basis vector has been obtained, the constraint system can be solved to obtain the coefficient values and construct the basis vector.

### Ribbon Processing

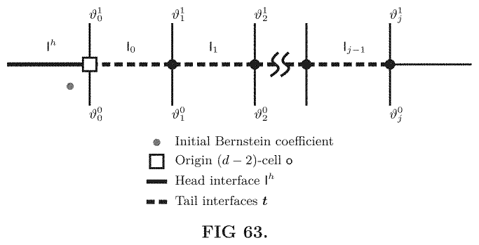

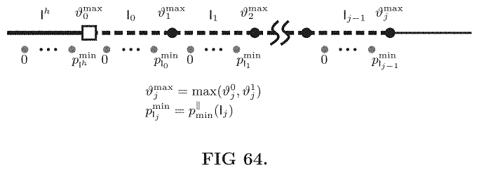

A ribbon of maximum coupling length is constructed on a mesh beginning at an origin (d−2)-cell o adjacent to an initial Bernstein coefficient, and then adding interfaces Iⱼ one by one beginning at the origin (d−2)-cell to form the tail t. We use |t| to represent the number of interfaces present in the tail t. As shown in FIGS. 63 and 64, to determine the length of the tail (or coupling distance) |t| we process a sequence of connected interfaces where the continuity assigned to each traversed (d−2)-cell is set to [symbol] ⱼ^{max}=max( [symbol] ⱼ⁰, [symbol] ⱼ¹) and the degree of each traversed interface is set to p_{I}_{ⱼ}^{min}=pₘᵢₙ^{∥,⊥}(Iⱼ,w), w∈ADj^{d-2}(Iⱼ)∩skel(r).

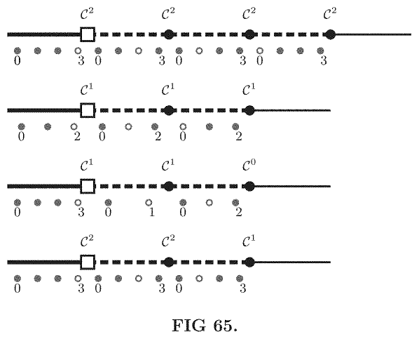

Conceptually, this process extracts a one-dimensional U-spline mesh (where the vertices and edges of the one-dimensional mesh correspond to the (d−2)-cells and interfaces of the parent mesh), and determines how far the specified Bernstein coefficient couples with the neighboring coefficients assigned to the edges in the one-dimensional mesh given the continuity constraints assigned to each vertex. Algorithm 2 describes the procedure used to determine the edges in the ribbon tail leveraging the notation introduced in FIGS. 63 and 64. The input parameters of the procedure include the interface at the head of the ribbon I^{h}, the origin vertex o, and i_{I}_{^{h}} is the index of the initial Bernstein coefficient in I^{h}. Several examples of ribbons of maximum coupling length are shown in FIG. 65.

A ribbon of length |t| is said to be truncated if [symbol] _{|t|}^{max}<p_{[t]}_{_{|t|−1}}^{min}−1 and the value of the Bernstein index i computed for the final interface [t]_{|t|-1} is greater than zero, as shown in algorithm 2. The bottom two examples in FIG. 65 show truncated ribbons.

Algorithm 2 Build a ribbon r of maximum coupling length, starting at head interface I^{h}, origin
(d − 2)-cell o, and initial Bernstein index i_{I}_{^{h}} (see FIG. 63 and FIG. 64 for notation).

| | | |
|---|---|---|
| 1: | procedure BUILDRIBBONOFMAXIMUMCOUPLINGLENGTH(I^{h}, o, i_{I}_{^{h}}) | [symbol] 0 ≤ i_{I}_{^{h}} ≤ p_{I}_{^{h}}^{min} |

| | | |
|---|---|---|
| 2: | t ← [ ] | [symbol] The array that will contain the interfaces in the tail. |

| | | |
|---|---|---|
| 3: | j ← 0 | [symbol] Counter for the length of the tail, |

| | | |
|---|---|---|
| 4: | trunc ← False | [symbol] If the ribbon is found to be truncated, this will be set to true later |

| | | |
|---|---|---|
| 5: | i ← i_{I}_{^{h}} | [symbol] The Bernstein index counter used to determine the length of the ribbon. |

| | | |
|---|---|---|
| 6: | I₋₁ ← I^{h} | [symbol] The index used in the loop to reference the head interface |

| 7: | w₀ ← o | [symbol] The index used in the loop to reference the origin (d − 2)-cell. |
|---|---|---|
| 8: | // Loop until the maximum coupling length is reached. | |
| 9: | loop | |
| 10: | iₚᵣₑᵥ ← i | [symbol] Save the Bernstein index on interface Iⱼ₋₁ for later reference. |

| 11: | // Get the max smoothness on the interfaces perpendicular to the ribbon on wⱼ. | |
|---|---|---|
| 12: | [symbol] ⱼ^{max} ← max( [symbol] ⱼ⁰, [symbol] ⱼ¹) | [symbol] In other words, [symbol] ⱼ^{max} ← max_{I′ϵADJ}_{^{d−1}}_{(w}_{ⱼ}_{)\{I}_{_{j−1}}_{,I}_{ⱼ}_{}}( [symbol] ^{I′}) |
| 13: | pⱼ₋₁^{min} ← p^{∥}ₘᵢₙ (Iⱼ₋₁) | [symbol] Get the min parallel degree on the previous interface |

| | | |
|---|---|---|
| 14: | i ← i + [symbol] ⱼ^{max} − pⱼ₋₁^{min} | [symbol] We compute the Bernstein index for interface Iⱼ. |

| 15: | if i ≥ 0 then | |
|---|---|---|
| 16: | [t]ⱼ ← Iⱼ | [symbol] If the Bernstein index for Iⱼ is valid, then we add Iⱼ to the tail. |

| | | |
|---|---|---|
| 17: | j ← j + 1 | [symbol] Increment the number of interfaces in the tail. |

| 18: | else | |
|---|---|---|
| 19: | // Here, iₚᵣₑᵥ refers to the value of i on [t]_{\|t\|-1}, the final interface of the tail t. | |
| 20: | if iₚᵣₑᵥ > 0 then | |
| 21: | // Since iₚᵣₑᵥ > 0, the only way i on interface Iⱼ to be less than 0 is for the | |
| 22: | // final interface to have reduced continuity. | |
| 23: | trunc ← True | |
| 24: | end if | |
| 25: | break | [symbol] Break out of the loop. |
| 26: | end if | |
| 27: | end loop | |
| 28: | r ← {I^{h}, o, t} | [symbol] Assemble the ribbon. |

| | | |
|---|---|---|
| 29: | return r, trunc | [symbol] Return the result, |

| | |
|---|---|
| 30: | end procedure |

U-Spline Test Cases with Bézier Extraction Coefficients

### U-Spline Extraction Coefficients Near a Supersmooth Interface

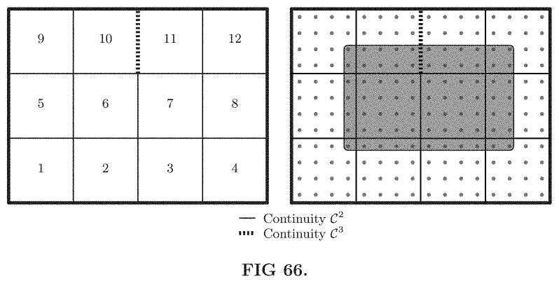

TABLE 6.2
The values of the nonzero Bernstein coefficients of
the U-spline basis function highlighted in FIG. 66.

| (3, 3)¹ | (0, 3)² | (1, 3)² | (2, 3)² | (3, 3)² | (0, 3)³ | (1, 3)³ |
|---|---|---|---|---|---|---|
| $\frac{3}{88}$ | $\frac{3}{88}$ | $\frac{3}{44}$ | $\frac{3}{22}$ | $\frac{2}{11}$ | $\frac{2}{11}$ | $\frac{5}{22}$ |
| (2, 3)³ | (3, 3)³ | (0, 3)⁴ | (1, 3)⁴ | (3, 0)⁵ | (3, 1)⁵ | (3, 2)⁵ |
| $\frac{1}{4}$ | $\frac{17}{88}$ | $\frac{17}{88}$ | $\frac{3}{22}$ | $\frac{3}{88}$ | $\frac{3}{44}$ | $\frac{3}{22}$ |
| (3, 3)⁵ | (0, 0)⁶ | (1, 0)⁶ | (2, 0)⁶ | (3, 0)⁶ | (0, 1)⁶ | (1, 1)⁶ |
| $\frac{21}{176}$ | $\frac{3}{88}$ | $\frac{3}{44}$ | $\frac{3}{22}$ | $\frac{2}{11}$ | $\frac{3}{44}$ | $\frac{3}{22}$ |
| (2, 1)⁶ | (3, 1)⁶ | (0, 2)⁶ | (1, 2)⁶ | (2, 2)⁶ | (3, 2)⁶ | (0, 3)⁶ |
| $\frac{3}{11}$ | $\frac{4}{11}$ | $\frac{3}{22}$ | $\frac{3}{11}$ | $\frac{6}{11}$ | $\frac{8}{11}$ | $\frac{21}{176}$ |
| (1, 3)⁶ | (2, 3)⁶ | (3, 3)⁶ | (0, 0)⁷ | (1, 0)⁷ | (2, 0)⁷ | (3, 0)⁷ |
| $\frac{21}{88}$ | $\frac{21}{44}$ | $\frac{7}{11}$ | $\frac{2}{11}$ | $\frac{5}{22}$ | $\frac{1}{4}$ | $\frac{17}{88}$ |
| (0, 1)⁷ | (1, 1)⁷ | (2, 1)⁷ | (3, 1)⁷ | (0, 2)⁷ | (1, 2)⁷ | (2, 2)⁷ |
| $\frac{4}{11}$ | $\frac{5}{11}$ | $\frac{1}{2}$ | $\frac{17}{44}$ | $\frac{8}{11}$ | $\frac{10}{11}$ | 1 |
| (3, 2)⁷ | (0, 3)⁷ | (1, 3)⁷ | (2, 3)⁷ | (3, 3)⁷ | (0, 0)⁸ | (1, 0)⁸ |
| $\frac{17}{22}$ | $\frac{7}{11}$ | $\frac{35}{44}$ | $\frac{7}{8}$ | $\frac{119}{176}$ | $\frac{17}{88}$ | $\frac{3}{22}$ |
| (0, 1)⁸ | (1, 1)⁸ | (0, 2)⁸ | (1, 2)⁸ | (0, 3)⁸ | (1, 3)⁸ | (3, 0)⁹ |
| $\frac{17}{44}$ | $\frac{3}{11}$ | $\frac{17}{22}$ | $\frac{6}{11}$ | $\frac{119}{176}$ | $\frac{21}{44}$ | $\frac{21}{176}$ |
| (3, 1)⁹ | (0, 0)¹⁰ | (1, 0)¹⁰ | (2, 0)¹⁰ | (3, 0)¹⁰ | (0, 1)¹⁰ | (1, 1)¹⁰ |
| $\frac{9}{88}$ | $\frac{21}{176}$ | $\frac{21}{88}$ | $\frac{21}{44}$ | $\frac{7}{11}$ | $\frac{9}{88}$ | $\frac{9}{44}$ |
| (2, 1)¹⁰ | (3, 1)¹⁰ | (0, 0)¹¹ | (1, 0)¹¹ | (2, 0)¹¹ | (3, 0)¹¹ | (0, 1)¹¹ |
| $\frac{9}{22}$ | $\frac{6}{11}$ | $\frac{7}{11}$ | $\frac{35}{44}$ | $\frac{7}{8}$ | $\frac{119}{176}$ | $\frac{6}{11}$ |
| (1, 1)¹¹ | (2, 1)¹¹ | (3, 1)¹¹ | (0, 0)¹² | (1, 0)¹² | (0, 1)¹² | (1, 1)¹² |
| $\frac{15}{22}$ | $\frac{3}{4}$ | $\frac{51}{88}$ | $\frac{119}{176}$ | $\frac{21}{44}$ | $\frac{51}{88}$ | $\frac{9}{22}$ |

U-Spline Extraction Coefficients with Non-Rectangular Support

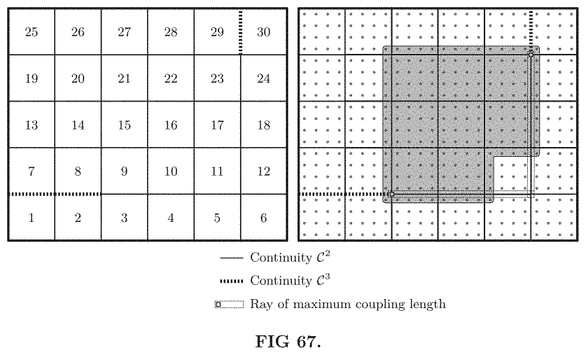

TABLE 6.3
The values of the nonzero Bernstein coefficients of
the U-spline basis function highlighted in FIG. 67.

| (3, 3)² | (0, 3)³ | (1, 3)³ | (2, 3)³ | (3, 3)³ | (0, 3)⁴ | (1, 3)⁴ |
|---|---|---|---|---|---|---|
| $\frac{1}{80}$ | $\frac{1}{80}$ | $\frac{1}{40}$ | $\frac{1}{20}$ | $\frac{1}{20}$ | $\frac{1}{20}$ | $\frac{1}{20}$ |
| (2, 3)⁴ | (3, 3)⁴ | (0, 3)⁵ | (3, 0)⁸ | (3, 1)⁸ | (3, 2)⁸ | (3, 3)⁸ |
| $\frac{1}{40}$ | $\frac{1}{80}$ | $\frac{1}{80}$ | $\frac{1}{80}$ | $\frac{1}{40}$ | $\frac{1}{20}$ | $\frac{1}{10}$ |
| (0, 0)⁹ | (1, 0)⁹ | (2, 0)⁹ | (3, 0)⁹ | (0, 1)⁹ | (1, 1)⁹ | (2, 1)⁹ |
| $\frac{1}{80}$ | $\frac{1}{40}$ | $\frac{1}{20}$ | $\frac{1}{20}$ | $\frac{1}{40}$ | $\frac{1}{20}$ | $\frac{1}{10}$ |
| (3, 1)⁹ | (0, 2)⁹ | (1, 2)⁹ | (2, 2)⁹ | (3, 2)⁹ | (0, 3)⁹ | (1, 3)⁹ |
| $\frac{1}{10}$ | $\frac{1}{20}$ | $\frac{1}{10}$ | $\frac{1}{5}$ | $\frac{1}{5}$ | $\frac{1}{10}$ | $\frac{1}{5}$ |
| (2, 3)⁹ | (3, 3)⁹ | (0, 0)¹⁰ | (1, 0)¹⁰ | (2, 0)¹⁰ | (3, 0)¹⁰ | (0, 1)¹⁰ |
| $\frac{2}{5}$ | $\frac{33}{80}$ | $\frac{1}{20}$ | $\frac{1}{20}$ | $\frac{1}{40}$ | $\frac{1}{80}$ | $\frac{1}{10}$ |
| (1, 1)¹⁰ | (2, 1)¹⁰ | (3, 1)¹⁰ | (0, 2)¹⁰ | (1, 2)¹⁰ | (2, 2)¹⁰ | (3, 2)¹⁰ |
| $\frac{1}{10}$ | $\frac{1}{20}$ | $\frac{1}{40}$ | $\frac{1}{5}$ | $\frac{1}{5}$ | $\frac{1}{10}$ | $\frac{1}{20}$ |
| (0, 3)¹⁰ | (1, 3)¹⁰ | (2, 3)¹⁰ | (3, 3)¹⁰ | (0, 0)¹¹ | (0, 1)¹¹ | (0, 2)¹¹ |
| $\frac{33}{80}$ | $\frac{17}{40}$ | $\frac{1}{4}$ | $\frac{3}{20}$ | $\frac{1}{80}$ | $\frac{1}{40}$ | $\frac{1}{20}$ |
| (0, 3)¹¹ | (1, 3)¹¹ | (2, 3)¹¹ | (3, 3)¹¹ | (0, 3)¹² | (3, 0)¹⁴ | (3, 1)¹⁴ |
| $\frac{3}{20}$ | $\frac{1}{20}$ | $\frac{1}{40}$ | $\frac{1}{80}$ | $\frac{1}{80}$ | $\frac{1}{10}$ | $\frac{3}{20}$ |
| (3, 2)¹⁴ | (3, 3)¹⁴ | (0, 0)¹⁵ | (1, 0)¹⁵ | (2, 0)¹⁵ | (3, 0)¹⁵ | (0, 1)¹⁵ |
| $\frac{9}{40}$ | $\frac{17}{80}$ | $\frac{1}{10}$ | $\frac{1}{5}$ | $\frac{2}{5}$ | $\frac{33}{80}$ | $\frac{3}{20}$ |
| (1, 1)¹⁵ | (2, 1)¹⁵ | (3, 1)¹⁵ | (0, 2)¹⁵ | (1, 2)¹⁵ | (2, 2)¹⁵ | (3, 2)¹⁵ |
| $\frac{3}{10}$ | $\frac{3}{5}$ | $\frac{5}{8}$ | $\frac{9}{40}$ | $\frac{9}{20}$ | $\frac{9}{10}$ | $\frac{19}{20}$ |
| (0, 3)¹⁵ | (1, 3)¹⁵ | (2, 3)¹⁵ | (3, 3)¹⁵ | (0, 0)¹⁶ | (1, 0)¹⁶ | (2, 0)¹⁶ |
| $\frac{17}{80}$ | $\frac{17}{40}$ | $\frac{17}{20}$ | $\frac{9}{10}$ | $\frac{33}{80}$ | $\frac{17}{40}$ | $\frac{1}{4}$ |
| (3, 0)¹⁶ | (0, 1)¹⁶ | (1, 1)¹⁶ | (2, 1)¹⁶ | (3, 1)¹⁶ | (0, 2)¹⁶ | (1, 2)¹⁶ |
| $\frac{3}{20}$ | $\frac{5}{8}$ | $\frac{13}{20}$ | $\frac{2}{5}$ | $\frac{1}{4}$ | $\frac{19}{20}$ | 1 |
| (2, 2)¹⁶ | (3, 2)¹⁶ | (0, 3)¹⁶ | (1, 3)¹⁶ | (2, 3)¹⁶ | (3, 3)¹⁶ | (0, 0)¹⁷ |
| $\frac{13}{20}$ | $\frac{17}{40}$ | $\frac{9}{10}$ | $\frac{19}{20}$ | $\frac{5}{8}$ | $\frac{33}{80}$ | $\frac{3}{20}$ |
| (1, 0)¹⁷ | (2, 0)¹⁷ | (3, 0)¹⁷ | (0, 1)¹⁷ | (1, 1)¹⁷ | (2, 1)¹⁷ | (3, 1)¹⁷ |
| $\frac{1}{20}$ | $\frac{1}{40}$ | $\frac{1}{80}$ | $\frac{1}{4}$ | $\frac{1}{10}$ | $\frac{1}{20}$ | $\frac{1}{40}$ |
| (0, 2)¹⁷ | (1, 2)¹⁷ | (2, 2)¹⁷ | (3, 2)¹⁷ | (0, 3)¹⁷ | (1, 3)¹⁷ | (2, 3)¹⁷ |
| $\frac{17}{40}$ | $\frac{1}{5}$ | $\frac{1}{10}$ | $\frac{1}{20}$ | $\frac{33}{80}$ | $\frac{1}{5}$ | $\frac{1}{10}$ |
| (3, 3)¹⁷ | (0, 0)¹⁸ | (0, 1)¹⁸ | (0, 2)¹⁸ | (0, 3)¹⁸ | (3, 0)²⁰ | (3, 1)²⁰ |
| $\frac{1}{20}$ | $\frac{1}{80}$ | $\frac{1}{40}$ | $\frac{1}{20}$ | $\frac{1}{20}$ | $\frac{17}{80}$ | $\frac{1}{5}$ |
| (3, 2)²⁰ | (3, 3)²⁰ | (0, 0)²¹ | (1, 0)²¹ | (2, 0)²¹ | (3, 0)²¹ | (0, 1)²¹ |
| $\frac{1}{10}$ | $\frac{1}{20}$ | $\frac{17}{80}$ | $\frac{17}{40}$ | $\frac{17}{20}$ | $\frac{9}{10}$ | $\frac{1}{5}$ |
| (1, 1)²¹ | (2, 1)²¹ | (3, 1)²¹ | (0, 2)²¹ | (1, 2)²¹ | (2, 2)²¹ | (3, 2)²¹ |
| $\frac{2}{5}$ | $\frac{4}{5}$ | $\frac{17}{20}$ | $\frac{1}{10}$ | $\frac{1}{5}$ | $\frac{2}{5}$ | $\frac{17}{40}$ |
| (0, 3)²¹ | (1, 3)²¹ | (2, 3)²¹ | (3, 3)²¹ | (0, 0)²² | (1, 0)²² | (2, 0)²² |
| $\frac{1}{20}$ | $\frac{1}{10}$ | $\frac{1}{5}$ | $\frac{17}{80}$ | $\frac{9}{10}$ | $\frac{19}{20}$ | $\frac{5}{8}$ |
| (3, 0)²² | (0, 1)²² | (1, 1)²² | (2, 1)²² | (3, 1)²² | (0, 2)²² | (1, 2)²² |
| $\frac{33}{80}$ | $\frac{17}{20}$ | $\frac{9}{10}$ | $\frac{3}{5}$ | $\frac{2}{5}$ | $\frac{17}{40}$ | $\frac{9}{20}$ |
| (2, 2)²² | (3, 2)²² | (0, 3)²² | (1, 3)²² | (2, 3)²² | (3, 3)²² | (0, 0)²³ |
| $\frac{3}{10}$ | $\frac{1}{5}$ | $\frac{17}{80}$ | $\frac{9}{40}$ | $\frac{3}{20}$ | $\frac{1}{10}$ | $\frac{33}{80}$ |
| (1, 0)²³ | (2, 0)²³ | (3, 0)²³ | (0, 1)²³ | (1, 1)²³ | (2, 1)²³ | (3, 1)²³ |
| $\frac{1}{5}$ | $\frac{1}{10}$ | $\frac{1}{20}$ | $\frac{2}{5}$ | $\frac{1}{5}$ | $\frac{1}{10}$ | $\frac{1}{20}$ |
| (0, 2)²³ | (1, 2)²³ | (2, 2)²³ | (3, 2)²³ | (0, 3)²³ | (1, 3)²³ | (2, 3)²³ |
| $\frac{1}{5}$ | $\frac{1}{10}$ | $\frac{1}{20}$ | $\frac{1}{40}$ | $\frac{1}{10}$ | $\frac{1}{20}$ | $\frac{1}{40}$ |
| (3, 3)²³ | (0, 0)²⁴ | (0, 1)²⁴ | (0, 2)²⁴ | (0, 3)²⁴ | (3, 0)²⁶ | (0, 0)²⁷ |
| $\frac{1}{80}$ | $\frac{1}{20}$ | $\frac{1}{20}$ | $\frac{1}{40}$ | $\frac{1}{80}$ | $\frac{1}{20}$ | $\frac{1}{20}$ |
| (1, 0)²⁷ | (2, 0)²⁷ | (3, 0)²⁷ | (0, 0)²⁸ | (1, 0)²⁸ | (2, 0)²⁸ | (3, 0)²⁸ |
| $\frac{1}{10}$ | $\frac{1}{5}$ | $\frac{17}{80}$ | $\frac{17}{80}$ | $\frac{9}{40}$ | $\frac{3}{20}$ | $\frac{1}{10}$ |

| (0, 0)²⁹ | (1, 0)²⁹ | (2, 0)²⁹ | (3, 0)²⁹ | (0, 0)³⁰ |
|---|---|---|---|---|
| $\frac{1}{10}$ | $\frac{1}{20}$ | $\frac{1}{40}$ | $\frac{1}{80}$ | $\frac{1}{80}$ |

U-Spline Extraction Coefficients on Mesh Equivalent to Analysis-Suitable T-Spline, with Non-Crossing Edge, Extensions

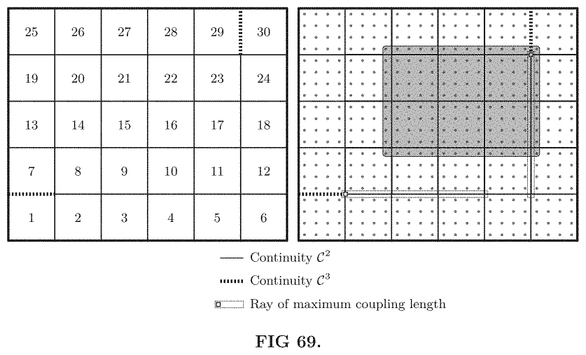

TABLE 6.4
The values of the nonzero Bernstein coefficients of
the U-spline basis function highlighted in FIG. 69.

| (3, 3)⁸ | (0, 3)⁹ | (1, 3)⁹ | (2, 3)⁹ | (3, 3)⁹ | (0, 3)¹⁰ | (1, 3)¹⁰ |
|---|---|---|---|---|---|---|
| $\frac{1}{18}$ | $\frac{1}{18}$ | $\frac{1}{9}$ | $\frac{2}{9}$ | $\frac{17}{72}$ | $\frac{17}{72}$ | $\frac{1}{4}$ |
| (2, 3)¹⁰ | (3, 3)¹⁰ | (0, 3)¹¹ | (1, 3)¹¹ | (2, 3)¹¹ | (3, 3)¹¹ | (0, 3)¹² |
| $\frac{1}{6}$ | $\frac{1}{9}$ | $\frac{1}{9}$ | $\frac{1}{18}$ | $\frac{1}{36}$ | $\frac{1}{72}$ | $\frac{1}{72}$ |
| (3, 0)¹⁴ | (3, 1)¹⁴ | (3, 2)¹⁴ | (3, 3)¹⁴ | (0, 0)¹⁵ | (1, 0)¹⁵ | (2, 0)¹⁵ |
| $\frac{1}{18}$ | $\frac{1}{9}$ | $\frac{2}{9}$ | $\frac{2}{9}$ | $\frac{1}{18}$ | $\frac{1}{9}$ | $\frac{2}{9}$ |
| (3, 0)¹⁵ | (0, 1)¹⁵ | (1, 1)¹⁵ | (2, 1)¹⁵ | (3, 1)¹⁵ | (0, 2)¹⁵ | (1, 2)¹⁵ |
| $\frac{17}{72}$ | $\frac{1}{9}$ | $\frac{2}{9}$ | $\frac{4}{9}$ | $\frac{17}{36}$ | $\frac{2}{9}$ | $\frac{4}{9}$ |
| (2, 2)¹⁵ | (3, 2)¹⁵ | (0, 3)¹⁵ | (1, 3)¹⁵ | (2, 3)¹⁵ | (3, 3)¹⁵ | (0, 0)¹⁶ |
| $\frac{8}{9}$ | $\frac{17}{18}$ | $\frac{2}{9}$ | $\frac{4}{9}$ | $\frac{8}{9}$ | $\frac{17}{18}$ | $\frac{17}{72}$ |
| (1, 0)¹⁶ | (2, 0)¹⁶ | (3, 0)¹⁶ | (0, 1)¹⁶ | (1, 1)¹⁶ | (2, 1)¹⁶ | (3, 1)¹⁶ |
| $\frac{1}{4}$ | $\frac{1}{6}$ | $\frac{1}{9}$ | $\frac{17}{36}$ | $\frac{1}{2}$ | $\frac{1}{3}$ | $\frac{2}{9}$ |
| (0, 2)¹⁶ | (1, 2)¹⁶ | (2, 2)¹⁶ | (3, 2)¹⁶ | (0, 3)¹⁶ | (1, 3)¹⁶ | (2, 3)¹⁶ |
| $\frac{17}{18}$ | 1 | $\frac{2}{3}$ | $\frac{4}{9}$ | $\frac{17}{18}$ | 1 | $\frac{2}{3}$ |
| (3, 3)¹⁶ | (0, 0)¹⁷ | (1, 0)¹⁷ | (2, 0)¹⁷ | (3, 0)¹⁷ | (0, 1)¹⁷ | (1, 1)¹⁷ |
| $\frac{4}{9}$ | $\frac{1}{9}$ | $\frac{1}{18}$ | $\frac{1}{36}$ | $\frac{1}{72}$ | $\frac{2}{9}$ | $\frac{1}{9}$ |
| (2, 1)¹⁷ | (3, 1)¹⁷ | (0, 2)¹⁷ | (1, 2)¹⁷ | (2, 2)¹⁷ | (3, 2)¹⁷ | (0, 3)¹⁷ |
| $\frac{1}{18}$ | $\frac{1}{36}$ | $\frac{4}{9}$ | $\frac{2}{9}$ | $\frac{1}{9}$ | $\frac{1}{18}$ | $\frac{4}{9}$ |
| (1, 3)¹⁷ | (2, 3)¹⁷ | (3, 3)¹⁷ | (0, 0)¹⁸ | (0, 1)¹⁸ | (0, 2)¹⁸ | (0, 3)¹⁸ |
| $\frac{2}{9}$ | $\frac{1}{9}$ | $\frac{1}{18}$ | $\frac{1}{72}$ | $\frac{1}{36}$ | $\frac{1}{18}$ | $\frac{1}{18}$ |
| (3, 0)²⁰ | (3, 1)²⁰ | (3, 2)²⁰ | (3, 3)²⁰ | (0, 0)²¹ | (1, 0)²¹ | (2, 0)²¹ |
| $\frac{2}{9}$ | $\frac{2}{9}$ | $\frac{1}{9}$ | $\frac{1}{18}$ | $\frac{2}{9}$ | $\frac{4}{9}$ | $\frac{8}{9}$ |
| (3, 0)²¹ | (0, 1)²¹ | (1, 1)²¹ | (2, 1)²¹ | (3, 1)²¹ | (0, 2)²¹ | (1, 2)²¹ |
| $\frac{17}{18}$ | $\frac{2}{9}$ | $\frac{4}{9}$ | $\frac{8}{9}$ | $\frac{17}{18}$ | $\frac{1}{9}$ | $\frac{2}{9}$ |
| (2, 2)²¹ | (3, 2)²¹ | (0, 3)²¹ | (1, 3)²¹ | (2, 3)²¹ | (3, 3)²¹ | (0, 0)²² |
| $\frac{4}{9}$ | $\frac{17}{36}$ | $\frac{1}{18}$ | $\frac{1}{9}$ | $\frac{2}{9}$ | $\frac{17}{72}$ | $\frac{17}{18}$ |
| (1, 0)²² | (2, 0)²² | (3, 0)²² | (0, 1)²² | (1, 1)²² | (2, 1)²² | (3, 1)²² |
| 1 | $\frac{2}{3}$ | $\frac{4}{9}$ | $\frac{17}{18}$ | 1 | $\frac{2}{3}$ | $\frac{4}{9}$ |
| (0, 2)²² | (1, 2)²² | (2, 2)²² | (3, 2)²² | (0, 3)²² | (1, 3)²² | (2, 3)²² |
| $\frac{17}{36}$ | $\frac{1}{2}$ | $\frac{1}{3}$ | $\frac{2}{9}$ | $\frac{17}{72}$ | $\frac{1}{4}$ | $\frac{1}{6}$ |
| (3, 3)²² | (0, 0)²³ | (1, 0)²³ | (2, 0)²³ | (3, 0)²³ | (0, 1)²³ | (1, 1)²³ |
| $\frac{1}{9}$ | $\frac{4}{9}$ | $\frac{2}{9}$ | $\frac{1}{9}$ | $\frac{1}{18}$ | $\frac{4}{9}$ | $\frac{2}{9}$ |
| (2, 1)²³ | (3, 1)²³ | (0, 2)²³ | (1, 2)²³ | (2, 2)²³ | (3, 2)²³ | (0, 3)²³ |
| $\frac{1}{9}$ | $\frac{1}{18}$ | $\frac{2}{9}$ | $\frac{1}{9}$ | $\frac{1}{18}$ | $\frac{1}{36}$ | $\frac{1}{9}$ |
| (1, 3)²³ | (2, 3)²³ | (3, 3)²³ | (0, 0)²⁴ | (0, 1)²⁴ | (0, 2)²⁴ | (0, 3)²⁴ |
| $\frac{1}{18}$ | $\frac{1}{36}$ | $\frac{1}{72}$ | $\frac{1}{18}$ | $\frac{1}{18}$ | $\frac{1}{36}$ | $\frac{1}{72}$ |
| (3, 0)²⁶ | (0, 0)²⁷ | (1, 0)²⁷ | (2, 0)²⁷ | (3, 0)²⁷ | (0, 0)²⁸ | (1, 0)²⁸ |
| $\frac{1}{18}$ | $\frac{1}{18}$ | $\frac{1}{9}$ | $\frac{2}{9}$ | $\frac{17}{72}$ | $\frac{17}{72}$ | $\frac{1}{4}$ |
| (2, 0)²⁸ | (3, 0)²⁸ | (0, 0)²⁹ | (1, 0)²⁹ | (2, 0)²⁹ | (3, 0)²⁹ | (0, 0)³⁰ |
| $\frac{1}{6}$ | $\frac{1}{9}$ | $\frac{1}{9}$ | $\frac{1}{18}$ | $\frac{1}{36}$ | $\frac{1}{72}$ | $\frac{1}{72}$ |

### U-Spline Extraction Coefficients Near an Extraordinary Vertex

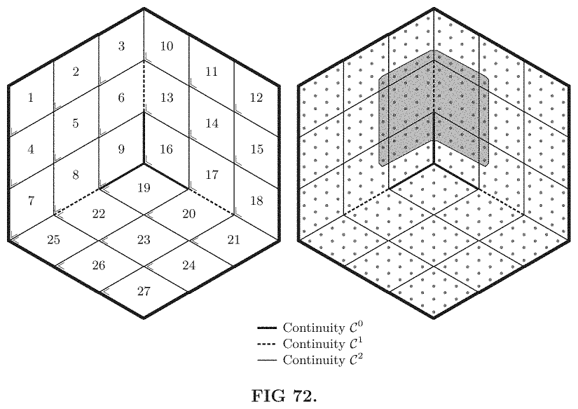

TABLE 6.5
The values of the nonzero Bernstein coefficients of
the U-spline basis function highlighted in FIG. 72.

| (3, 0)² | (0, 0)³ | (1, 0)³ | (2, 0)³ | (3, 0)³ | (3, 0)⁵ | (3, 1)⁵ |
|---|---|---|---|---|---|---|
| $\frac{1}{16}$ | $\frac{1}{16}$ | $\frac{1}{8}$ | $\frac{1}{4}$ | $\frac{1}{4}$ | $\frac{7}{32}$ | $\frac{1}{4}$ |
| (3, 2)⁵ | (3, 3)⁵ | (0, 0)⁶ | (1, 0)⁶ | (2, 0)⁶ | (3, 0)⁶ | (0, 1)⁶ |
| $\frac{1}{8}$ | $\frac{1}{16}$ | $\frac{7}{32}$ | $\frac{7}{16}$ | $\frac{7}{8}$ | $\frac{7}{8}$ | $\frac{1}{4}$ |
| (1, 1)⁶ | (2, 1)⁶ | (3, 1)⁶ | (0, 2)⁶ | (1, 2)⁶ | (2, 2)⁶ | (3, 2)⁶ |
| $\frac{1}{2}$ | 1 | 1 | $\frac{1}{8}$ | $\frac{1}{4}$ | $\frac{1}{2}$ | $\frac{1}{2}$ |
| (0, 3)⁶ | (1, 3)⁶ | (2, 3)⁶ | (3, 3)⁶ | (3, 2)⁸ | (3, 3)⁸ | (0, 2)⁹ |
| $\frac{1}{16}$ | $\frac{1}{8}$ | $\frac{1}{4}$ | $\frac{1}{4}$ | $\frac{3}{16}$ | $\frac{7}{32}$ | $\frac{3}{16}$ |
| (1, 2)⁹ | (2, 2)⁹ | (3, 2)⁹ | (0, 3)⁹ | (1, 3)⁹ | (2, 3)⁹ | (3, 3)⁹ |
| $\frac{3}{8}$ | $\frac{3}{4}$ | $\frac{3}{4}$ | $\frac{7}{32}$ | $\frac{7}{16}$ | $\frac{7}{8}$ | $\frac{7}{8}$ |
| (0, 0)¹⁰ | (1, 0)¹⁰ | (2, 0)¹⁰ | (3, 0)¹⁰ | (0, 0)¹¹ | (0, 0)¹³ | (1, 0)¹³ |
| $\frac{1}{4}$ | $\frac{1}{4}$ | $\frac{1}{8}$ | $\frac{1}{16}$ | $\frac{1}{16}$ | $\frac{7}{8}$ | $\frac{7}{8}$ |
| (2, 0)¹³ | (3, 0)¹³ | (0, 1)¹³ | (1, 1)¹³ | (2, 1)¹³ | (3, 1)¹³ | (0, 2)¹³ |
| $\frac{7}{16}$ | $\frac{7}{32}$ | 1 | 1 | $\frac{1}{2}$ | $\frac{1}{4}$ | $\frac{1}{2}$ |
| (1, 2)¹³ | (2, 2)¹³ | (3, 2)¹³ | (0, 3)¹³ | (1, 3)¹³ | (2, 3)¹³ | (3, 3)¹³ |
| $\frac{1}{2}$ | $\frac{1}{4}$ | $\frac{1}{8}$ | $\frac{1}{4}$ | $\frac{1}{4}$ | $\frac{1}{8}$ | $\frac{1}{16}$ |
| (0, 0)¹⁴ | (0, 1)¹⁴ | (0, 2)¹⁴ | (0, 3)¹⁴ | (0, 2)¹⁶ | (1, 2)¹⁶ | (2, 2)¹⁶ |
| $\frac{7}{32}$ | $\frac{1}{4}$ | $\frac{1}{8}$ | $\frac{1}{16}$ | $\frac{3}{4}$ | $\frac{3}{4}$ | $\frac{3}{8}$ |
| (3, 2)¹⁶ | (0, 3)¹⁶ | (1, 3)¹⁶ | (2, 3)¹⁶ | (3, 3)¹⁶ | (0, 2)¹⁷ | (0, 3)¹⁷ |
| $\frac{3}{16}$ | $\frac{7}{8}$ | $\frac{7}{8}$ | $\frac{7}{16}$ | $\frac{7}{32}$ | $\frac{3}{16}$ | $\frac{7}{32}$ |

### U-Spline Extraction Coefficients Near a Triangle

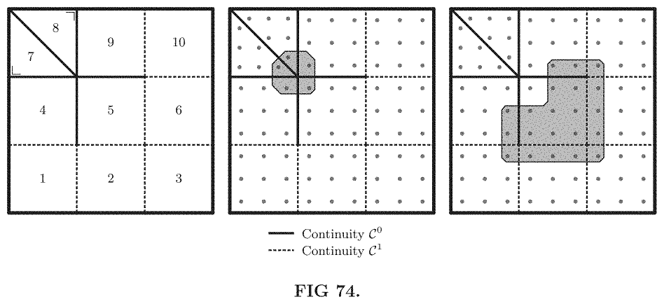

TABLE 6.6
The values of the nonzero Bernstein coefficients
of the U-spline basis function highlighted in
FIG. 74 on the left.

| (2, 2)⁴ | (0, 2)⁵ | (2, 0)⁷ | (0, 2)⁸ | (0, 0)⁹ |
|---|---|---|---|---|
| 1 | 1 | 1 | 1 | 1 |

TABLE 6.7
The values of the nonzero Bernstein coefficients of
the U-spline basis function highlighted in FIG. 74 on the right.

| (2, 2)¹ | (0, 2)² | (1, 2)² | (2, 2)² | (0, 2)³ | (2, 0)⁴ | (2, 1)⁴ |
|---|---|---|---|---|---|---|
| $\frac{1}{4}$ | $\frac{1}{4}$ | $\frac{1}{2}$ | $\frac{1}{4}$ | $\frac{1}{4}$ | $\frac{1}{4}$ | $\frac{1}{2}$ |
| (0, 0)⁵ | (1, 0)⁵ | (2, 0)⁵ | (0, 1)⁵ | (1, 1)⁵ | (2, 1)⁵ | (1, 2)⁵ |
| $\frac{1}{4}$ | $\frac{1}{2}$ | $\frac{1}{4}$ | $\frac{1}{2}$ | 1 | $\frac{1}{2}$ | $\frac{1}{2}$ |
| (2, 2)⁵ | (0, 0)⁶ | (0, 1)⁶ | (0, 2)⁶ | (1, 0)⁹ | (2, 0)⁹ | (0, 0)¹⁰ |
| $\frac{1}{4}$ | $\frac{1}{4}$ | $\frac{1}{2}$ | $\frac{1}{4}$ | $\frac{1}{2}$ | $\frac{1}{4}$ | $\frac{1}{4}$ |

### Exemplary Computing Environment

Embodiments of the invention including the processes, methods, systems, data structures, and computer program products as described herein may be accomplished, produced, and may be practiced by and within computing systems and environments. Computing systems and environments may take on a variety of forms. In this description and in the claims, the term computing system is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

Computing systems and environments may include one, more, or many discrete systems and components. Accordingly, the terms systems and environments may be used interchangeably. Such computing systems and environments may include one or more processors, computer memory, and computer-readable media. In particular, computer memory may store computer-executable instructions which, when executed by one or more processors within a system or environment, cause various processes or functions to be performed, such as the steps and acts as are recited in the embodiments.

In a basic configuration, a computing system includes at least one hardware processing unit and memory. The processing unit includes a general-purpose processor. In some configurations, the processing unit may also include a field programmable gate array (FPGA), an application specific integrated circuit (ASIC), or any other specialized circuit. In one embodiment, the memory includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

A computing system may comprise one or more executable components. An executable component may be a structure that can be software, hardware, or a combination thereof. When implemented in software, an executable component may include software objects, routines, methods (and so forth) that may be executed on or within the computing system. An executable component may exist on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate a binary or other executable code that is directly interpretable or executable by the processors. Such an understanding of example structures of an executable component is well within the understanding of one of ordinary skill in the art of computing when using the term ‘executable component.’

An executable component is also well understood by one having ordinary skill as including structures that are implemented exclusively or near-exclusively in hardware, such as within a field programmable gate array (FPGA), an application specific integrated circuit (ASIC), or any other specialized circuit. Accordingly, the term ‘executable component’ is a term for a structure that is well understood by those of ordinary skill in the art of computing, whether implemented in software, hardware, or a combination. In this description, the terms ‘component,’ ‘service,’‘engine,’ ‘module,’ ‘control,’ or the like may also be used. As used in this description and in the case, these terms (whether expressed with or without a modifying clause) are also intended to be synonymous with the term executable component, and thus also have a structure that is well understood by those of ordinary skill in the art of computing.

Embodiments are described with reference to steps and acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

While not all computing systems require a user interface, in some embodiments, the computing system includes a user interface for use in interfacing with a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, holograms and so forth. Examples of input mechanisms might include, for instance, microphones, touchscreens, holograms, cameras, keyboards, mouse or other pointer input, sensors of any type, and so forth.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data and data structures. Such computer-readable media can be any available media that can be accessed by a general purpose or special purpose computer system. Computer-readable storage media that store computer-executable instructions are physical storage media. Computer-readable transmission media that carry computer-executable instructions are transmission media. Transmission media may include signals such as radio waves. Thus, by way of example, and not limitation, embodiments of the invention can comprise at least two distinctly different kinds of computer-readable media: physical computer-readable storage media and computer-readable transmission media. Storage media comprises only physical media and expressly does not include transmission media.

Physical computer-readable storage media includes RAM. ROM, EEPROM, CD-ROM or other optical disk storage (such as CDs, DVDs, etc.), magnetic disk storage, magnetic tape, or other magnetic storage devices, or any other physical medium or hardware storage device which can be used to store desired data or program code means in the form of computer-executable instructions or data structures. Physical computer-readable storage media may be referred to as storage media. Storage media and the data stored therein can be accessed by a general purpose or special purpose computing system.

Computing systems and environments may also comprise a network. A network is defined as one or more data links that enable the transport of electronic data between computer systems, processes, and/or modules and/or other electronic devices. Data may be in the form or digital data or analog data. When information is transferred or provided over a network or another communications connection (either hardwired, wireless, or a combination of hardwired or wireless) to a computer, the computer properly views the connection as a transmission medium. Transmissions media can include a network and/or data links which can be used to carry or transmit desired data or program code means in the form of computer-executable instructions or data structures and which can be accessed by a general purpose or special purpose computer. Combinations of the above are also included within the scope of computer-readable media. (Note that physical computer-readable (storage) media and transmission are different and distinct forms of computer-readable media.)

Further, upon reaching various computer system components, program code means in the form of computer-executable instructions or data structures can be transferred from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media such as a magnetic hard disc or CD-ROM at a computer system. Thus, computer-readable physical storage media can be included in computer system components that also utilize or interface with transmission media. As noted above, however, storage media and transmission media are separate and distinct.

Computer-executable instructions comprise, for example, instructions and data which cause a general purpose computer, special purpose computer, or special purpose processing device to perform a certain function, process, or group of functions or processes. The computer-executable instructions may be, for example, binaries that are directly executable on a processor, intermediate format instructions such as assembly language, or source code such as a high-level programming language, computer-executable instructions may be instructions which must be compiled before execution on a processor or may be instructions that are interpretable by a runtime interpreter. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, mainframe computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments and so-called cloud computing systems where local and remote computer systems, which are linked (either by hardwired data links, wireless data links, or by a combination of hardwired and wireless data links) through a network, both perform tasks. Distributed and cloud computing environments may comprise myriad computing resources such as (but not limited to) networks, servers, data storage, computing nodes, I/O devices, data acquisition nodes and services, applications, and other services. In a distributed system environment, data and program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

For each of the processes, systems, and methods disclosed herein, the operations performed in the processes and methods may be implemented in differing order. Furthermore, the outlined operations are provided as non-limiting and non-exclusive examples, and some of the operations may be optional, combined into fewer steps and operations, supplemented with further operations, or expanded into additional operations without detracting from the essence of the disclosed embodiments.

### Exemplary Embodiments

The foregoing has provided the background, tools, and techniques for calculating, determining, constructing, creating, storing, applying, and using U-splines in computer aided design (CAD) and computer aided engineering (CAE). Several illustrative (but non-limiting) examples of actual applications and uses of U-splines have also been provided. Embodiments of the foregoing novel and useful technology may comprise systems, computer-implemented methods, and computer program products. Systems may include computing systems, computing environments, distributed processing systems, cloud computing systems, ad hoc and/or specialized computing systems, ad hoc and/or specialized CAD and CAE systems, structural design, analysis, and simulations systems, and other systems as are known to those having skill in the art.

Embodiments for calculating, determining, creating, using, applying U-splines include computing systems which can perform functions and steps to calculate, determine, construct, create, apply, store, or execute U-splines. Embodiments also include computer-implemented methods for calculating, determining, constructing, creating, using, and applying U-splines which may be performed in suitable computational environments. Embodiments also include computer program products which include computer readable media having computer executable instructions encoded thereon which when read and executed by appropriate computing systems can enable those systems to perform functions within a computing environment associated with U-splines including calculating, constructing, determining, creating, storing, using, and applying U-splines. The computer executable instructions can be, in various embodiments, instructions that are directly executable on or within computer systems and computing environments, such as binary machine code. The computer executable instructions can be higher level source code that can be compiled using appropriate compilers to produce executable code for particular computing systems. The computer executable instructions can be intermediate level code that can be interpreted by an interpreter within a particular computing system or environment.

For instance, there may be a system, such as is described in an exemplary computing environment discussed above, which is constructed and enabled to implement U-splines. Such a system may include computer processors, computer memory, displays, data storage, I/O facilities, and include computer-executable instructions which, when executed upon the processors, causes the system to be enabled to perform (or to actually perform) particular functions and/or steps for implementing, calculating, determining, constructing, creating, using, storing, and applying U-splines.

One particular embodiment may comprise a system for constructing a U-spline mesh in computer aided design (CAD) or computer aided engineering (CAE) or both. The system comprises one or more computer processors. The system also comprises computer readable memory and/or data storage which has stored therein computer-executable instructions. The computer-executable instructions are configured such that when executed by the one or more computer processors of the system, configures, enables, or causes the system to perform a plurality of functions.

In this embodiment, the functions may include constructing a mesh which comprises a plurality of cells. Constructing a mesh comprising a plurality of cells is discussed in section 6.2.1. The functions also may include assigning a coordinate system to each cell in the mesh, wherein each coordinate system is barycentric or formed from tensor products of barycentric coordinate systems. Such assigning a coordinate system is discussed in section 6.2.2.

The functions also may include assigning a parametric length to each edge of each cell in the mesh, wherein the parametric lengths satisfy the conditions for seamless similarity maps. Assigning a parametric length is also discussed in section 6.2.2. The functions also may include assigning a basis to each cell in the mesh, wherein each basis of each cell is a Bernstein or Bernstein-like basis. Assigning a basis to each cell is discussed in section 6.2.3.

The functions also may include assigning a minimum desired continuity to each interface between adjacent cells in the mesh. Assigning a minimum desired continuity is discussed in section 6.2.4. The functions also may include constructing a system of continuity constraints, termed the global system of constraints, from each interface in the mesh, wherein the global system of constraints is derived from a coordinate system, parametric lengths, and basis for each cell and the continuity associated with each interface. This is discussed in section 6.4. Once constructed, the U-spline mesh may be stored in durable data storage such that the U-spline mesh is accessible to or is transmittable to a CAD or CAE process for display, use, application, or further analysis.

In another embodiment, and based on the U-spline mesh constructed above, a first refined U-spline mesh may be constructed. In this embodiment, the the global system of constraints in the U-spline mesh of the system described above may be partitioned into cell systems of constraints, wherein the cell systems of constraints satisfies that each cell in the mesh has an associated cell system of constraints; wherein a cell system of constraints associated with cells of maximum dimension is empty; and wherein a cell system of constraints for each cell of lower dimension is formed recursively from the cell systems of constraints of adjacent cells of higher dimension until an interface dimension is reached. Such partitioning of the global system of constraints is described in section 6.4.

In another embodiment, and based on the first refined U-spline mesh constructed above, a second refined U-spline mesh may be constructed. In this embodiment, a set of basis vectors, termed the vertex basis vectors, can be constructed for each vertex in a mesh by computing basis vectors for a nullspace of the cell system of constraints associated with each cell in the mesh, wherein: a basis vector for the nullspace has nonnegative coefficients when expressed in Bernstein form; a basis vector for the nullspace has a minimal number of nonzero coefficients in the Bernstein form; every nonzero coefficient in a basis vector for the nullspace is within one index unit of at least one other nonzero coefficient when other nonzero coefficients are required; a basis vector for the nullspace is computed from associated interfaces first; and a basis vector for the nullspace for lower-dimensional cells is computed by analyzing a set of basis vectors associated with the nullspaces of adjacent cells of dimension one greater. Such construction of the set of vertex basis vectors is explained in section 6.7.

In another embodiment, and based on the second refined U-spline mesh constructed above, a third refined U-spline mesh may be constructed. In this embodiment, a special set of basis vectors, termed the boundaryset, is constructed for each set of vertex basis vectors in the mesh. The boundaryset is constructed by: determining a set of basis vectors associated with cell systems of constraints adjacent to the vertex, wherein nonzero coefficient indices in the basis vectors appear in at least one basis vector in the set of vertex basis vectors; determining appropriate charts for each cell adjacent to a vertex; forming equivalence classes of cell basis vectors adjacent to a vertex, wherein the equivalence class is determined through an appropriate projection; finding a basis vector from each equivalence class, wherein the nearest projected index point of the basis vector is furthest from the vertex in all appropriate charts; and forming a set containing the most distant basis vectors from each equivalence class. Such special set of basis vectors, the boundaryset, is explained in section 6.7.7.

In another embodiment, and based on the third refined U-spline mesh constructed above, a fourth refined U-spline mesh may be constructed. In this embodiment, nonzero coefficients of a single basis vector for a null space of the global system of constraints are constructed from the vertex basis vectors by: Step 1: forming a set of indices, wherein each index in the set of indices is contained in at least one vertex basis vector and the associated Bernstein coefficient is nonzero; Step 2: given one vertex basis vector, using the boundary set to determine the vertex basis vectors of all adjacent vertices whose boundary sets are aligned and adding these to a set; Step 3: repeating Step 1 until no adjacent vertices contain vertex basis vectors with aligned boundaries that are not in the set; Step 4: taking the set produced in Steps 1-3 and determining all Bernstein indices associated with vertex basis vectors in the set and computing values for all associated Bernstein coefficients, wherein the values are determined from the global system of constraints while also enforcing positivity of all nonzero Bernstein coefficients. This process is discussed in section 6.9.

In another embodiment, and based on the steps above, steps 14 are applied repeatedly until all unique basis vectors for the nullspace of the global system of constraints have been generated to form a U-spline basis. This process is also discussed in section 6.9.

In another embodiment, individual basis vectors are scaled so that the sum over all basis vectors in Bernstein form produces a vector with every entry equal to 1. Such scaling of basis vectors is described in section 6.9.3.

In another embodiment, the mesh, basis of each cell, and minimum desired continuity of each interface between adjacent cells are modified such that [symbol] -separation, p-separation, and [symbol] -grading are satisfied. This modification of the mesh, basis of each cell, and minimum desired continuity of each interface between adjacent cells is described in section 6.8.

The embodiments described above should be considered exemplary but are not limiting examples of the scope of the invention described herein. As those with skill in the art will appreciate, all embodiments, including these examples and others, that fall within the description and discussion of the entire specification and are enabled by the specification should be considered within the scope of the invention.

### CONCLUSION

Described herein are embodiments related to the application, construction, use, and storage of U-splines within computer aided design and computer aided engineering. The present invention may be embodied in other specific forms without departing from its spirit, or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for constructing a U-spline mesh in computer aided design (CAD) or computer aided engineering (CAE), the system comprising:
one or more computer processors; and
computer readable memory having stored therein computer-executable instructions which, when executed by the one or more computer processors, configures the system to:
construct a mesh which comprises a plurality of cells;
assign a coordinate system to each cell in the mesh, wherein each coordinate system is barycentric or formed from tensor products of barycentric coordinate systems;
assign a parametric length to each edge of each cell in the mesh, wherein the parametric lengths satisfy the conditions for seamless similarity maps;
assign a basis to each cell in the mesh, wherein each basis of each cell is a Bernstein or Bernstein-like basis;
assign a minimum desired continuity to each interface between adjacent cells in the mesh;
construct a system of continuity constraints, termed the global system of constraints, from each interface in the mesh, wherein the global system of constraints is derived from a coordinate system, parametric lengths, and basis for each cell and the continuity associated with each interface; and
store the U-spline mesh in durable data storage such that the U-spline mesh is accessible to or is transmittable to CAD or CAE processes for display or further analysis.

2. The system of claim 1 wherein a first refined U-spline mesh is constructed by partitioning the global system of constraints associated with the U-spline mesh into cell systems of constraints wherein:
a cell system of constraints associated with cells of maximum dimension is empty; and
a cell system of constraints for each cell of lower dimension is formed recursively from the cell systems of constraints of adjacent cells of higher dimension until an interface dimension is reached.

3. The system of claim 2 wherein a second refined U-spline mesh is constructed by constructing a set of vertex basis vectors for each vertex in the mesh by computing basis vectors for a nullspace of the cell system of constraints associated with each cell in the mesh, wherein:
a basis vector for the nullspace has nonnegative coefficients when expressed in Bernstein form;
a basis vector for the nullspace has a minimal number of nonzero coefficients in the Bernstein form;
every nonzero coefficient in a basis vector for the nullspace is within one index unit of at least one other nonzero coefficient when other nonzero coefficients are required;
a basis vector for the nullspace is computed from associated interfaces first; and
a basis vector for the nullspace for lower-dimensional cells is computed by analyzing a set of basis vectors associated with the nullspaces of adjacent cells of dimension one greater.

4. The system of claim 3 wherein a third refined U-spline mesh is constructed by constructing a special set of basis vectors, termed the boundary set, for each set of vertex basis vectors in the mesh by:
determining a set of basis vectors associated with cell systems of constraints adjacent to the vertex, wherein nonzero coefficient indices in the basis vectors appear in at least one basis vector in the set of vertex basis vectors;
determining appropriate charts for each cell adjacent to a vertex;
forming equivalence classes of cell basis vectors adjacent to a vertex, wherein the equivalence class is determined through an appropriate projection;
finding a basis vector from each equivalence class, wherein the nearest projected index point of the basis vector is furthest from the vertex in all appropriate charts; and
forming a set containing the most distant basis vectors from each equivalence class.

5. The system of claim 4 wherein a fourth refined U-spline mesh is constructed by constructing nonzero coefficients of a single basis vector for a nullspace of the global system of constraints from the vertex basis vectors by:
Step 1: forming a set, termed the basis index set, wherein each index in the basis index set is contained in at least one vertex basis vector and the associated Bernstein coefficient is nonzero;
Step 2: given one vertex basis vector, using the boundary set to determine the vertex basis vectors of all adjacent vertices whose boundary sets are aligned and adding these to the basis index set;
Step 3: repeating Steps 1-2 until no adjacent vertices contain vertex basis vectors with aligned boundaries that are not in the basis index set;
Step 4: taking the basis index set produced in Steps 1-3 and computing values for all Bernstein coefficients associated with the indices in the basis index set, wherein the values are determined from the global system of constraints while also enforcing positivity of all nonzero Bernstein coefficients.

6. The system of claim 5 wherein Steps 14 are applied repeatedly until all unique basis vectors for the nullspace of the global system of constraints have been generated to form a U-spline basis.

7. The system of claim 6 wherein individual basis vectors are scaled so that the sum over all basis vectors in Bernstein form produces a vector with every entry equal to 1.

8. The system of claim 6 wherein the U-spline mesh, basis of each cell, and minimum desired continuity of each interface between adjacent cells are modified such that [symbol] -separation, p-separation, and [symbol] -grading are satisfied.

9. A method for constructing a U-spline mesh in computer aided design (CAD) or computer aided engineering (CAE), the method performed within a computing system, the method comprising:
construct a plurality of cells;
assign a coordinate system to each cell in the mesh, wherein each coordinate system is barycentric or formed from tensor products of barycentric coordinate systems;
assign a parametric length to each edge of each cell in the mesh, wherein the parametric lengths satisfy the conditions for seamless similarity maps;
assign a basis to each cell in the mesh, wherein each basis of each cell is a Bernstein or Bernstein-like basis;
assign a minimum desired continuity to each interface between adjacent cells in the mesh;
construct a system of continuity constraints, termed the global system of constraints, from each interface in the mesh, wherein the global system of constraints is derived from a coordinate system, parametric lengths, and basis for each cell and the continuity associated with each interface; and
storing the U-spline mesh in durable data storage such that the U-spline mesh is accessible to or is transmittable to CAD or CAE processes for display or further analysis.

10. The method of claim 9 wherein a first refined U-spline mesh is constructed by partitioning the global system of constraints associated with the U-spline mesh into cell systems of constraints wherein:
a cell system of constraints associated with cells of maximum dimension is empty; and
a cell system of constraints for each cell of lower dimension is formed recursively from the cell systems of constraints of adjacent cells of higher dimension until an interface dimension is reached.

11. The method of claim 10 wherein a second refined U-spline mesh is constructed by constructing a set of vertex basis vectors for each vertex in the mesh by computing basis vectors for a nullspace of the cell system of constraints associated with each cell in the mesh, wherein:
a basis vector for the nullspace has nonnegative coefficients when expressed in Bernstein form;
a basis vector for the nullspace has a minimal number of nonzero coefficients in the Bernstein form;
every nonzero coefficient in a basis vector for the nullspace is within one index unit of at least one other nonzero coefficient when other nonzero coefficients are required;
a basis vector for the nullspace is computed from associated interfaces first; and
a basis vector for the nullspace for lower-dimensional cells is computed by analyzing a set of basis vectors associated with the nullspaces of adjacent cells of dimension one greater.

12. The method of claim 11 wherein a third refined U-spline mesh is constructed by constructing a special set of basis vectors, termed the boundary set, for each set of vertex basis vectors in the mesh by:
determining a set of basis vectors associated with cell systems of constraints adjacent to the vertex, wherein nonzero coefficient indices in the basis vectors appear in at least one basis vector in the set of vertex basis vectors;
determining appropriate charts for each cell adjacent to a vertex;
forming equivalence classes of cell basis vectors adjacent to a vertex, wherein the equivalence class is determined through an appropriate projection;
finding a basis vector from each equivalence class, wherein the nearest projected index point of the basis vector is furthest from the vertex in all appropriate charts; and
forming a set containing the most distant basis vectors from each equivalence class.

13. The method of claim 12 wherein a fourth refined U-spline mesh is constructed by constructing nonzero coefficients of a single basis vector for a nullspace of the global system of constraints from the vertex basis vectors by:
Step 1: forming a set, termed the basis index set, wherein each index in the basis index set is contained in at least one vertex basis vector and the associated Bernstein coefficient is nonzero;
Step 2: given one vertex basis vector, using the boundary set to determine the vertex basis vectors of all adjacent vertices whose boundary sets are aligned and adding these to the basis index set;
Step 3: repeating Steps 1-2 until no adjacent vertices contain vertex basis vectors with aligned boundaries that are not in the basis index set;
Step 4: taking the basis index set produced in Steps 1-3 and computing values for all Bernstein coefficients associated with the indices in the basis index set, wherein the values are determined from the global system of constraints while also enforcing positivity of all nonzero Bernstein coefficients.

14. The method of claim 13 wherein Steps 14 are applied repeatedly until all unique basis vectors for the nullspace of the global system of constraints have been generated to form a U-spline basis.

15. The method of claim 14 wherein individual basis vectors are scaled so that the sum over all basis vectors in Bernstein form produces a vector with every entry equal to 1.

16. The method of claim 14 wherein the U-spline mesh, basis of each cell, and minimum desired continuity of each interface between adjacent cells are modified such that [symbol] -separation, p-separation, and [symbol] -grading are satisfied.

17. A computer program product for constructing a U-spline mesh in computer aided design (CAD) or computer aided engineering (CAE), the system comprising: computer readable data storage having stored therein computer-executable instructions which, when executed by one or more computer processors within a computing system, configures the computing system to:
construct a plurality of cells;
assign a coordinate system to each cell in the mesh, wherein each coordinate system is barycentric or formed from tensor products of barycentric coordinate systems;
assign a parametric length to each edge of each cell in the mesh, wherein the parametric lengths satisfy the conditions for seamless similarity maps;
assign a basis to each cell in the mesh, wherein each basis of each cell is a Bernstein or Bernstein-like basis;
assign a minimum desired continuity to each interface between adjacent cells in the mesh;
construct a system of continuity constraints, termed the global system of constraints, from each interface in the mesh, wherein the global system of constraints is derived from a coordinate system, parametric lengths, and basis for each cell and the continuity associated with each interface; and
store the U-spline mesh in durable data storage such that the U-spline mesh is accessible to or is transmittable to CAD or CAE processes for display or further analysis.

18. The method of claim 17 wherein a first refined U-spline mesh is constructed by partitioning the global system of constraints associated with the U-spline mesh into cell systems of constraints wherein:
a cell system of constraints associated with cells of maximum dimension is empty; and
a cell system of constraints for each cell of lower dimension is formed recursively from the cell systems of constraints of adjacent cells of higher dimension until an interface dimension is reached.

19. The method of claim 18 wherein a second refined U-spline mesh is constructed by constructing a set of vertex basis vectors for each vertex in the mesh by computing basis vectors for a nullspace of the cell system of constraints associated with each cell in the mesh, wherein:
a basis vector for the nullspace has nonnegative coefficients when expressed in Bernstein form;
a basis vector for the nullspace has a minimal number of nonzero coefficients in the Bernstein form;
every nonzero coefficient in a basis vector for the nullspace is within one index unit of at least one other nonzero coefficient when other nonzero coefficients are required;
a basis vector for the nullspace is computed from associated interfaces first; and
a basis vector for the nullspace for lower-dimensional cells is computed by analyzing a set of basis vectors associated with the nullspaces of adjacent cells of dimension one greater.

20. The method of claim 19 wherein a third refined U-spline mesh is constructed by constructing a special set of basis vectors, termed the boundary set, for each set of vertex basis vectors in the mesh by:
determining a set of basis vectors associated with cell systems of constraints adjacent to the vertex, wherein nonzero coefficient indices in the basis vectors appear in at least one basis vector in the set of vertex basis vectors;
determining appropriate charts for each cell adjacent to a vertex;
forming equivalence classes of cell basis vectors adjacent to a vertex, wherein the equivalence class is determined through an appropriate projection;
finding a basis vector from each equivalence class, wherein the nearest projected index point of the basis vector is furthest from the vertex in all appropriate charts; and
forming a set containing the most distant basis vectors from each equivalence class.

21. The method of claim 20 wherein a fourth refined U-spline mesh is constructed by constructing nonzero coefficients of a single basis vector for a nullspace of the global system of constraints from the vertex basis vectors by:
Step 1: forming a set, termed the basis index set wherein each index in the basis index set is contained in at least one vertex basis vector and the associated Bernstein coefficient is nonzero;
Step 2: given one vertex basis vector, using the boundary set to determine the vertex basis vectors of all adjacent vertices whose boundary sets are aligned and adding these to the basis index set;
Step 3: repeating Steps 1-2 until no adjacent vertices contain vertex basis vectors with aligned boundaries that are not in the basis index set;
Step 4: taking the basis index set produced in Steps 1-3 and computing values for all Bernstein coefficients associated with the indices in the basis index set, wherein the values are determined from the global system of constraints while also enforcing positivity of all nonzero Bernstein coefficients.

22. The method of claim 21 wherein Steps 14 are applied repeatedly until all unique basis vectors for the nullspace of the global system of constraints have been generated to form a U-spline basis.

23. The method of claim 22 wherein individual basis vectors are scaled so that the sum over all basis vectors in Bernstein form produces a vector with every entry equal to 1.

24. The method of claim 22 wherein the U-spline mesh, basis of each cell, and minimum desired continuity of each interface between adjacent cells are modified such that [symbol] -separation, p-separation, and [symbol] -grading are satisfied.
